(19) United States
(12) Patent Application Publication
(10) Pub. No.: US 2024/0419294 A1
(43) Pub. Date: Dec. 19, 2024

(54) DEVICES, METHODS, AND GRAPHICAL USER INTERFACES FOR DISPLAYING A VIRTUAL KEYBOARD

(71) Applicant: Apple Inc., Cupertino, CA (US)

(72) Inventors: Evgenii KRIVORUCHKO, San Francisco, CA (US); Torsten BECKER, Victoria Harbour (CA); Shuxin YU, San Francisco, CA (US); Stephen O. LEMAY, Palo Alto, CA (US); Zoey C. TAYLOR, San Francisco, CA (US); Laura C. MADEYA, San Diego, CA (US); Emily K. VAN HAREN, Sunnyvale, CA (US); Ting-Yuan WU, Campbell, CA (US)

(21) Appl. No.: 18/676,851

(22) Filed: May 29, 2024

Related U.S. Application Data
(60) Provisional application No. 63/652,633, filed on May 28, 2024.
(60) Provisional application No. 63/470,915, filed on Jun. 4, 2023.
(60) Provisional application No. 63/470,094, filed on May 31, 2023.

(51) Int. Cl. G06F 3/04815; G06F 3/01

(52) U.S. Cl. CPC G06F 3/04815; G06F 3/011

(57) ABSTRACT

The present disclosure generally relates to methods and user interfaces for positioning a virtual keyboard in a three-dimensional environment, displaying various types of virtual keyboards, for switching between virtual keyboards, and/or displaying a virtual keyboard based on a position of a user.

### CROSS-REFERENCE TO RELATED APPLICATIONS

This application claims priority to U.S. Provisional Application No. 63/652,633, entitled “DEVICES, METHODS, AND GRAPHICAL USER INTERFACES FOR DISPLAYING A VIRTUAL KEYBOARD,” filed May 28, 2024, U.S. Provisional Application No. 63/470,915, entitled “DEVICES, METHODS, AND GRAPHICAL USER INTERFACES FOR DISPLAYING A VIRTUAL KEYBOARD,” filed Jun. 4, 2023, and U.S. Provisional Application No. 63/470,094, entitled “DEVICES, METHODS, AND GRAPHICAL USER INTERFACES FOR DISPLAYING A VIRTUAL KEYBOARD,” filed May 31, 2023, the entire disclosures of which are incorporated by reference.

### TECHNICAL FIELD

The present disclosure relates generally to computer systems that are in communication with a display generation component and, optionally, one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for providing a virtual keyboard that include at least some virtual elements (e.g., applications, augmented reality environments, mixed reality environments, and virtual reality environments) are cumbersome, inefficient, and limited. For example, systems that do not provide proper placement of a keyboard, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing virtual keyboards to users that make interaction with the computer system more efficient and intuitive for a user. Such methods and interfaces optionally complement or replace conventional methods for providing virtual keyboards to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for displaying a virtual keyboard. Such methods and interfaces may complement or replace conventional methods for displaying a virtual keyboard. Such methods and interfaces reduce the number, extent, and/or the nature of the inputs from a user and produce a more efficient human-machine interface. For battery-operated computing devices, such methods and interfaces conserve power and increase the time between battery charges.

In accordance with some embodiments, a method performed at a computer system that is in communication with a display generation component and one or more input devices is described. The method comprises: displaying, via the display generation component, a user interface that includes: a representation of a portion of a three-dimensional environment; and a representation of a respective application; receiving, via the one or more input devices, a request to display a keyboard user interface in the representation of the portion of the three-dimensional environment; and in response to receiving the request to display the keyboard user interface, displaying, via the display generation component, the keyboard user interface at a respective keyboard position in the representation of the portion of the three-dimensional environment, wherein: in accordance with a determination that a first set of keyboard placement criteria is satisfied, wherein the first set of keyboard placement criteria includes a first application criterion that is satisfied when the representation of the respective application has a first pose in the representation of the portion of the three-dimensional environment, the respective keyboard position is at a first keyboard position in the representation of the portion of the three-dimensional environment; and in accordance with a determination that a second set of keyboard placement criteria is satisfied, wherein the second set of keyboard placement criteria includes a second application criterion that is satisfied when the representation of the respective application has a second pose in the representation of the portion of the three-dimensional environment, wherein the second pose is different from the first pose, the respective keyboard position is at a second keyboard position in the representation of the portion of the three-dimensional environment that is different from the first keyboard position in the representation of the portion of the three-dimensional environment.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a user interface that includes: a representation of a portion of a three-dimensional environment; and a representation of a respective application; receiving, via the one or more input devices, a request to display a keyboard user interface in the representation of the portion of the three-dimensional environment; and in response to receiving the request to display the keyboard user interface, displaying, via the display generation component, the keyboard user interface at a respective keyboard position in the representation of the portion of the three-dimensional environment, wherein: in accordance with a determination that a first set of keyboard placement criteria is satisfied, wherein the first set of keyboard placement criteria includes a first application criterion that is satisfied when the representation of the respective application has a first pose in the representation of the portion of the three-dimensional environment, the respective keyboard position is at a first keyboard position in the representation of the portion of the three-dimensional environment; and in accordance with a determination that a second set of keyboard placement criteria is satisfied, wherein the second set of keyboard placement criteria includes a second application criterion that is satisfied when the representation of the respective application has a second pose in the representation of the portion of the three-dimensional environment, wherein the second pose is different from the first pose, the respective keyboard position is at a second keyboard position in the representation of the portion of the three-dimensional environment that is different from the first keyboard position in the representation of the portion of the three-dimensional environment.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: displaying, via the display generation component, a user interface that includes: a representation of a portion of a three-dimensional environment; and a representation of a respective application; receiving, via the one or more input devices, a request to display a keyboard user interface in the representation of the portion of the three-dimensional environment; and in response to receiving the request to display the keyboard user interface, displaying, via the display generation component, the keyboard user interface at a respective keyboard position in the representation of the portion of the three-dimensional environment, wherein: in accordance with a determination that a first set of keyboard placement criteria is satisfied, wherein the first set of keyboard placement criteria includes a first application criterion that is satisfied when the representation of the respective application has a first pose in the representation of the portion of the three-dimensional environment, the respective keyboard position is at a first keyboard position in the representation of the portion of the three-dimensional environment; and in accordance with a determination that a second set of keyboard placement criteria is satisfied, wherein the second set of keyboard placement criteria includes a second application criterion that is satisfied when the representation of the respective application has a second pose in the representation of the portion of the three-dimensional environment, wherein the second pose is different from the first pose, the respective keyboard position is at a second keyboard position in the representation of the portion of the three-dimensional environment that is different from the first keyboard position in the representation of the portion of the three-dimensional environment.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: displaying, via the display generation component, a user interface that includes: a representation of a portion of a three-dimensional environment; and a representation of a respective application; receiving, via the one or more input devices, a request to display a keyboard user interface in the representation of the portion of the three-dimensional environment; and in response to receiving the request to display the keyboard user interface, displaying, via the display generation component, the keyboard user interface at a respective keyboard position in the representation of the portion of the three-dimensional environment, wherein: in accordance with a determination that a first set of keyboard placement criteria is satisfied, wherein the first set of keyboard placement criteria includes a first application criterion that is satisfied when the representation of the respective application has a first pose in the representation of the portion of the three-dimensional environment, the respective keyboard position is at a first keyboard position in the representation of the portion of the three-dimensional environment; and in accordance with a determination that a second set of keyboard placement criteria is satisfied, wherein the second set of keyboard placement criteria includes a second application criterion that is satisfied when the representation of the respective application has a second pose in the representation of the portion of the three-dimensional environment, wherein the second pose is different from the first pose, the respective keyboard position is at a second keyboard position in the representation of the portion of the three-dimensional environment that is different from the first keyboard position in the representation of the portion of the three-dimensional environment.

In accordance with some embodiments, a computer system that is configured to communicate with a display generation component and one or more input devices is described. The computer system comprises: means for displaying, via the display generation component, a user interface that includes: a representation of a portion of a three-dimensional environment; and a representation of a respective application; means for receiving, via the one or more input devices, a request to display a keyboard user interface in the representation of the portion of the three-dimensional environment; and means, responsive to receiving the request to display the keyboard user interface, for displaying, via the display generation component, the keyboard user interface at a respective keyboard position in the representation of the portion of the three-dimensional environment, wherein: in accordance with a determination that a first set of keyboard placement criteria is satisfied, wherein the first set of keyboard placement criteria includes a first application criterion that is satisfied when the representation of the respective application has a first pose in the representation of the portion of the three-dimensional environment, the respective keyboard position is at a first keyboard position in the representation of the portion of the three-dimensional environment; and in accordance with a determination that a second set of keyboard placement criteria is satisfied, wherein the second set of keyboard placement criteria includes a second application criterion that is satisfied when the representation of the respective application has a second pose in the representation of the portion of the three-dimensional environment, wherein the second pose is different from the first pose, the respective keyboard position is at a second keyboard position in the representation of the portion of the three-dimensional environment that is different from the first keyboard position in the representation of the portion of the three-dimensional environment.

In accordance with some embodiments, a computer program product is described. The computer program product comprises one or more programs configured to be executed by one or more processors of a computer system that is that is in communication with a display generation component and one or more input devices. The one or more programs include instructions for: displaying, via the display generation component, a user interface that includes: a representation of a portion of a three-dimensional environment; and a representation of a respective application; receiving, via the one or more input devices, a request to display a keyboard user interface in the representation of the portion of the three-dimensional environment; and in response to receiving the request to display the keyboard user interface, displaying, via the display generation component, the keyboard user interface at a respective keyboard position in the representation of the portion of the three-dimensional environment, wherein: in accordance with a determination that a first set of keyboard placement criteria is satisfied, wherein the first set of keyboard placement criteria includes a first application criterion that is satisfied when the representation of the respective application has a first pose in the representation of the portion of the three-dimensional environment, the respective keyboard position is at a first keyboard position in the representation of the portion of the three-dimensional environment; and in accordance with a determination that a second set of keyboard placement criteria is satisfied, wherein the second set of keyboard placement criteria includes a second application criterion that is satisfied when the representation of the respective application has a second pose in the representation of the portion of the three-dimensional environment, wherein the second pose is different from the first pose, the respective keyboard position is at a second keyboard position in the representation of the portion of the three-dimensional environment that is different from the first keyboard position in the representation of the portion of the three-dimensional environment.

In accordance with some embodiments, a method performed at a computer system that is in communication with a display generation component and one or more input devices is described. The method comprises: while a representation of a three-dimensional environment is visible via the display generation component, detecting, via the one or more input devices, a request to use a keyboard; and in response to detecting the request to use the keyboard: in accordance with a determination that a first set of one or more criteria is satisfied, wherein the first set of one or more criteria includes a requirement that a hardware keyboard is not available for input in order for the first set of one or more criteria to be met, displaying, via the display generation component, a first keyboard user interface that includes a plurality of character entry keys in a software keyboard; and in accordance with a determination that a second set of criteria is satisfied, wherein the second set of one or more criteria includes a requirement that a hardware keyboard is available for input in order for the second set of one or more criteria to be met, displaying, via the display generation component, a second keyboard user interface that does not include the plurality of character entry keys.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: while a representation of a three-dimensional environment is visible via the display generation component, detecting, via the one or more input devices, a request to use a keyboard; and in response to detecting the request to use the keyboard: in accordance with a determination that a first set of one or more criteria is satisfied, wherein the first set of one or more criteria includes a requirement that a hardware keyboard is not available for input in order for the first set of one or more criteria to be met, displaying, via the display generation component, a first keyboard user interface that includes a plurality of character entry keys in a software keyboard; and in accordance with a determination that a second set of criteria is satisfied, wherein the second set of one or more criteria includes a requirement that a hardware keyboard is available for input in order for the second set of one or more criteria to be met, displaying, via the display generation component, a second keyboard user interface that does not include the plurality of character entry keys.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: while a representation of a three-dimensional environment is visible via the display generation component, detecting, via the one or more input devices, a request to use a keyboard; and in response to detecting the request to use the keyboard: in accordance with a determination that a first set of one or more criteria is satisfied, wherein the first set of one or more criteria includes a requirement that a hardware keyboard is not available for input in order for the first set of one or more criteria to be met, displaying, via the display generation component, a first keyboard user interface that includes a plurality of character entry keys in a software keyboard; and in accordance with a determination that a second set of criteria is satisfied, wherein the second set of one or more criteria includes a requirement that a hardware keyboard is available for input in order for the second set of one or more criteria to be met, displaying, via the display generation component, a second keyboard user interface that does not include the plurality of character entry keys.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: while a representation of a three-dimensional environment is visible via the display generation component, detecting, via the one or more input devices, a request to use a keyboard; and in response to detecting the request to use the keyboard: in accordance with a determination that a first set of one or more criteria is satisfied, wherein the first set of one or more criteria includes a requirement that a hardware keyboard is not available for input in order for the first set of one or more criteria to be met, displaying, via the display generation component, a first keyboard user interface that includes a plurality of character entry keys in a software keyboard; and in accordance with a determination that a second set of criteria is satisfied, wherein the second set of one or more criteria includes a requirement that a hardware keyboard is available for input in order for the second set of one or more criteria to be met, displaying, via the display generation component, a second keyboard user interface that does not include the plurality of character entry keys.

In accordance with some embodiments, a computer system that is configured to communicate with a display generation component and one or more input devices is described. The computer system comprises: means for, while a representation of a three-dimensional environment is visible via the display generation component, detecting, via the one or more input devices, a request to use a keyboard; and means for, in response to detecting the request to use the keyboard: in accordance with a determination that a first set of one or more criteria is satisfied, wherein the first set of one or more criteria includes a requirement that a hardware keyboard is not available for input in order for the first set of one or more criteria to be met, displaying, via the display generation component, a first keyboard user interface that includes a plurality of character entry keys in a software keyboard; and in accordance with a determination that a second set of criteria is satisfied, wherein the second set of one or more criteria includes a requirement that a hardware keyboard is available for input in order for the second set of one or more criteria to be met, displaying, via the display generation component, a second keyboard user interface that does not include the plurality of character entry keys.

In accordance with some embodiments, a computer program product is described. The computer program product comprises one or more programs configured to be executed by one or more processors of a computer system that is that is in communication with a display generation component and one or more input devices. The one or more programs include instructions for: while a representation of a three-dimensional environment is visible via the display generation component, detecting, via the one or more input devices, a request to use a keyboard; and in response to detecting the request to use the keyboard: in accordance with a determination that a first set of one or more criteria is satisfied, wherein the first set of one or more criteria includes a requirement that a hardware keyboard is not available for input in order for the first set of one or more criteria to be met, displaying, via the display generation component, a first keyboard user interface that includes a plurality of character entry keys in a software keyboard; and in accordance with a determination that a second set of criteria is satisfied, wherein the second set of one or more criteria includes a requirement that a hardware keyboard is available for input in order for the second set of one or more criteria to be met, displaying, via the display generation component, a second keyboard user interface that does not include the plurality of character entry keys.

In accordance with some embodiments, a method performed at a computer system that is in communication with a display generation component is described. The method comprises: displaying, via the display generation component, a first keyboard user interface in an augmented reality environment; while displaying the first keyboard user interface in the augmented reality environment, detecting an event associated with a first hardware keyboard; and in response to detecting the event associated with the first hardware keyboard: displaying, via the display generation component, a second keyboard user interface, different from the first keyboard user interface, in the augmented reality environment; and ceasing display of the first keyboard user interface.

In accordance with some embodiments, a non-transitory computer-readable storage medium is described. The non-transitory computer-readable storage medium stores one or more programs configured to be executed by one or more processors of a computer system that is in communication with a display generation component, the one or more programs including instructions for: displaying, via the display generation component, a first keyboard user interface in an augmented reality environment; while displaying the first keyboard user interface in the augmented reality environment, detecting an event associated with a first hardware keyboard; and in response to detecting the event associated with the first hardware keyboard: displaying, via the display generation component, a second keyboard user interface, different from the first keyboard user interface, in the augmented reality environment; and ceasing display of the first keyboard user interface.

In accordance with some embodiments, a transitory computer-readable storage medium is described. The transitory computer-readable storage medium stores one or more programs configured to be executed by one or more processors of a computer system that is configured to communicate with a display generation component, the one or more programs including instructions for: displaying, via the display generation component, a first keyboard user interface in an augmented reality environment; while displaying the first keyboard user interface in the augmented reality environment, detecting an event associated with a first hardware keyboard; and in response to detecting the event associated with the first hardware keyboard: displaying, via the display generation component, a second keyboard user interface, different from the first keyboard user interface, in the augmented reality environment; and ceasing display of the first keyboard user interface.

In accordance with some embodiments, a computer system that is configured to communicate with a display generation component is described. The computer system comprises: one or more processors; and memory storing one or more programs configured to be executed by the one or more processors, the one or more programs including instructions for: displaying, via the display generation component, a first keyboard user interface in an augmented reality environment; while displaying the first keyboard user interface in the augmented reality environment, detecting an event associated with a first hardware keyboard; and in response to detecting the event associated with the first hardware keyboard: displaying, via the display generation component, a second keyboard user interface, different from the first keyboard user interface, in the augmented reality environment; and ceasing display of the first keyboard user interface.

In accordance with some embodiments, a computer system that is configured to communicate with a display generation component is described. The computer system comprises: means for displaying, via the display generation component, a first keyboard user interface in an augmented reality environment; means for, while displaying the first keyboard user interface in the augmented reality environment, detecting an event associated with a first hardware keyboard; and means for, in response to detecting the event associated with the first hardware keyboard: displaying, via the display generation component, a second keyboard user interface, different from the first keyboard user interface, in the augmented reality environment; and ceasing display of the first keyboard user interface.

In accordance with some embodiments, a computer program product is described. The computer program product comprises one or more programs configured to be executed by one or more processors of a computer system that is that is in communication with a display generation component. The one or more programs include instructions for: displaying, via the display generation component, a first keyboard user interface in an augmented reality environment; while displaying the first keyboard user interface in the augmented reality environment, detecting an event associated with a first hardware keyboard; and in response to detecting the event associated with the first hardware keyboard: displaying, via the display generation component, a second keyboard user interface, different from the first keyboard user interface, in the augmented reality environment; and ceasing display of the first keyboard user interface.

In accordance with some embodiments, a method performed at a computer system that is in communication with one or more display generation components and one or more input devices is described. The method comprises: detecting, via the one or more input devices, an event associated with an input field; and in response to detecting the event associated with the input field, displaying, via the one or more display generation components, a keyboard user interface for inputting content into the input field, including: in accordance with a determination that a portion of a person associated with the computer system has a first spatial arrangement, displaying the keyboard user interface at a first distance from the input field; and in accordance with a determination that the portion of the person associated with the computer system has a second spatial arrangement, different from the first spatial arrangement, displaying the keyboard user interface at a second distance from the input field that is different from the first distance.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: detecting, via the one or more input devices, an event associated with an input field; and in response to detecting the event associated with the input field, displaying, via the one or more display generation components, a keyboard user interface for inputting content into the input field, including: in accordance with a determination that a portion of a person associated with the computer system has a first spatial arrangement, displaying the keyboard user interface at a first distance from the input field; and in accordance with a determination that the portion of the person associated with the computer system has a second spatial arrangement, different from the first spatial arrangement, displaying the keyboard user interface at a second distance from the input field that is different from the first distance.

In accordance with some embodiments, a transitory computer-readable storage medium is described. The transitory computer-readable storage medium stores one or more programs configured to be executed by one or more processors of a computer system that is configured to communicate with one or more display generation components and one or more input devices, the one or more programs including instructions for: detecting, via the one or more input devices, an event associated with an input field; and in response to detecting the event associated with the input field, displaying, via the one or more display generation components, a keyboard user interface for inputting content into the input field, including: in accordance with a determination that a portion of a person associated with the computer system has a first spatial arrangement, displaying the keyboard user interface at a first distance from the input field; and in accordance with a determination that the portion of the person associated with the computer system has a second spatial arrangement, different from the first spatial arrangement, displaying the keyboard user interface at a second distance from the input field that is different from the first distance.

In accordance with some embodiments, a computer system that is configured to communicate with one or more display generation components and one or more input devices is described. The computer system comprises: one or more processors; and memory storing one or more programs configured to be executed by the one or more processors, the one or more programs including instructions for: detecting, via the one or more input devices, an event associated with an input field; and in response to detecting the event associated with the input field, displaying, via the one or more display generation components, a keyboard user interface for inputting content into the input field, including: in accordance with a determination that a portion of a person associated with the computer system has a first spatial arrangement, displaying the keyboard user interface at a first distance from the input field; and in accordance with a determination that the portion of the person associated with the computer system has a second spatial arrangement, different from the first spatial arrangement, displaying the keyboard user interface at a second distance from the input field that is different from the first distance.

In accordance with some embodiments, a computer system that is configured to communicate with one or more display generation components and one or more input devices is described. The computer system comprises: means for detecting, via the one or more input devices, an event associated with an input field; and means for, in response to detecting the event associated with the input field, displaying, via the one or more display generation components, a keyboard user interface for inputting content into the input field, including: in accordance with a determination that a portion of a person associated with the computer system has a first spatial arrangement, displaying the keyboard user interface at a first distance from the input field; and in accordance with a determination that the portion of the person associated with the computer system has a second spatial arrangement, different from the first spatial arrangement, displaying the keyboard user interface at a second distance from the input field that is different from the first distance.

In accordance with some embodiments, a computer program product is described. The computer program product comprises one or more programs configured to be executed by one or more processors of a computer system that is that is in communication with one or more display generation components and one or more input devices. The one or more programs include instructions for: detecting, via the one or more input devices, an event associated with an input field; and in response to detecting the event associated with the input field, displaying, via the one or more display generation components, a keyboard user interface for inputting content into the input field, including: in accordance with a determination that a portion of a person associated with the computer system has a first spatial arrangement, displaying the keyboard user interface at a first distance from the input field; and in accordance with a determination that the portion of the person associated with the computer system has a second spatial arrangement, different from the first spatial arrangement, displaying the keyboard user interface at a second distance from the input field that is different from the first distance.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in some embodiments.

FIG. 3 is a block diagram illustrating a display generation component of a computer system that is configured to provide a visual component of the XR experience to the user in some embodiments.

FIG. 4 is a block diagram illustrating a hand tracking unit of a computer system that is configured to capture gesture inputs of the user in some embodiments.

FIG. 5 is a block diagram illustrating an eye tracking unit of a computer system that is configured to capture gaze inputs of the user in some embodiments.

FIG. 6 is a flow diagram illustrating a glint-assisted gaze tracking pipeline in some embodiments.

FIGS. 7A-7T illustrate example techniques for positioning a virtual keyboard in a three-dimensional environment, in some embodiments.

FIG. 8 is a flow diagram of methods for positioning a virtual keyboard in a three-dimensional environment, in some embodiments.

FIGS. 9A-9Z illustrate example techniques for displaying various types of virtual keyboards and switching between virtual keyboards, in some embodiments.

FIG. 10 is a flow diagram of methods for displaying various types of virtual keyboard, in some embodiments.

FIG. 11 is a flow diagram of methods for switching between virtual keyboards, in some embodiments.

FIGS. 12A-12T illustrate example techniques for positioning a virtual keyboard based on a person's position, in some embodiments.

FIG. 13 is a flow diagram of methods for positioning a virtual keyboard based on a person's position, in some embodiments.

### DESCRIPTION OF EMBODIMENTS

The present disclosure relates to user interfaces for providing an extended reality (XR) experience to a user, in some embodiments.

The systems, methods, and GUIs described herein improve user interface interactions with virtual/augmented reality environments in multiple ways.

In some embodiments, a computer system displays a keyboard user interface at different positions based on different poses of an application. Automatically displaying the keyboard user interface at different positions reduces user inputs required to move the keyboard user interface and improves how the keyboard user interface is displayed in a three-dimensional environment. It also allows the user to interact with the keyboard naturally and efficiently.

In some embodiments, the computer system displays a first keyboard user interface that includes a plurality of character entry keys or a second keyboard user interface that does not include the plurality of character entry keys. The computer system displays these interfaces based on whether a hardware keyboard is available for input. Conditionally displaying the first keyboard user interface or the second keyboard user interface reduces user inputs required to display a proper keyboard user interface when a hardware keyboard is available for input and declutters the user interface.

In some embodiments, the computer system displays one keyboard user interface and, in response to detecting an event associated with a hardware keyboard, displays a different keyboard user interface. Automatically switching between keyboard user interfaces reduces the number of user inputs required to change between keyboard user interfaces, declutters the user interface, and provides visual feedback that an event associated with a hardware keyboard was detected.

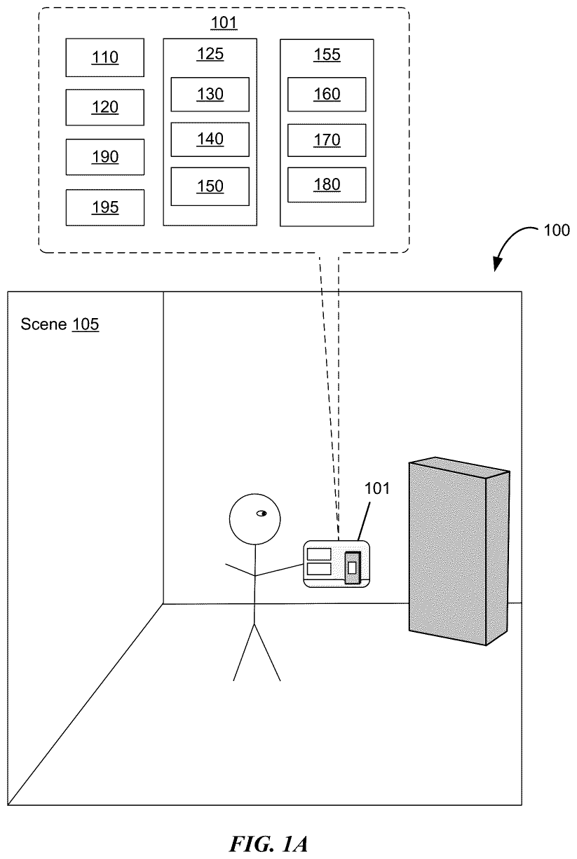

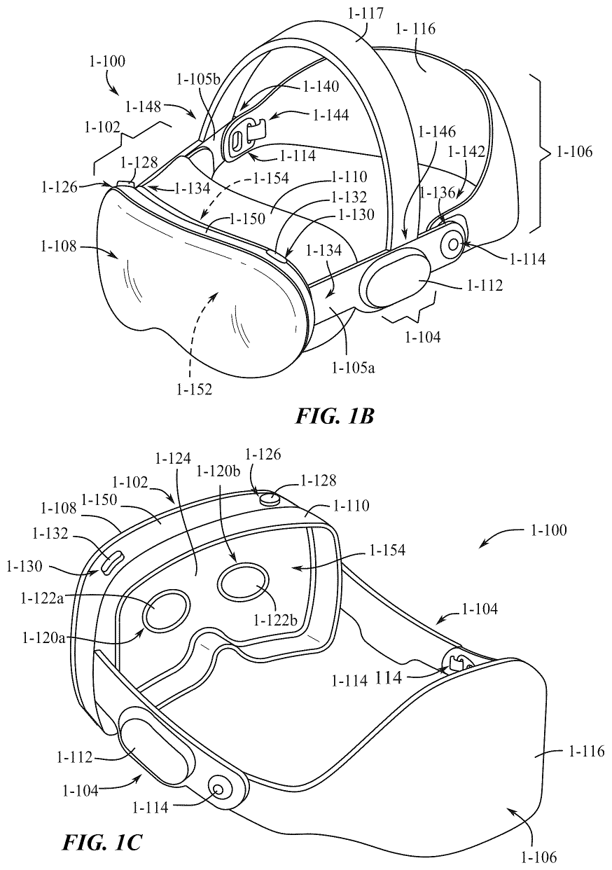

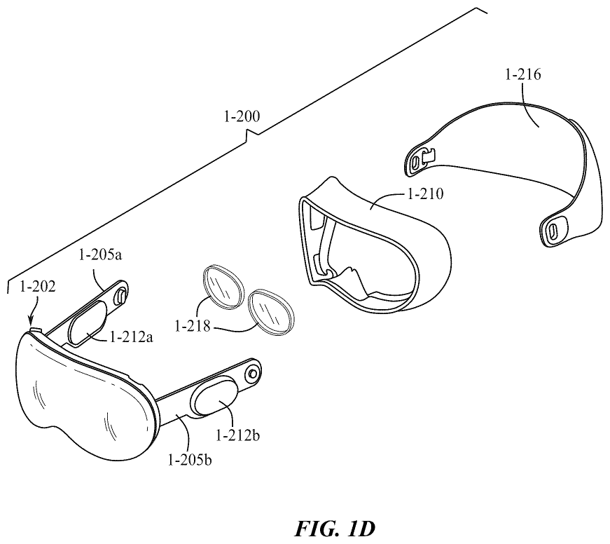

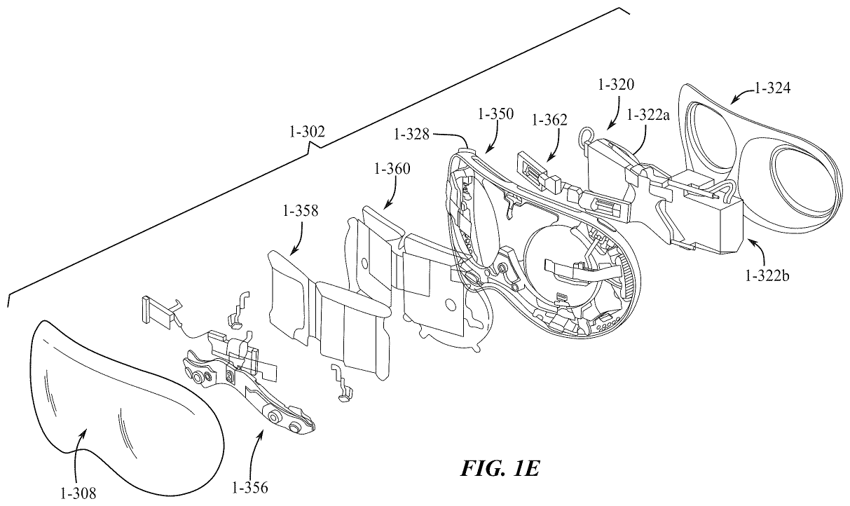

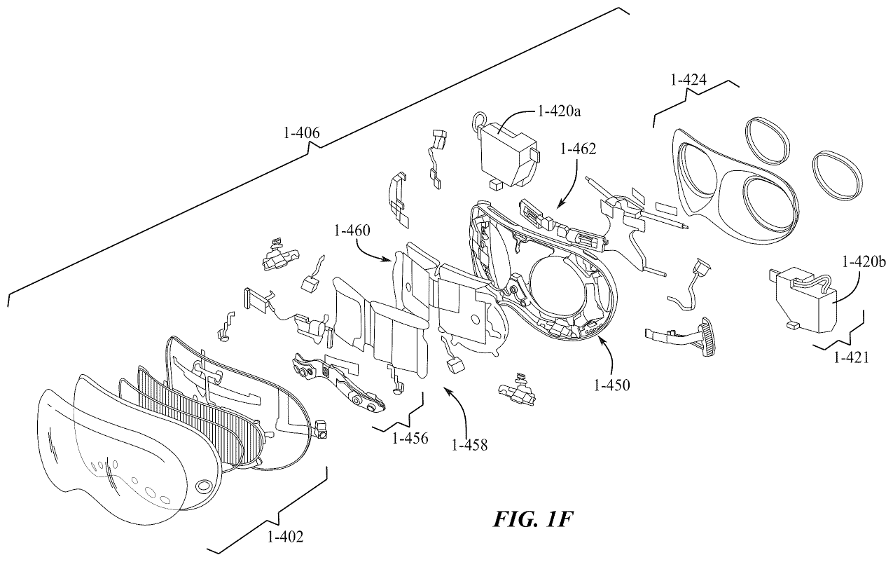

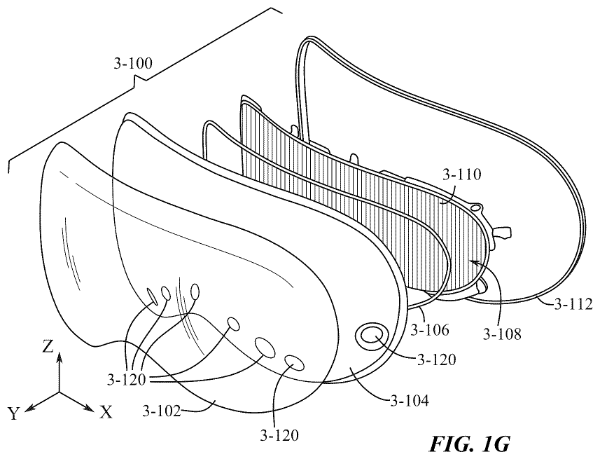

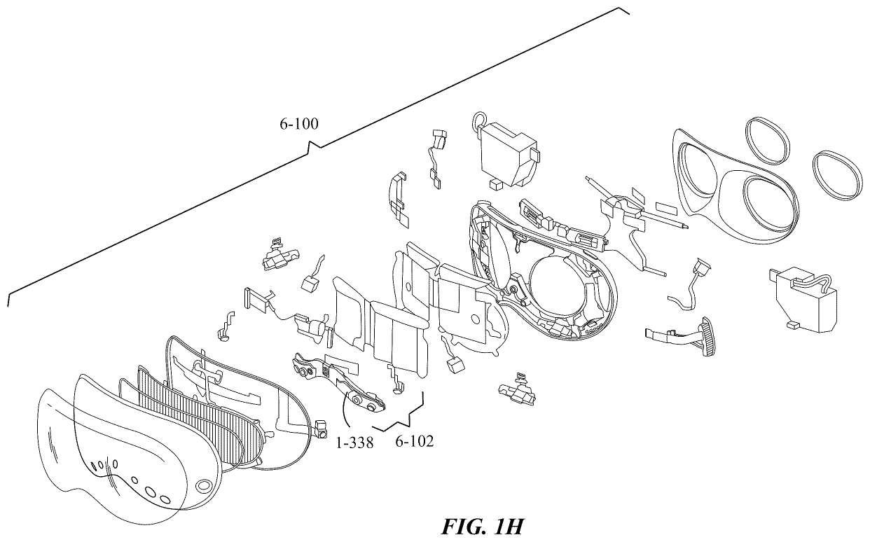

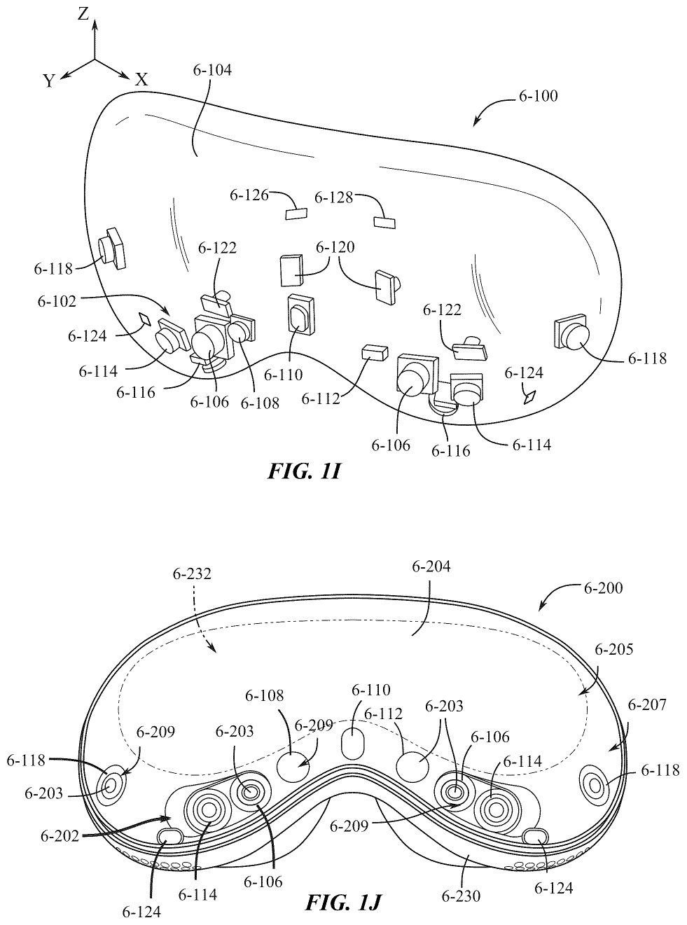

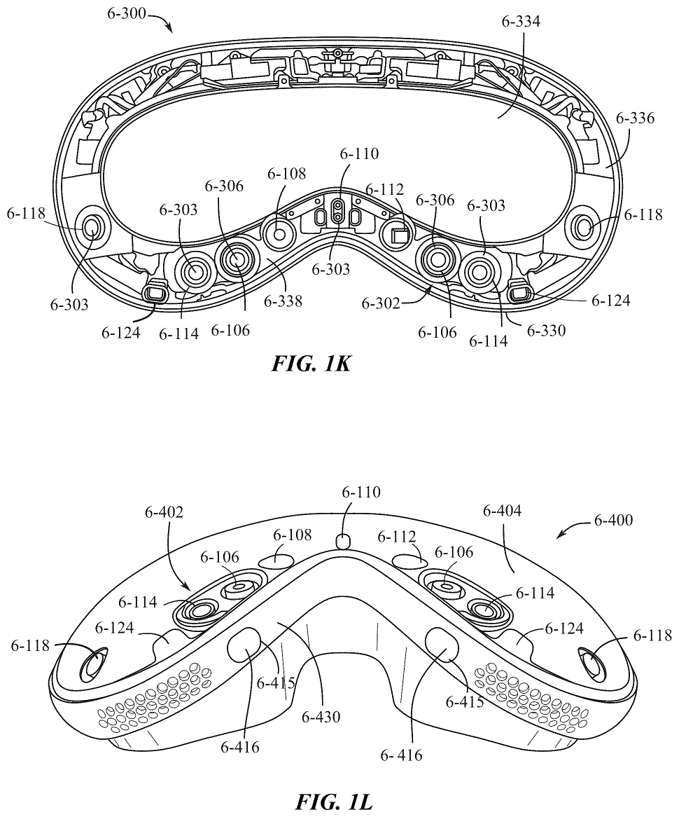

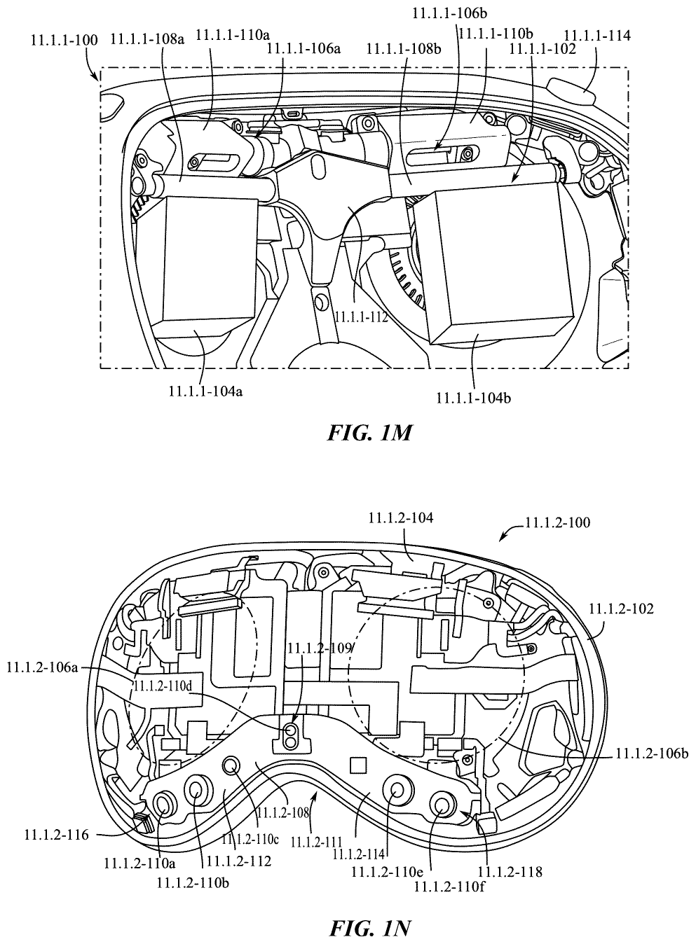

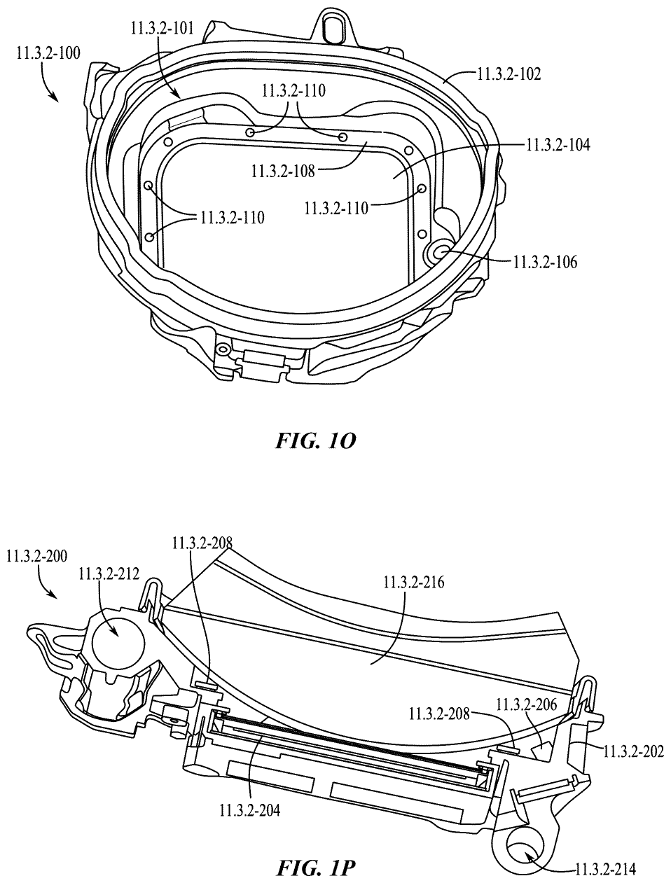

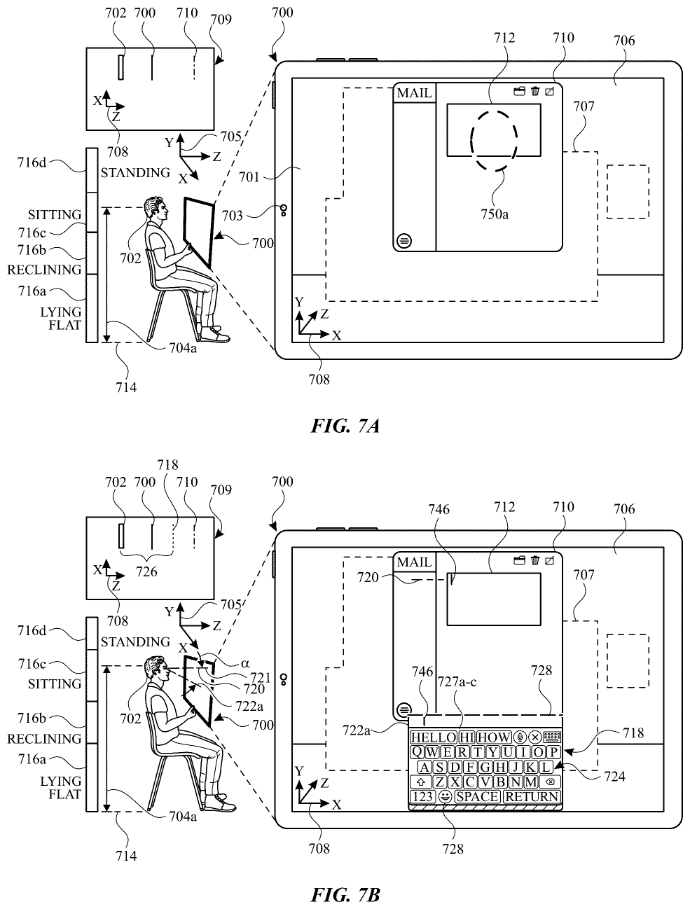

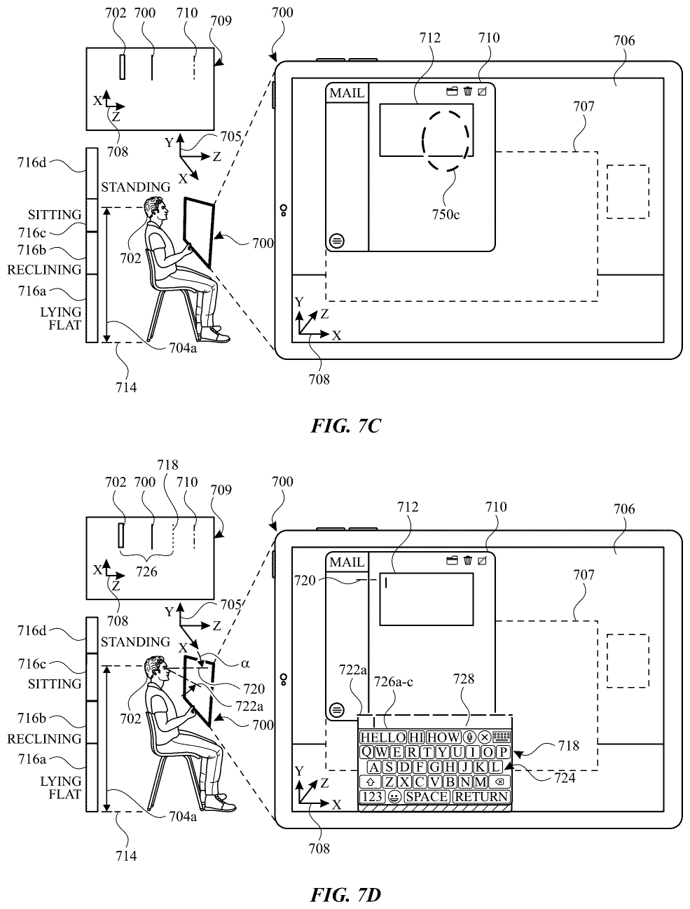

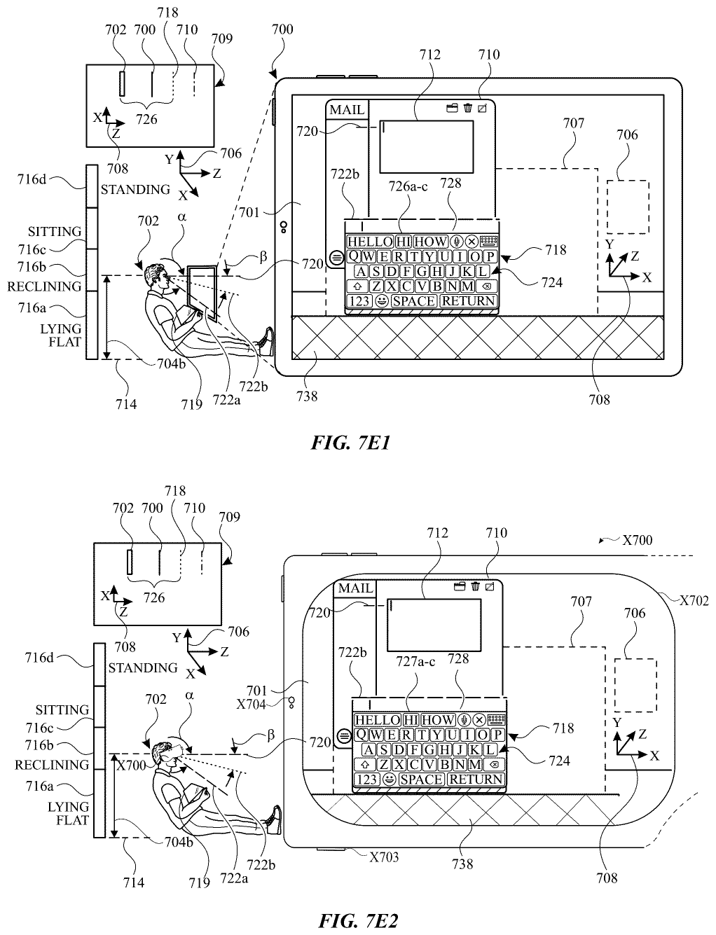

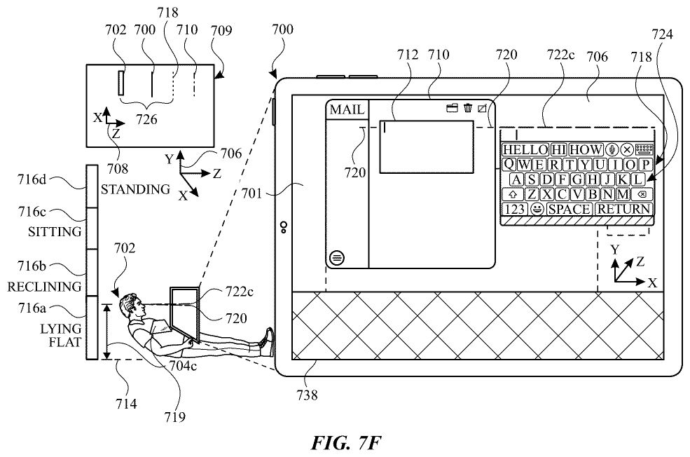

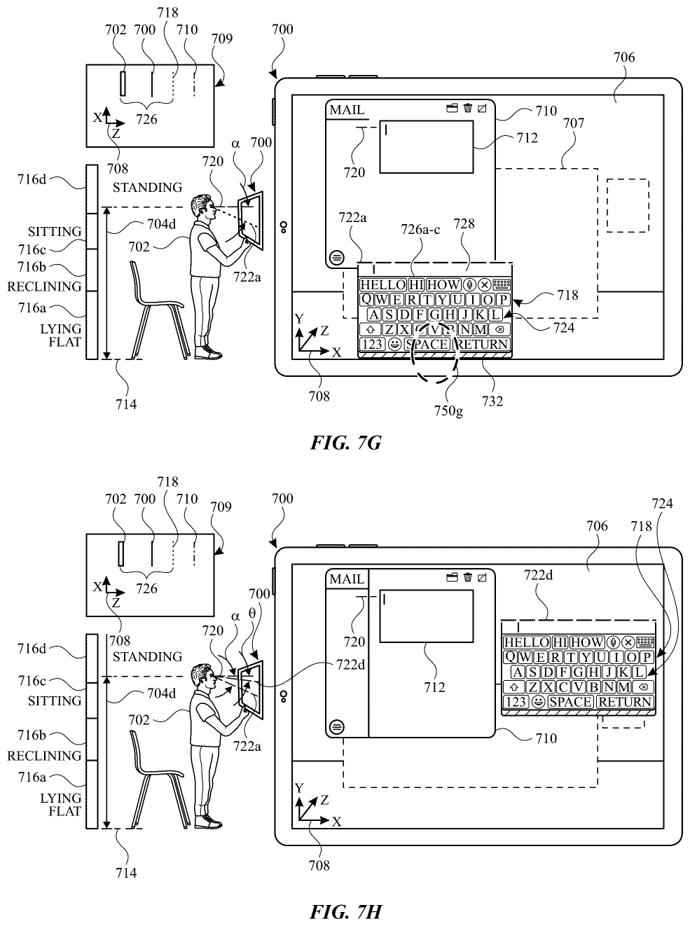

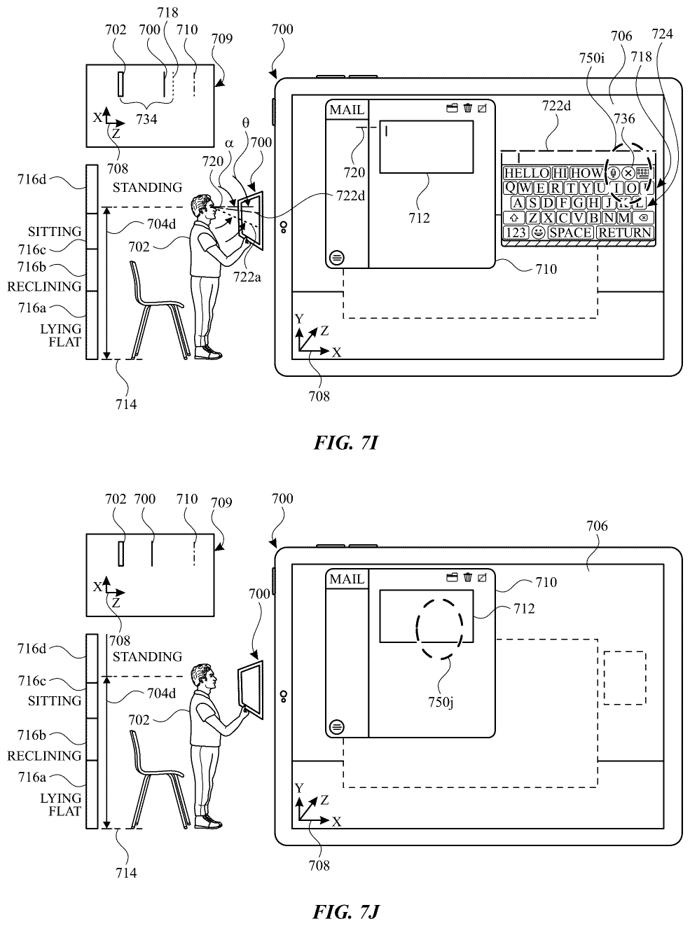

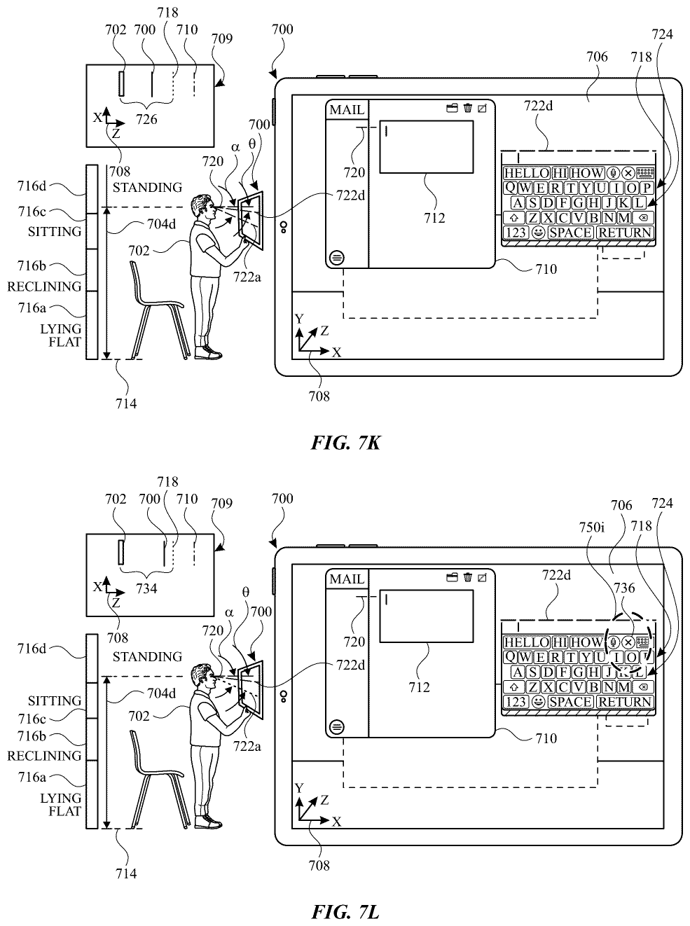

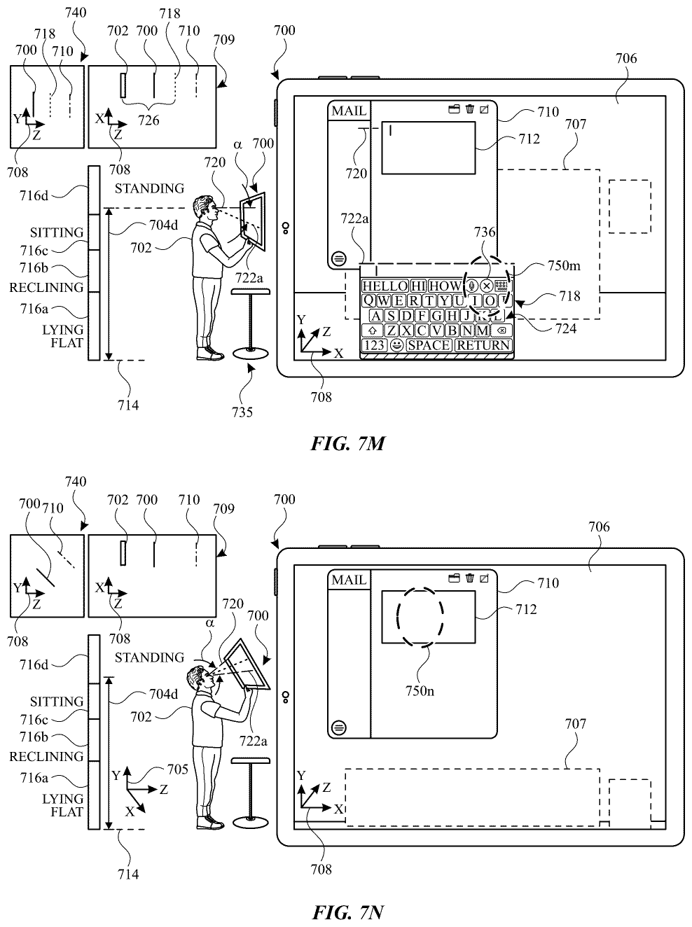

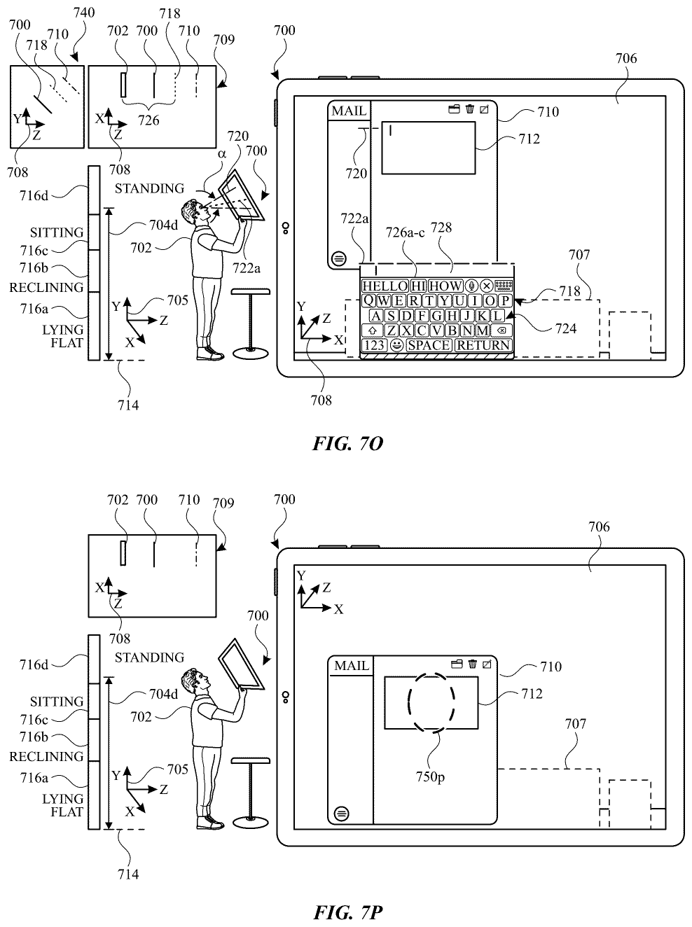

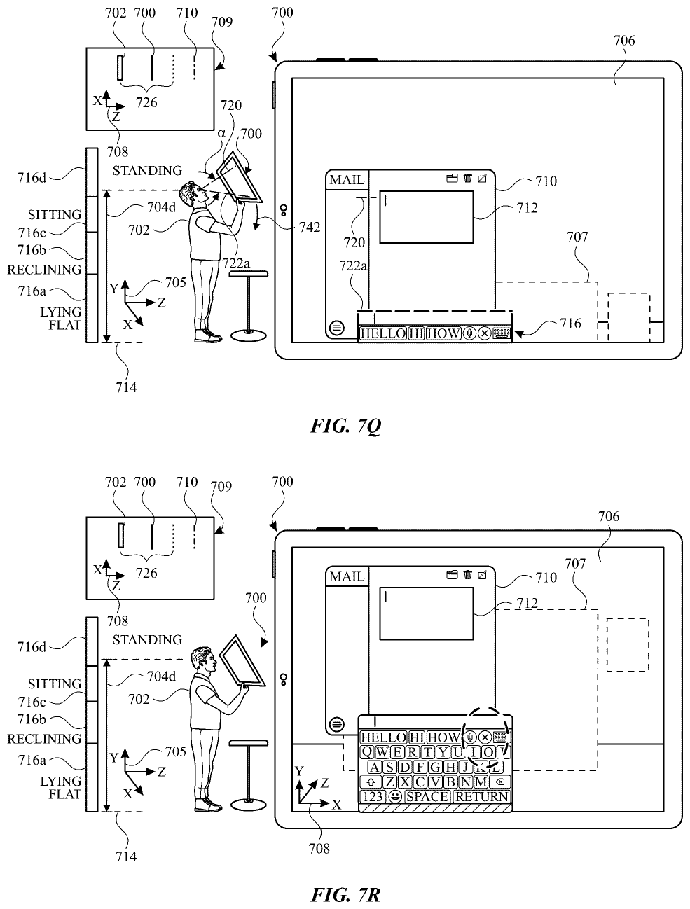

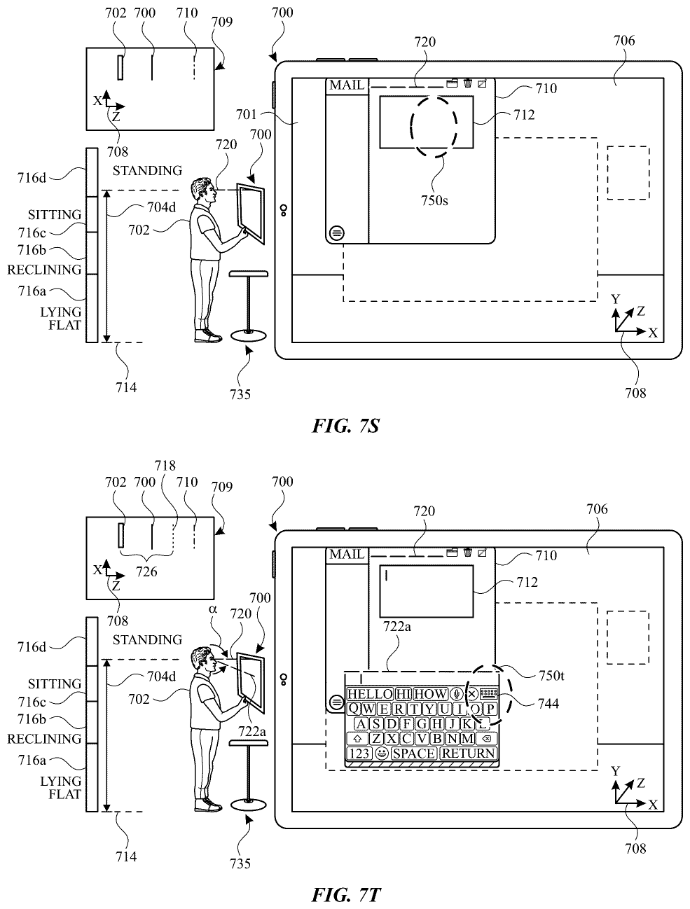

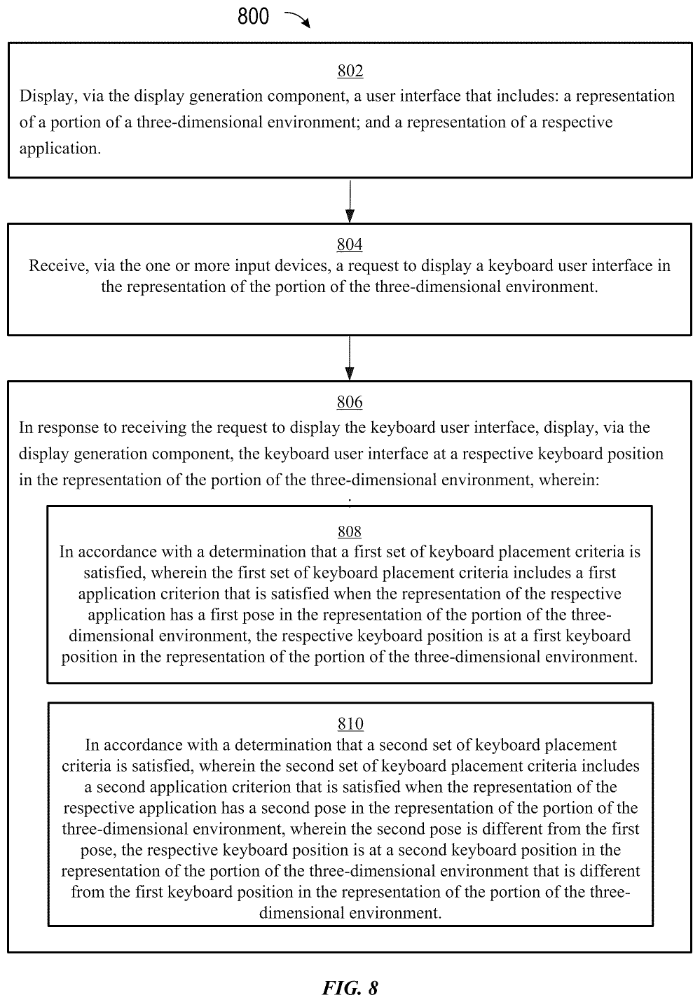

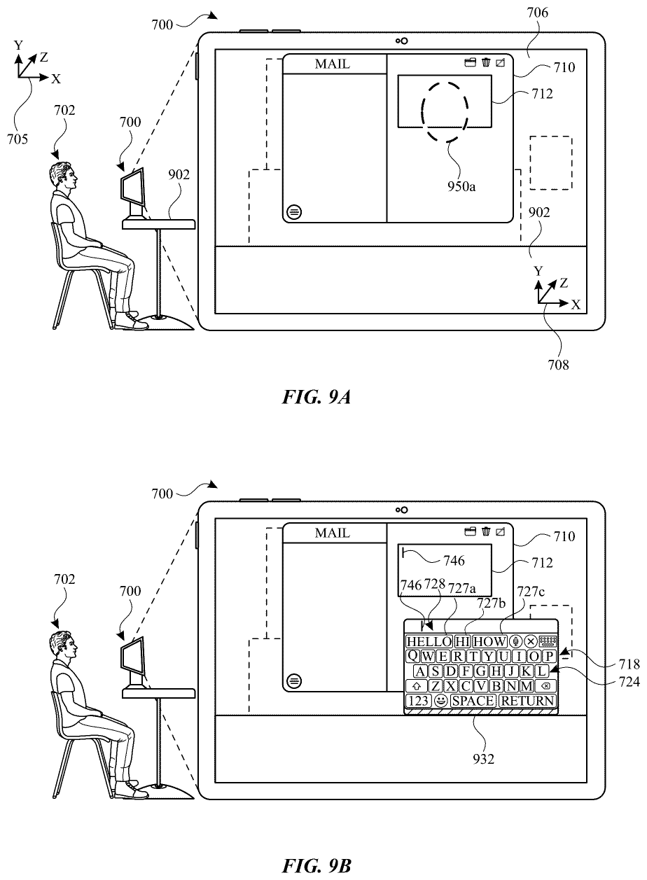

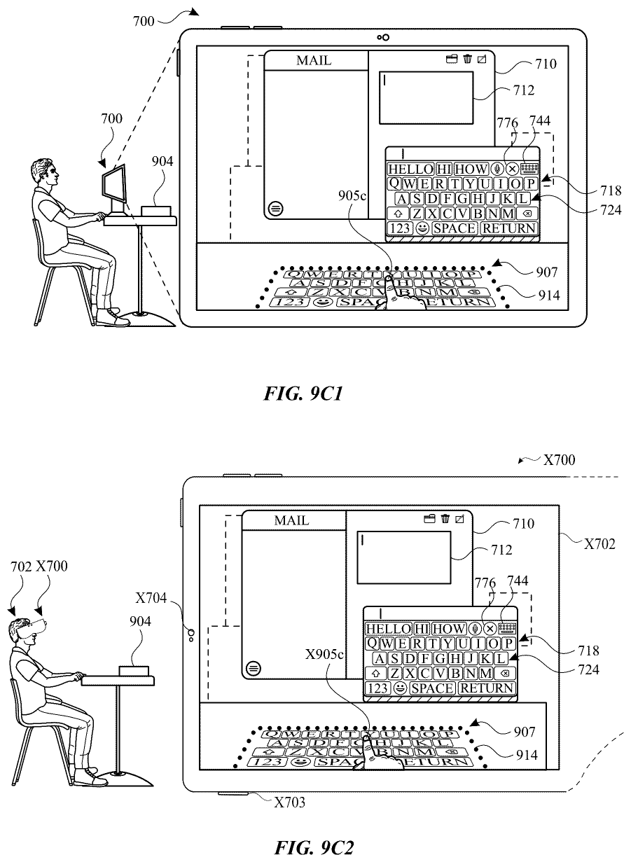

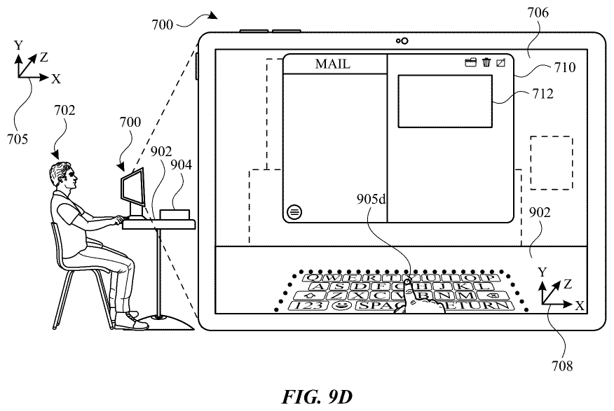

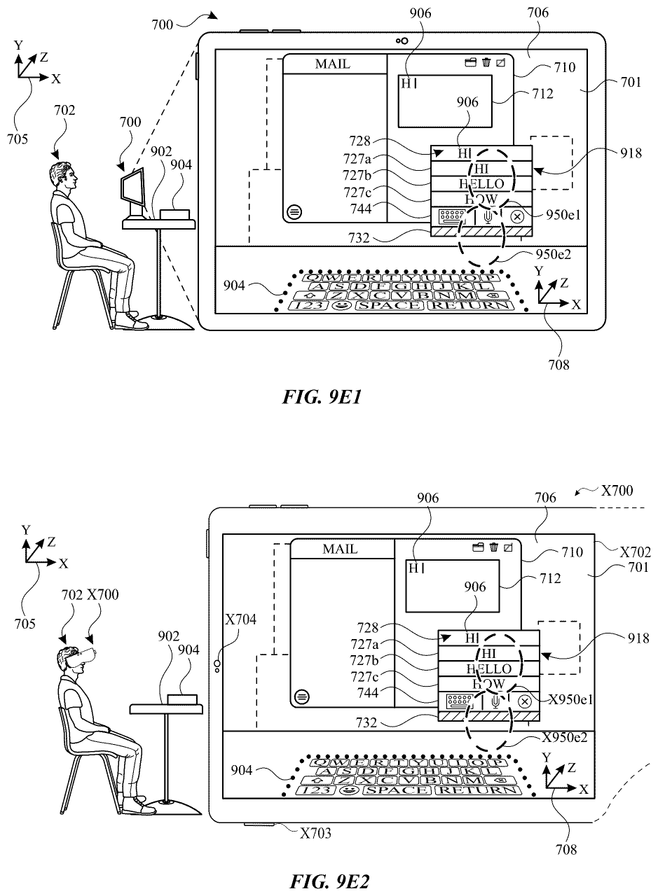

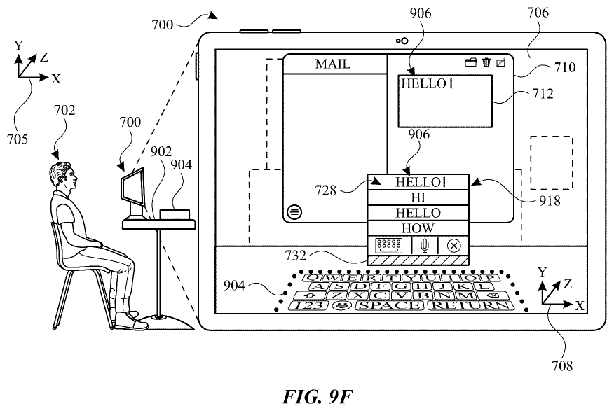

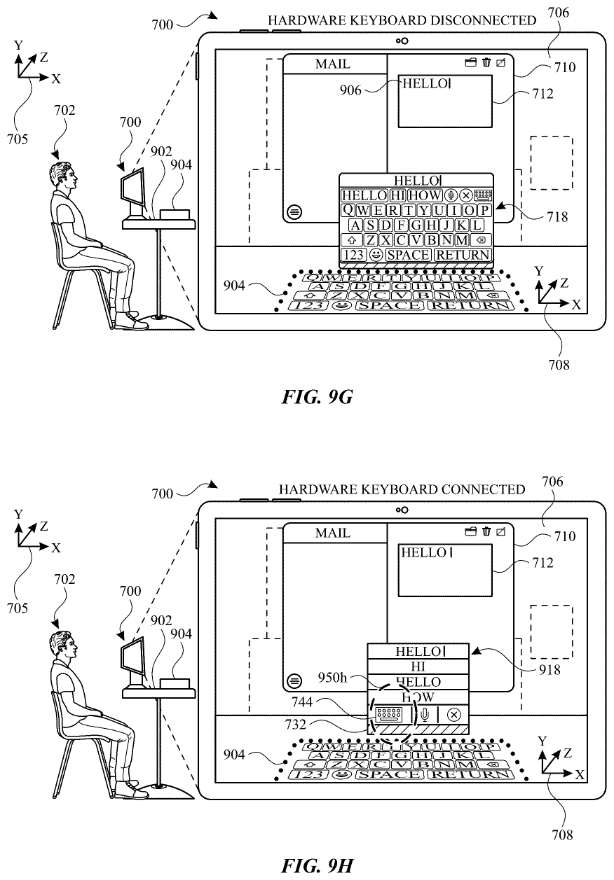

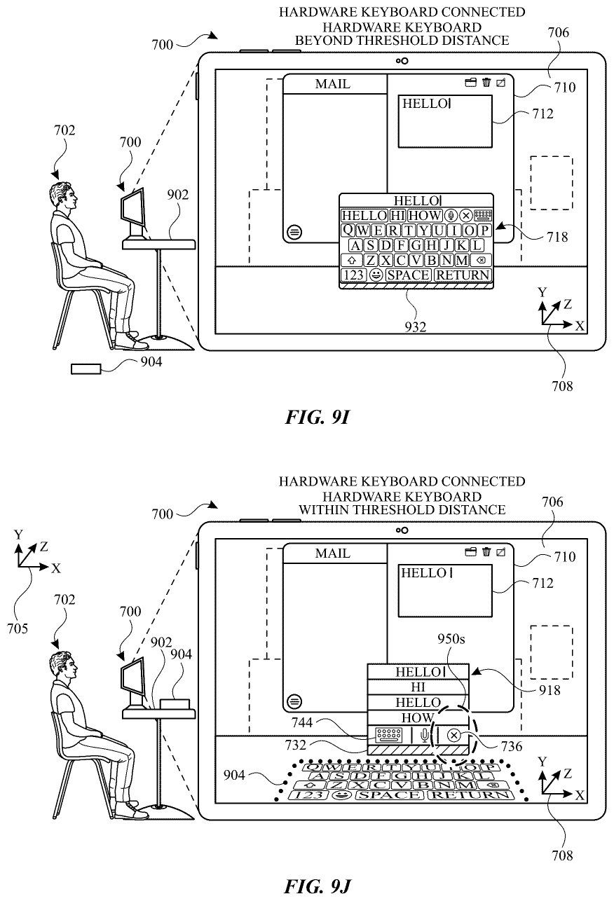

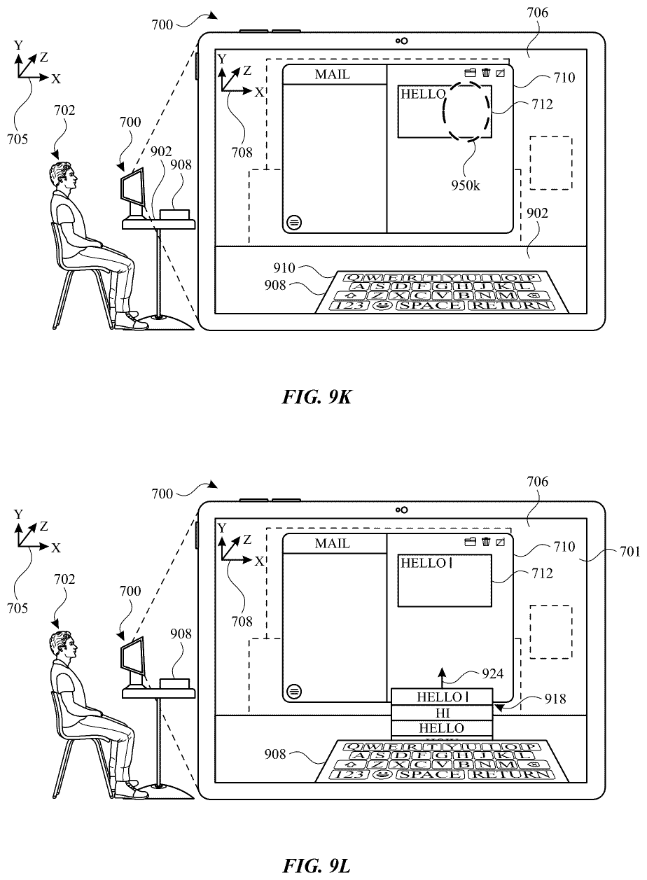

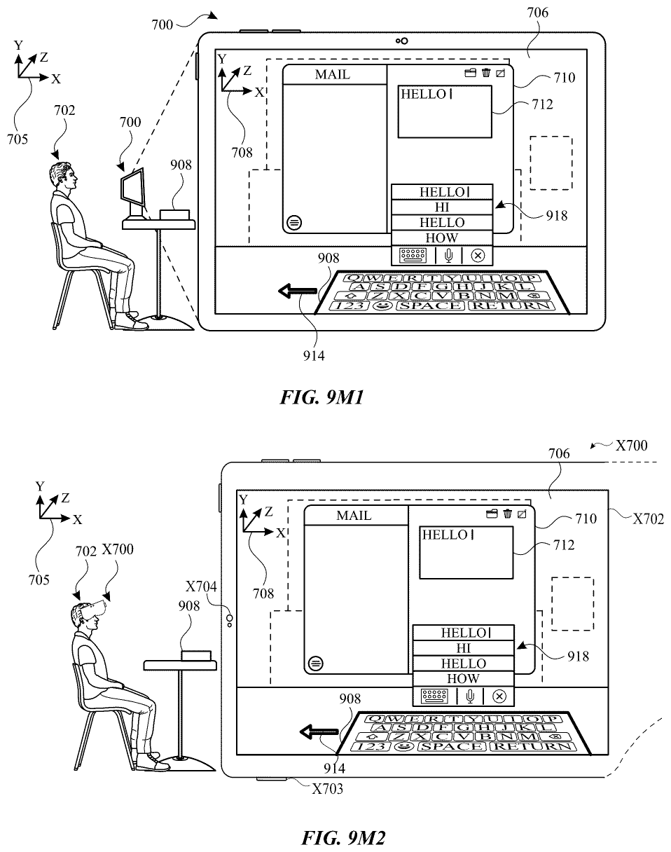

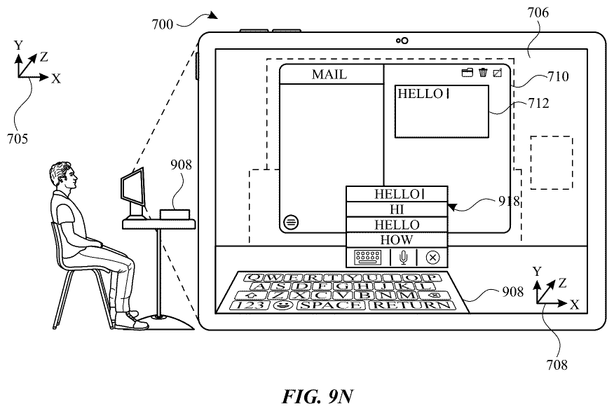

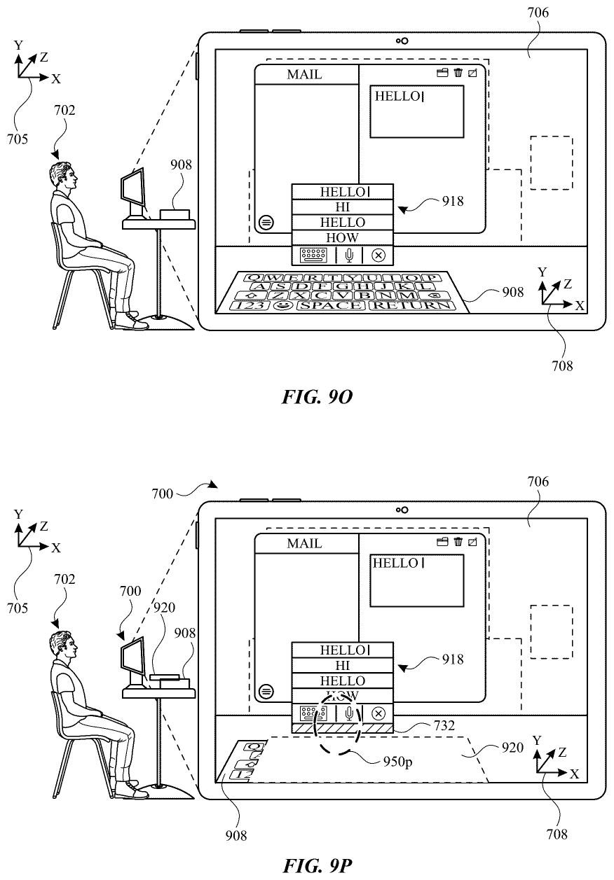

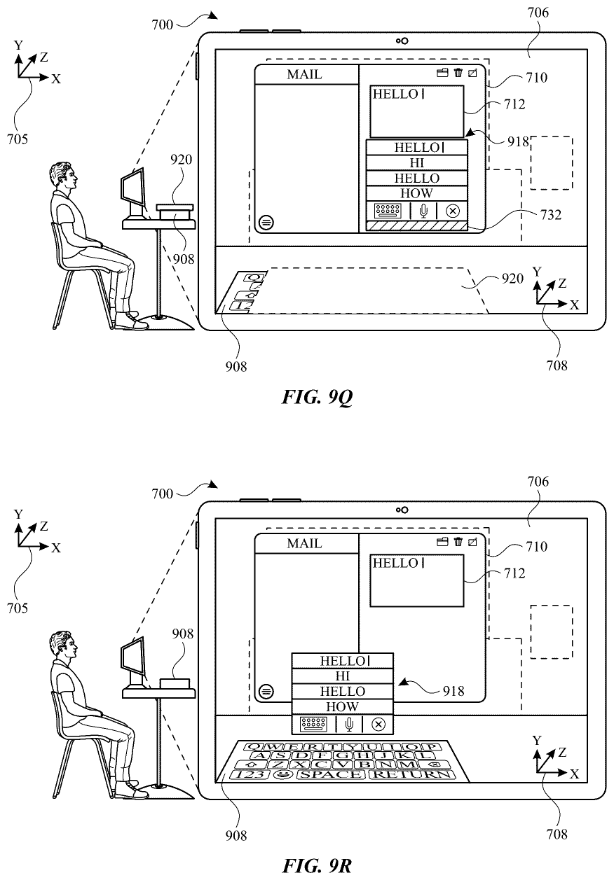

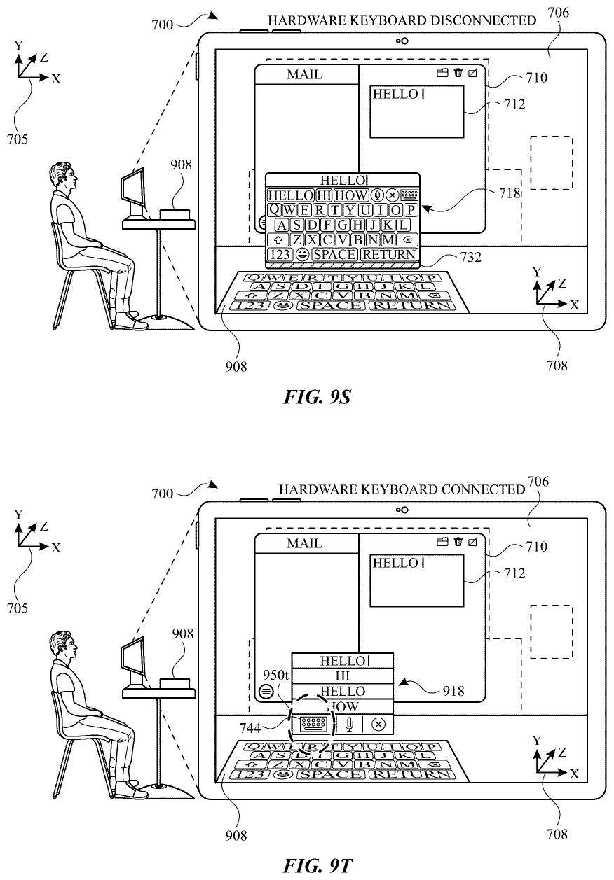

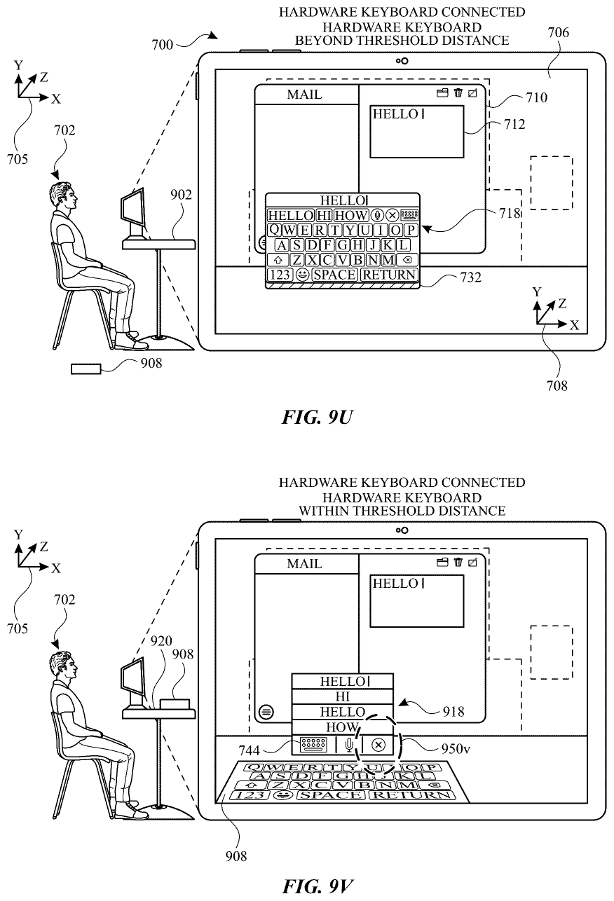

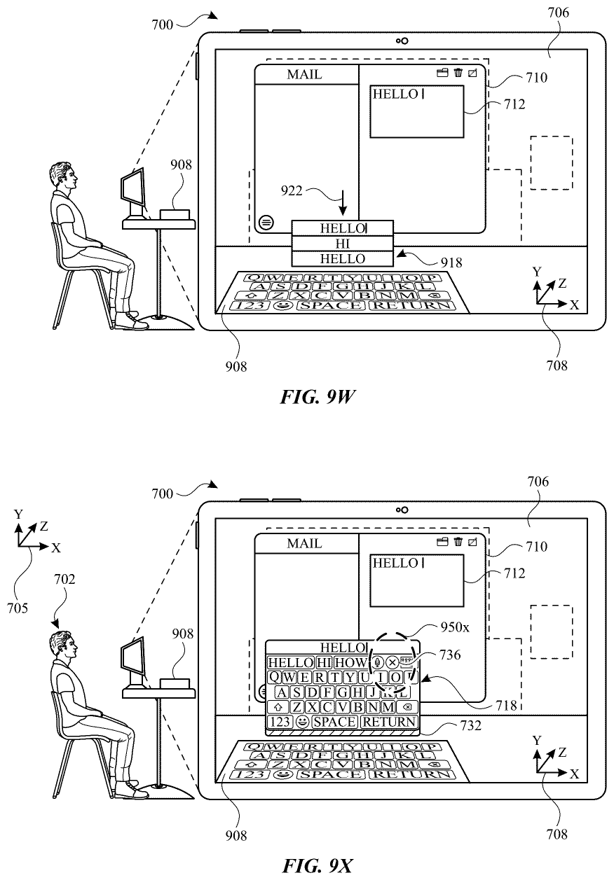

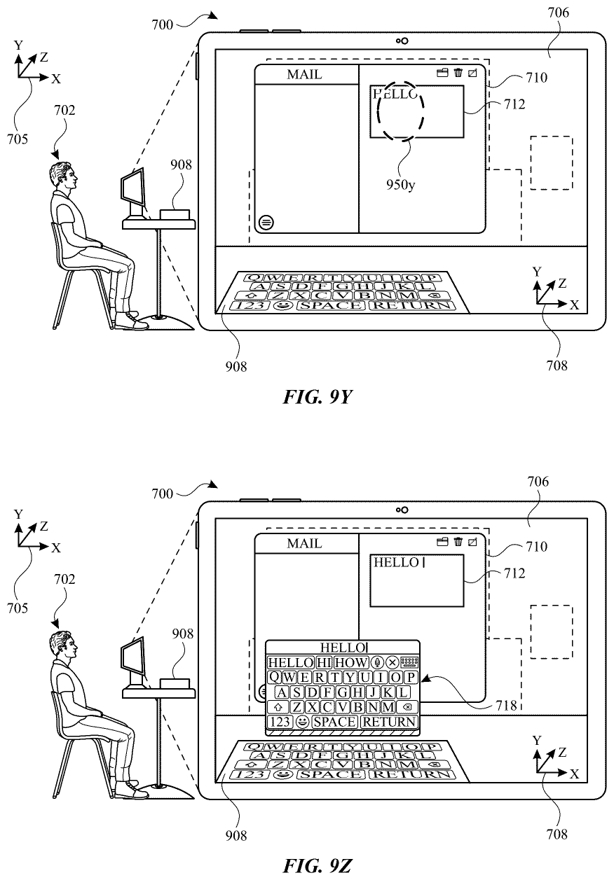

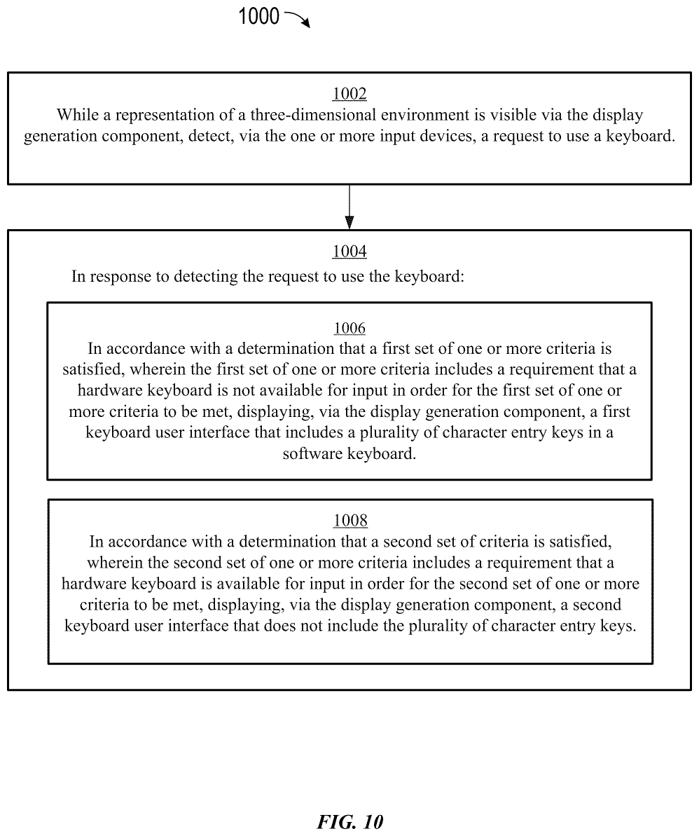

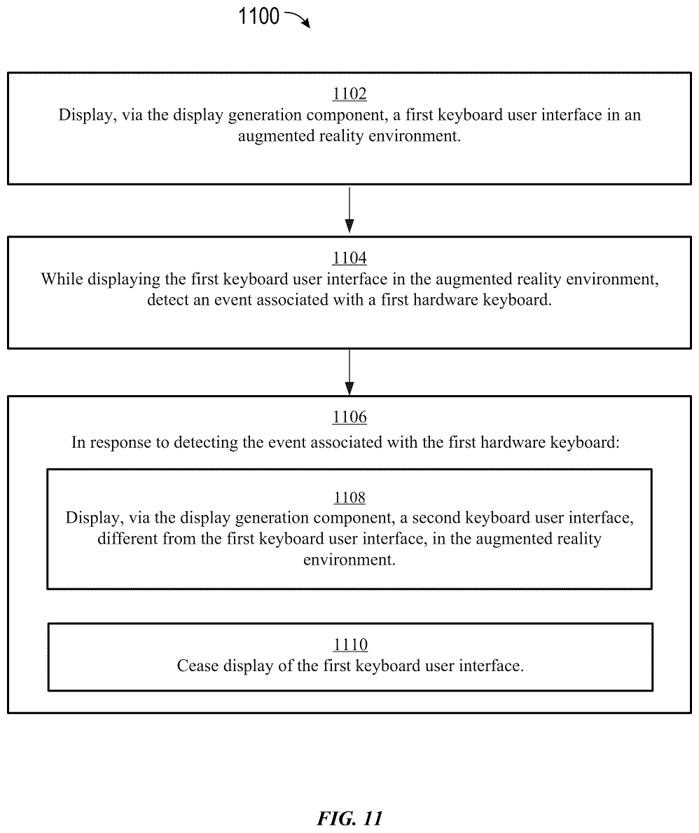

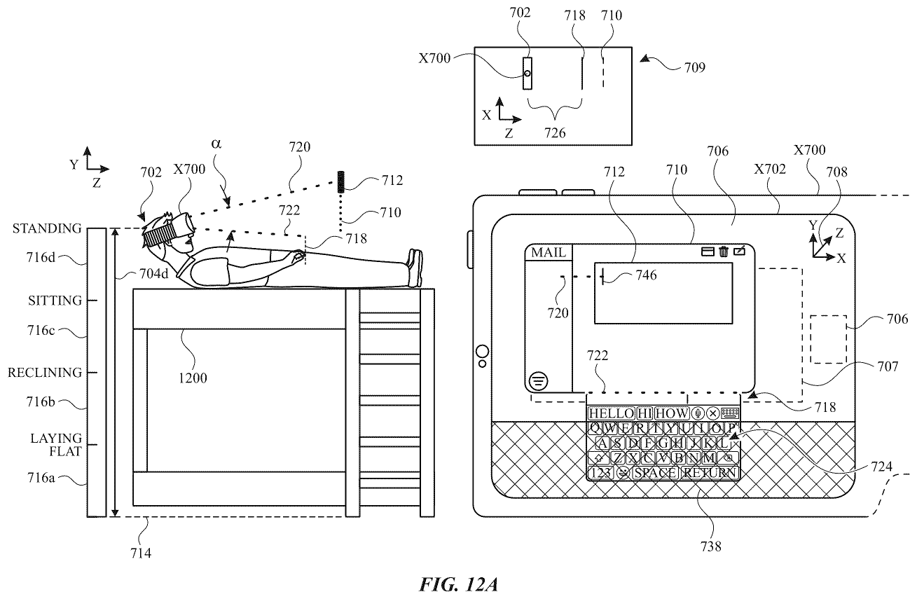

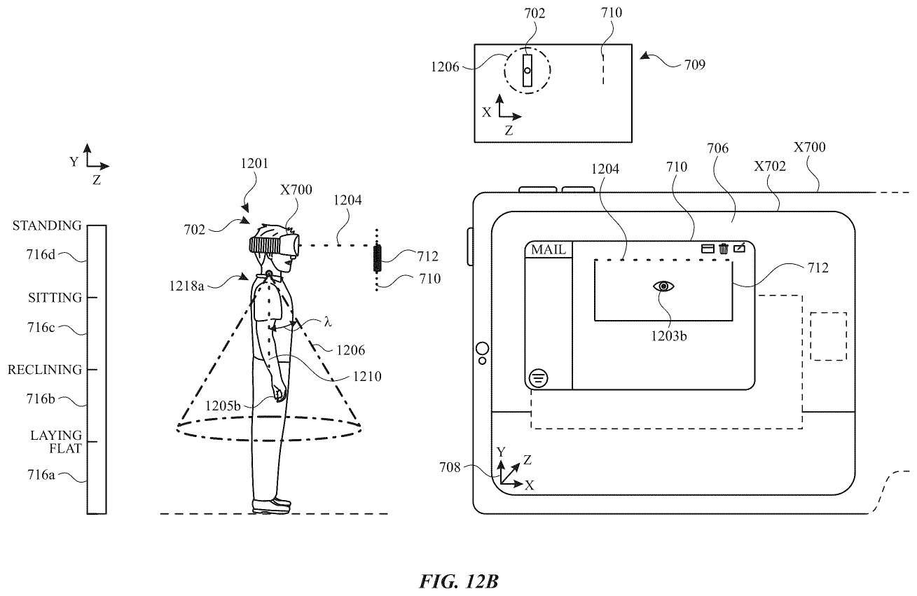

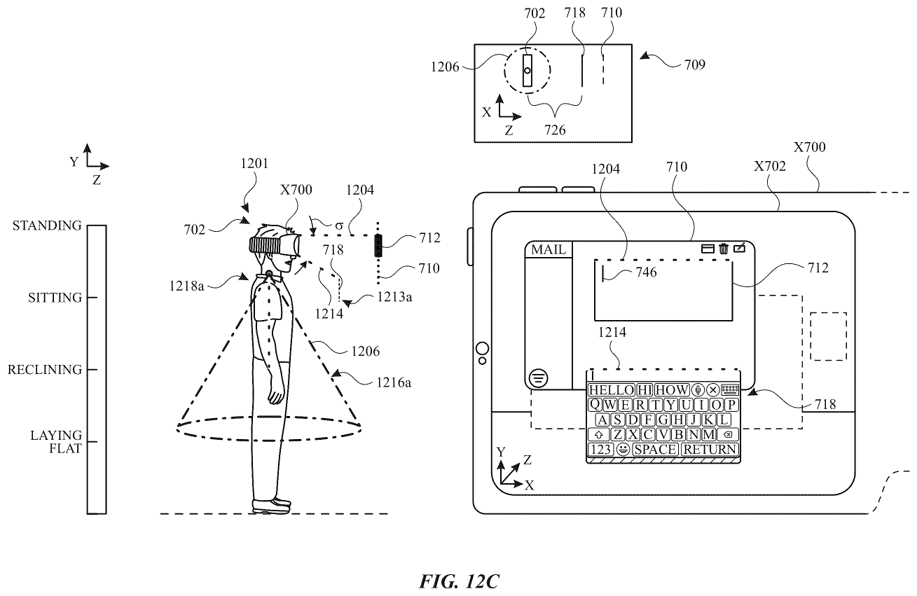

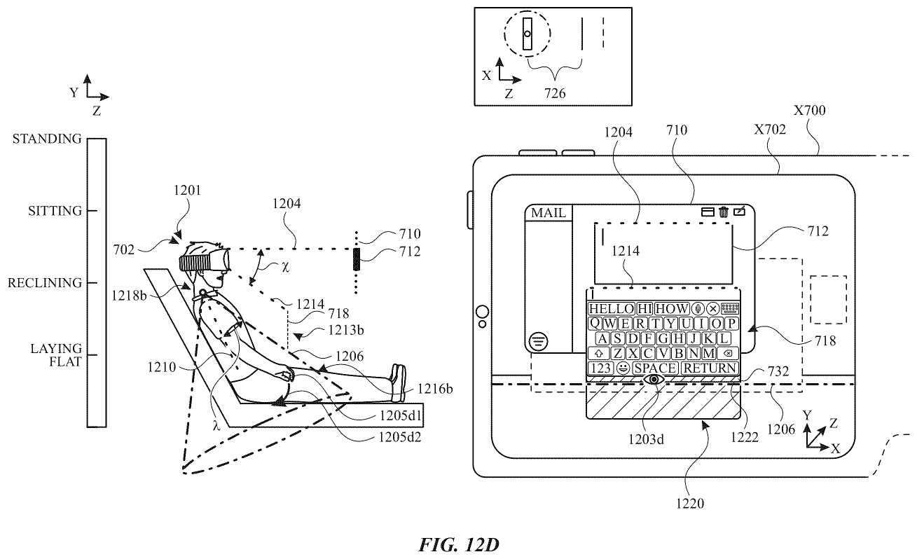

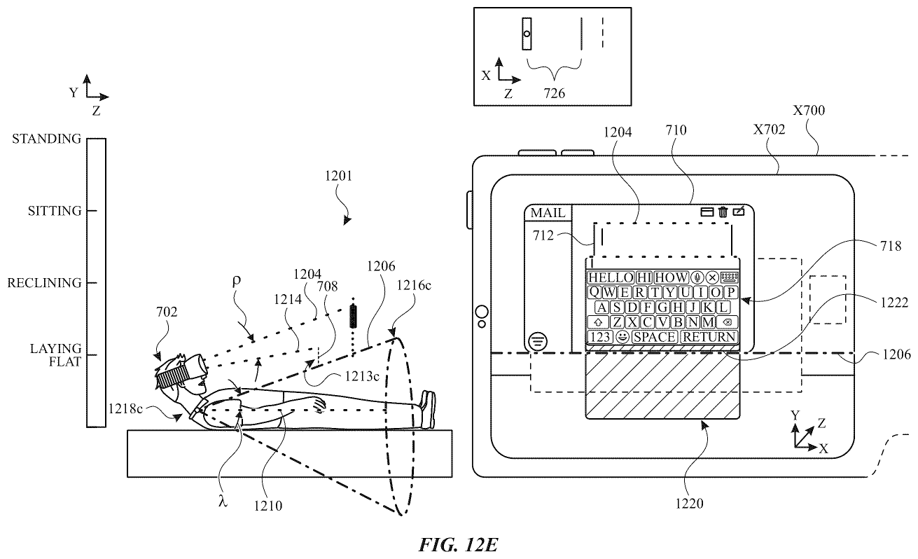

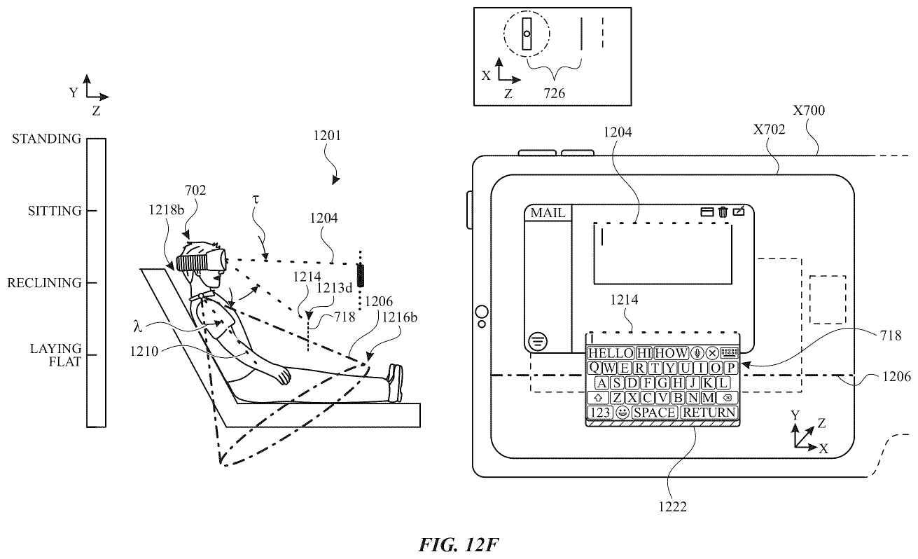

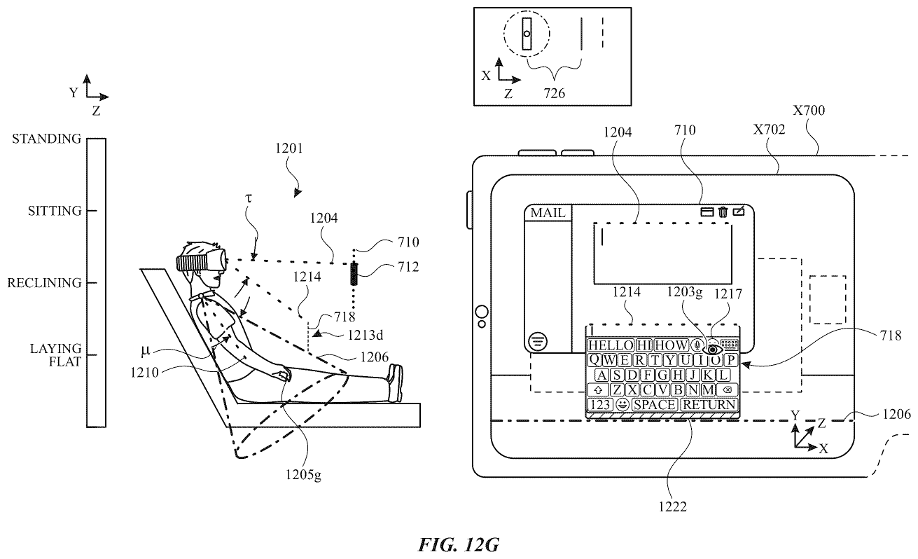

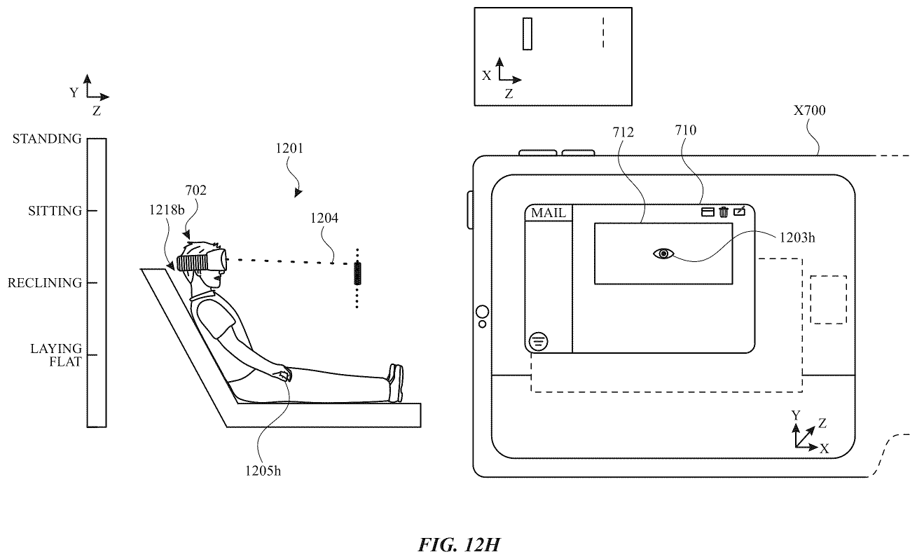

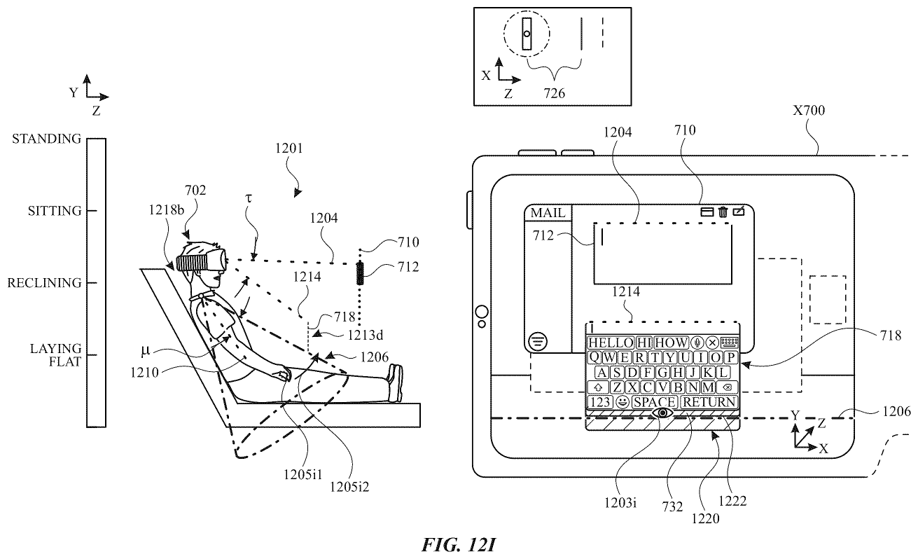

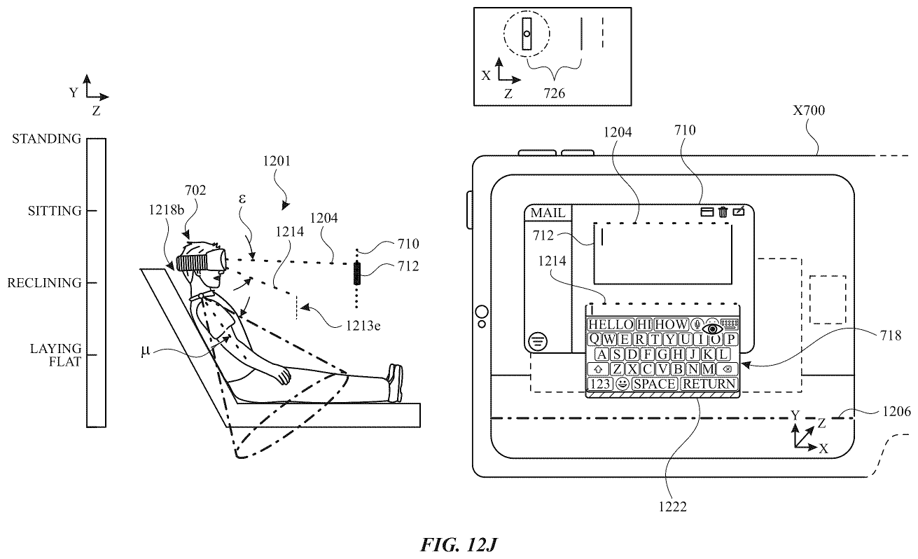

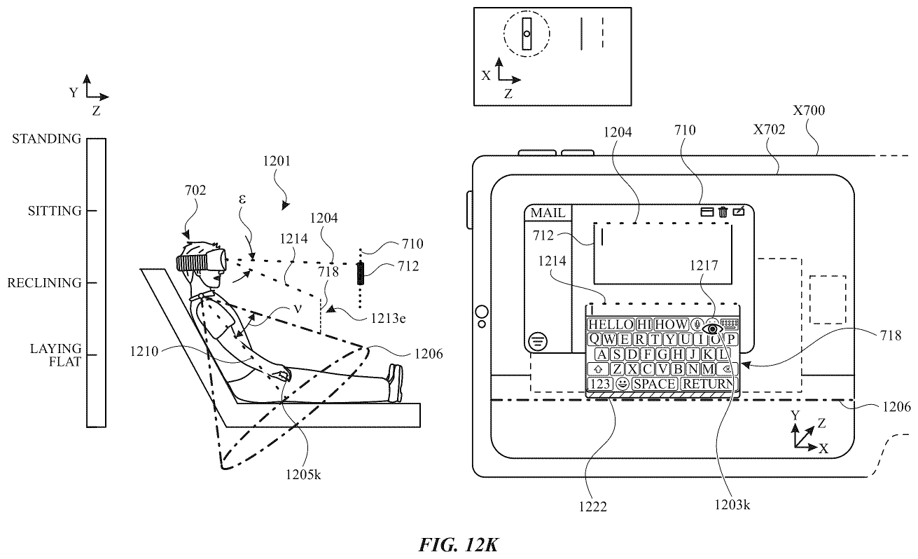

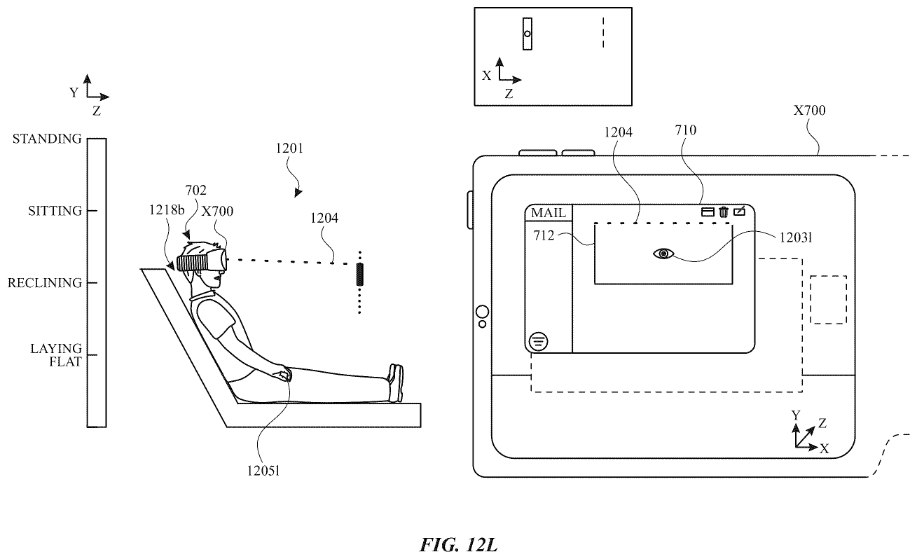

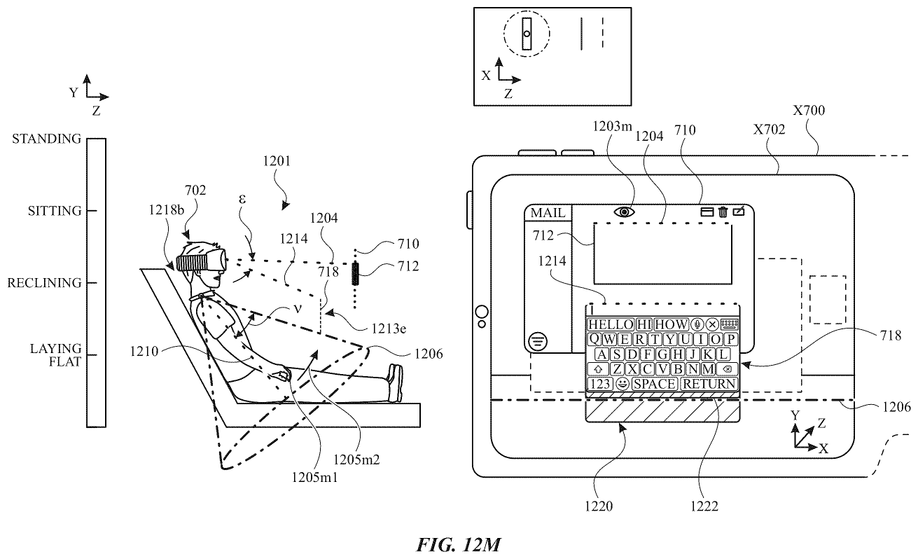

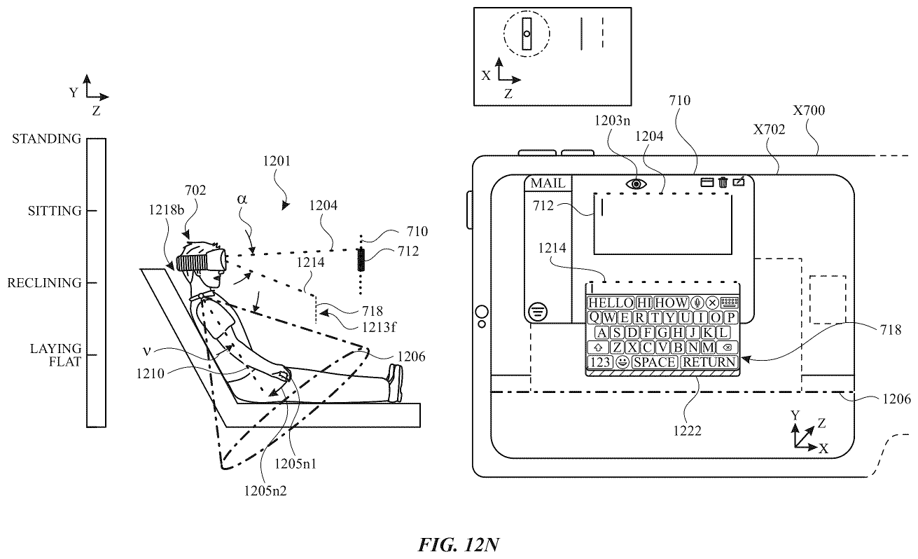

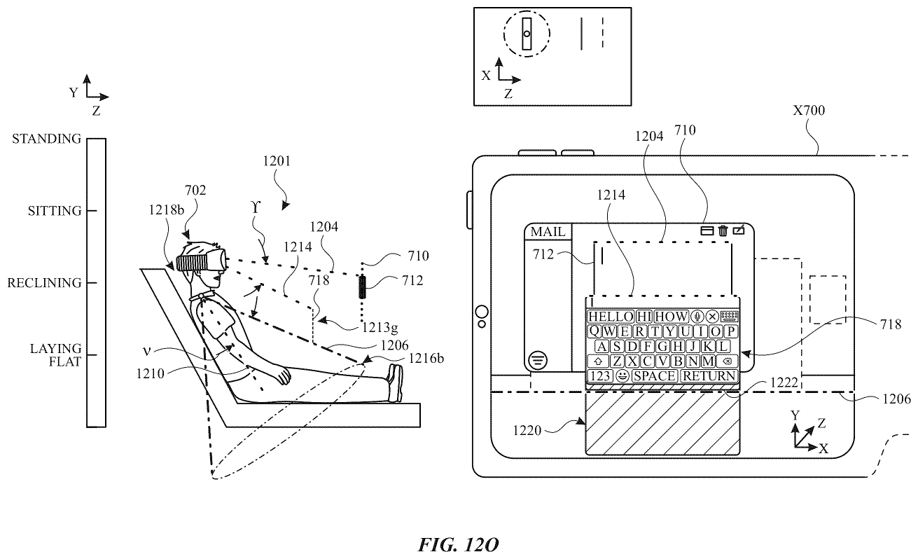

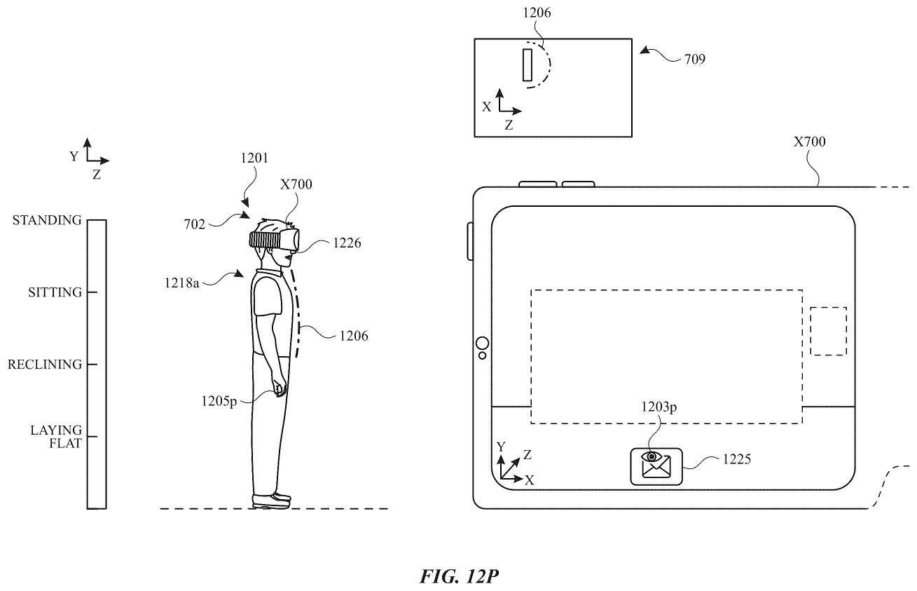

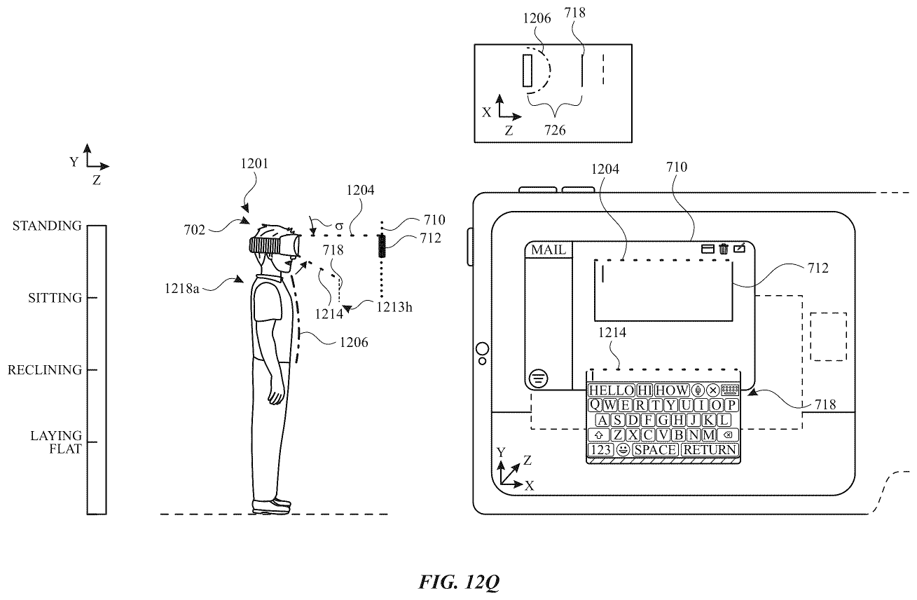

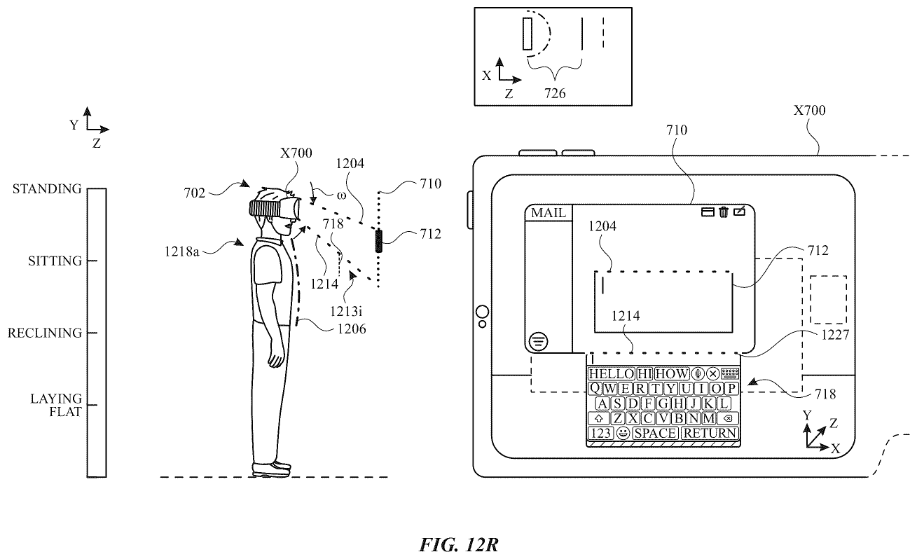

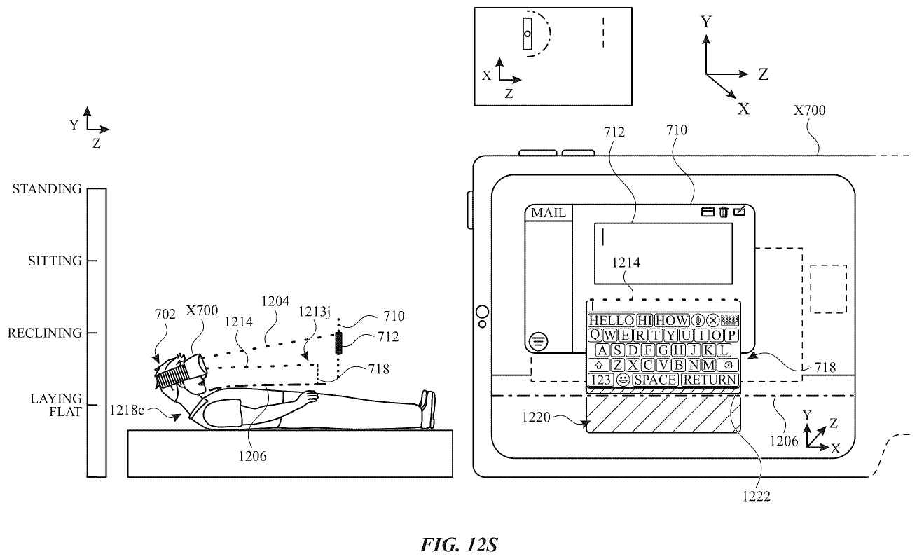

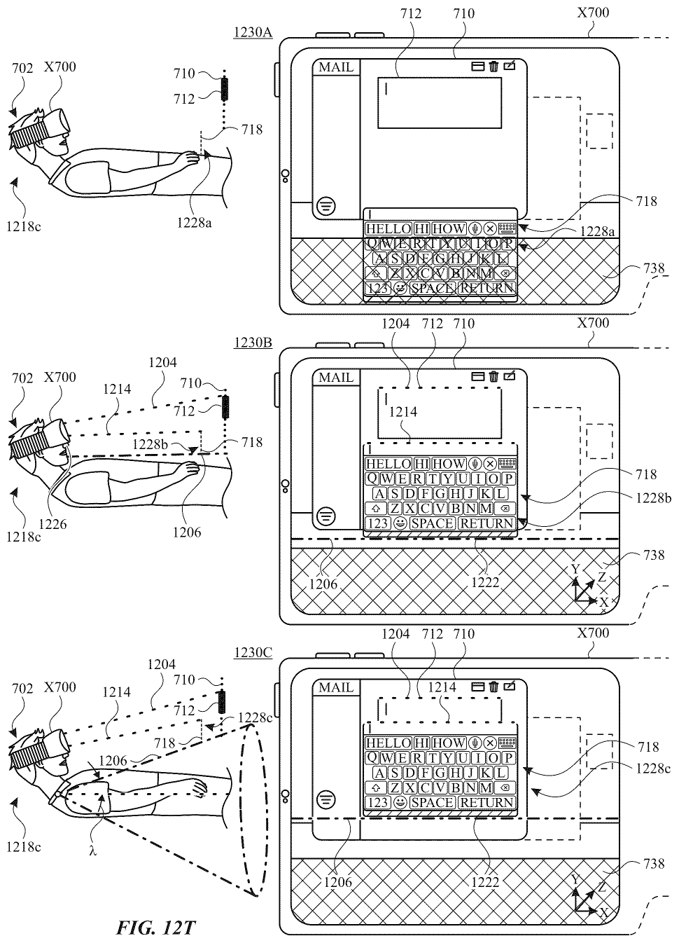

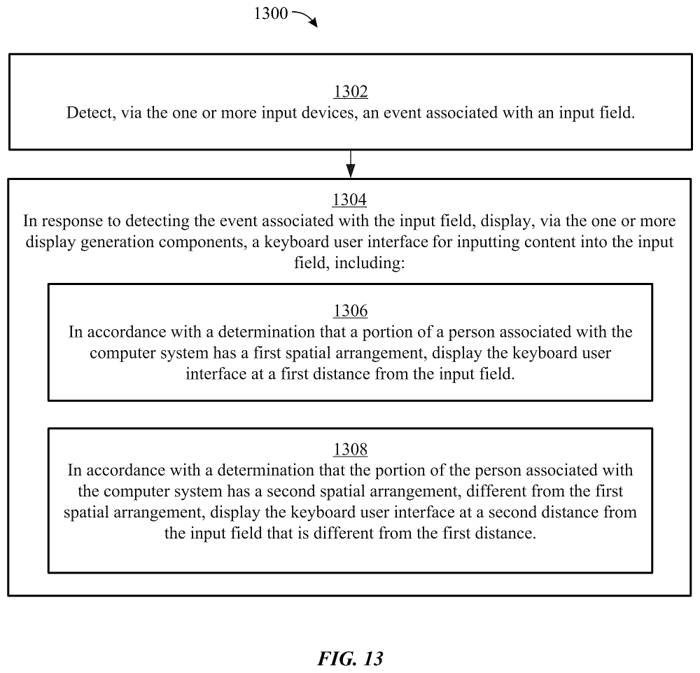

FIGS. 1A-6 provide a description of example computer systems for providing XR experiences to users. FIGS. 7A-7T illustrate example techniques for positioning a virtual keyboard in a three-dimensional environment, in some embodiments. FIG. 8 is a flow diagram of methods for positioning a virtual keyboard in a three-dimensional environment, in some embodiments. The user interfaces in FIGS. 7A-7T are used to illustrate the processes in FIG. 8. FIGS. 9A-9Z illustrate example techniques for displaying various types of keyboards and for switching between virtual keyboards, in some embodiments. FIG. 10 is a flow diagram of methods for displaying various types of virtual keyboards, in some embodiments. FIG. 11 is a flow diagram of methods for switching between virtual keyboards, in some embodiments. The user interfaces in FIGS. 9A-9Z are used to illustrate the processes in FIGS. 10-11. FIGS. 12A-12T illustrate example techniques of positioning a virtual keyboard based on a person's position, in some embodiments. FIG. 13 is a flow diagram of methods for positioning a virtual keyboard based on a person's position, in some embodiments. The techniques and user interfaces in FIGS. 12A-12T are used to illustrate the processes in FIG. 13.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing a XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 11-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 11-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 11-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

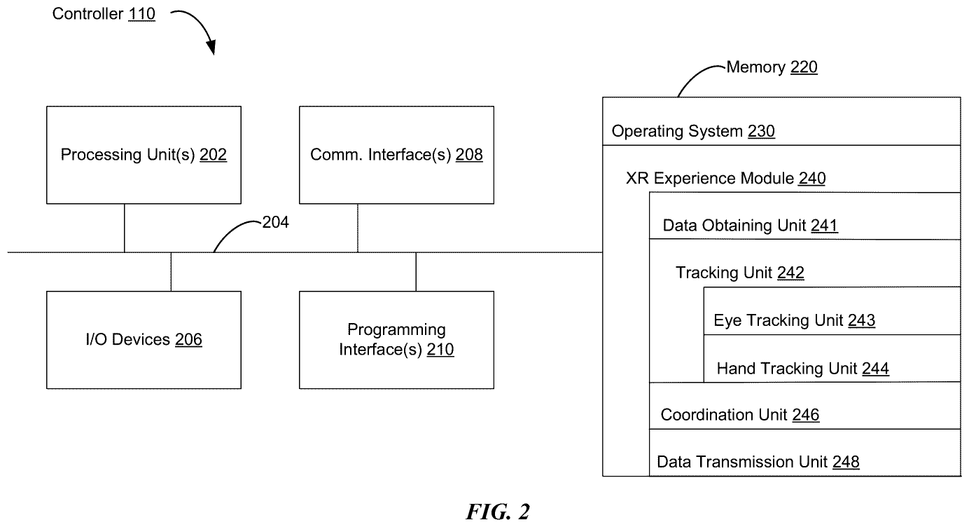

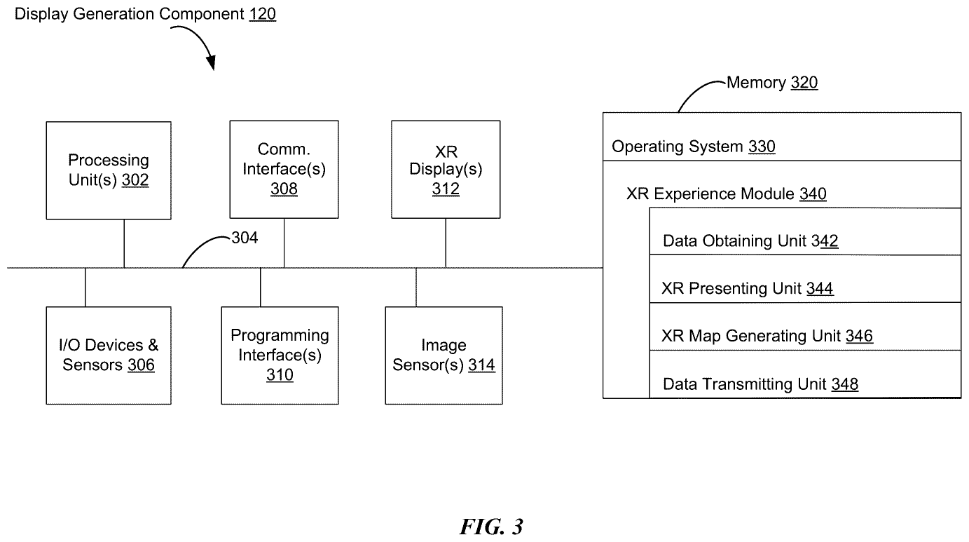

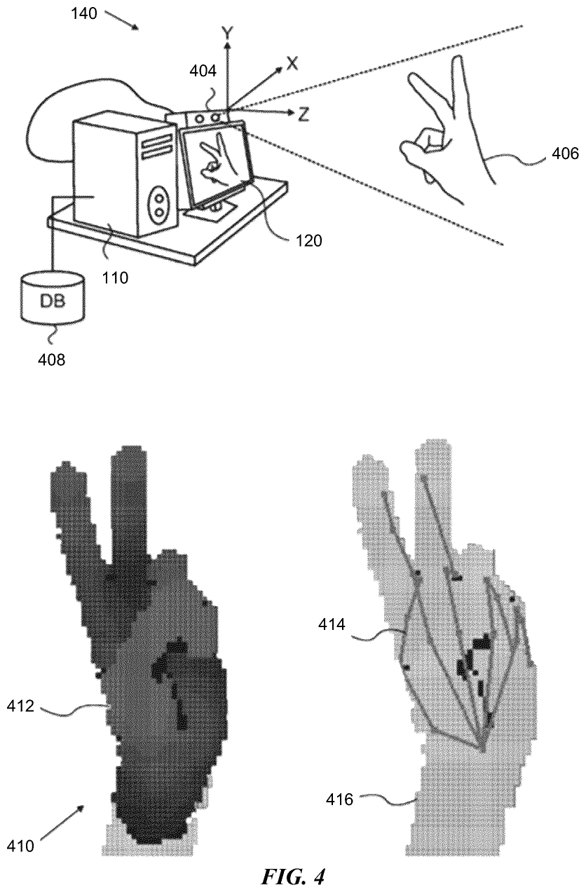

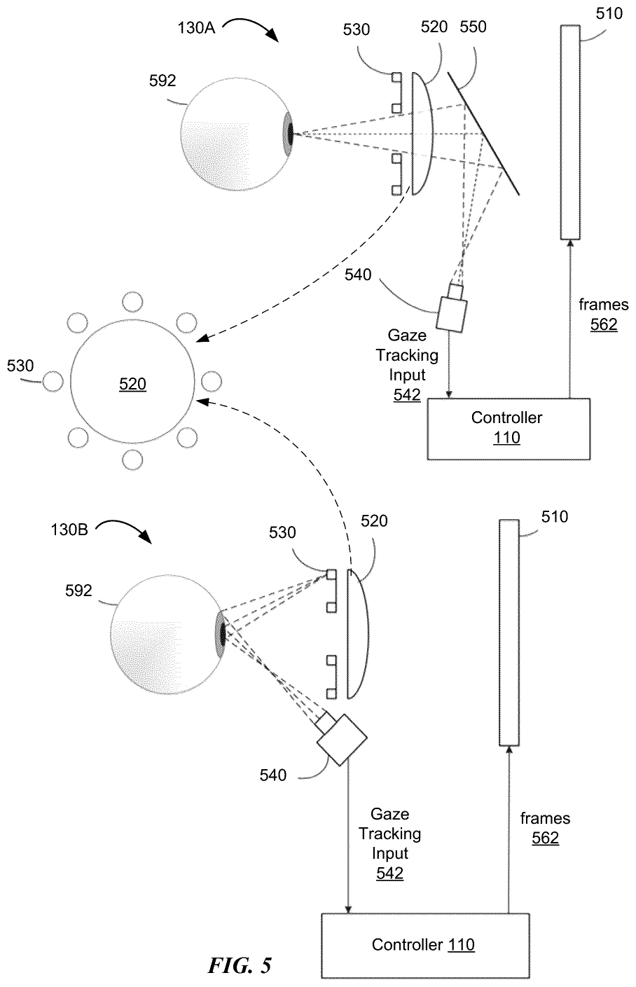

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand). In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) (or part(s) of the user's hand) for interacting with an XR environment (e.g., a virtual or mixed-reality environment), in some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand). In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user, user inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, wherein the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

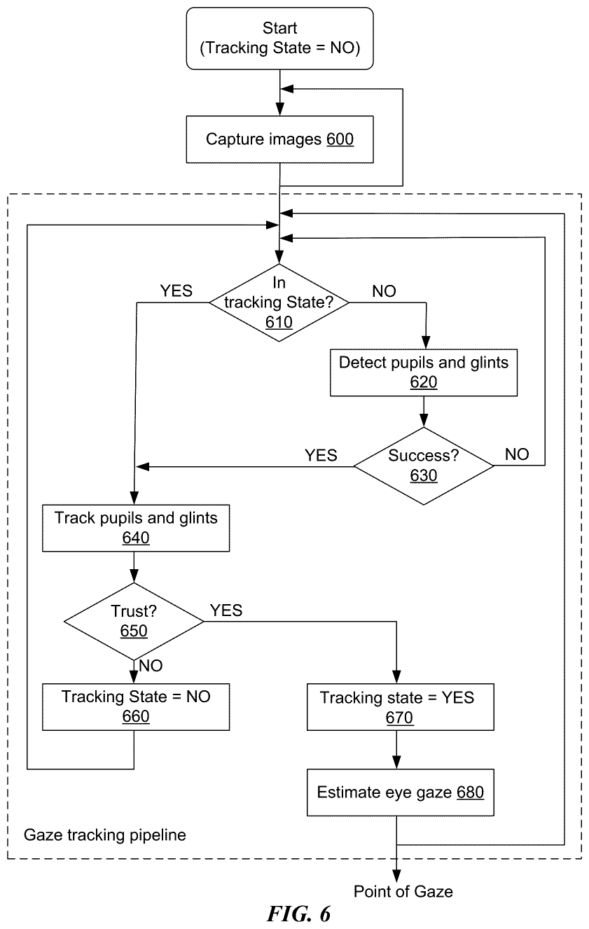

FIG. 6 illustrates a glint-assisted gaze tracking pipeline, in some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in some embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with a display generation component, one or more input devices, and (optionally) one or cameras.

FIGS. 7A-7T illustrate examples of positioning a virtual keyboard in a three-dimensional environment. FIG. 8 is a flow diagram of an exemplary method 800 for positioning a virtual keyboard in a three-dimensional environment. The user interfaces in FIGS. 7A-7T are used to illustrate the processes described below, including the processes in FIG. 8.

FIGS. 7A-7T illustrate examples of device 700 being held by user 702. In some embodiments, device 700 is a head-mounted device. In some embodiments, a virtual keyboard is displayed as part of an extended reality user interface and/or extended reality environment/experience. In some such embodiments, display of a virtual keyboard can be affected by the position of one or more objects in the environment, including one or more body parts of the user (e.g., as the user shifts his or her viewpoint by moving his or her head). In such embodiments, a virtual keyboard is placed so as to facilitate a better interaction with the virtual keyboard while device 700 is working. Additionally, a position of device 700 is optionally based on a height of a body part of user 702 (e.g., the user's eyes and/or head). In some embodiments, device 700 optionally includes one or more features of computer system 101 of FIG. 1A, one or more features of the controller 110 of FIG. 2, one or more features of display generation component 120 of FIG. 3, one or more features of hand tracking device 140 of FIG. 4, one or more features of eye tracking unit 243 of FIG. 5, and/or one or more features of the glint-assisted gaze tracking pipeline of FIG. 6.

At FIG. 7A, user 702 is sitting while holding device 700 in a physical environment. Device 700 includes one or more cameras, including camera 703, and one or more displays, including display 701. Device 700 displays an image of three-dimensional environment 706 and an image of furniture 707 that is captured by the one or more cameras of device 700. Device 700 also displays email user interface 710 and text field 712 of an email application, where text and images can be entered into text field 712 through a hardware keyboard and/or a virtual keyboard, such as the hardware keyboard and virtual keyboards described herein.

At FIG. 7A, three-dimensional environment 706 includes a width (e.g., x-axis), height (e.g., y-axis), and depth axis (e.g., z-axis) as illustrated by three-dimensional environment cartesian 708 (also referred to herein as “cartesian”) (in some embodiments, the cartesian 708 is not displayed by device 700 and is provided in FIG. 7A for illustrative purposes, only; in some embodiments, cartesian 708 is displayed by device 700). The axes of three-dimensional environment cartesian 708 align with a width axis (e.g., x-axis), height axis (e.g., y-axis), and depth axis (e.g., z-axis) of physical environment cartesian 705. In some embodiments, device 700 detects an orientation of furniture 707 within a physical environment and, in response, displays an image of furniture 707 in three-dimensional environment 706 (e.g., where the image of furniture 707 has coordinates in three-dimensional environment cartesian 708 that are based on the coordinates of furniture 707 in the physical environment).

At FIG. 7A, device 700 displays email user interface 710 as having a depth in three-dimensional environment 706 (e.g., a position along the z-axis of cartesian 708), as depicted by top-down schematic 709. Top-down schematic 709 includes cartesian 708 having a width (e.g., along the x-axis) and a depth (e.g., along the z-axis). Top-down schematic 709 depicts the relative depth of user 702, device 700, and email application interface 710. As illustrated, email application interface 710 is displayed at a different depth than device 700 and/or user.

At FIG. 7A, as described in greater detail herein, device 700 detects a height of a portion of the user's body, which optionally effects where graphical objects are displayed on display 701. In some embodiments, device 700 detects the height of a head (or eyes) of user 702 (and/or device 700 when device 700 is a head-mounted device worn on the head of user 702) with respect to a position of floor 714 (e.g., as detected by one or more sensors of device 700). In some embodiments, device 700 determines whether the height of a head of user 702 is within different ranges relative to floor 714, such as ranges 716a-716d. As depicted in FIG. 7A, device 700 detects sitting height 704a of the head of user 702 is within range 716c. While the head of the user 702 is detected at sitting height 704a (and/or within range 716a), device 700 detects input 750a (e.g., a touch input, an air gesture, a gaze and an air gesture, and/or a mouse click) that is directed to text field 712. In response to input 750a, device 700 displays keyboard 718 as illustrated in FIG. 7B. In some embodiments, in response to input 750a, device 700 begins an input session (e.g., device 700 will enter a mode where content will be added a text field). In some embodiments, an input session ends when device 700 detects a request to close a keyboard (and/or when no more content will be added in response to a keystroke on a hardware keyboard and/or a keystroke on a virtual keyboard, such as keyboard 718 of FIG. 7B).

At FIG. 7B, keyboard 718 includes graphical elements to add content to text field 712. Keyboard 718 includes character buttons 724, emoji button 725, and suggested text buttons 727a-727c. In response to detecting inputs directed to character buttons 724, device 700 adds the corresponding text characters to text field 712. In response to detecting an input to emoji button 725, device 700 adds an image (e.g., emoji) to text field. In some embodiments, in response to detecting an input to emoji button 725, device 700 displays multiple emojis that, when selected, are added to text field 712. In response to detecting inputs directed to suggested text buttons 727a-727c, device 700 adds suggested text (or, in some embodiments, emojis) to text field 712. In some embodiments, device 700 updates suggested text buttons 727a-727c based on a context (e.g., a linguistic context and/or semantic context) of where text is going to be added. Keyboard 718 also includes view 728 of text field 712. View 728 of text field 712 includes a view of a portion (e.g., some but not all) of text field 712, including text cursor 746. In some embodiments, view 728 of text field 712 allows the user to stay focused on a virtual or physical keyboard, without having to glance back up to the text box in order to see what content the user has typed.

At FIG. 7B, keyboard 718 has specific coordinates along three-dimensional environment cartesian 708, including a height (e.g., along the y-axis), a width (e.g., along the x-axis), and a depth (e.g., along the z-axis). As illustrated in top-down schematic 709, keyboard 718 has a depth that is between a depth of device 700 and a depth of email application interface 710 in three-dimensional environment 706. In some embodiments, device 700 displays keyboard 718 at depth 726 relative to the position of a portion of user 702 (e.g., hands and/or head). In some embodiments, depth 726 is a default depth that device 700 uses when keyboard 718 is initially displayed and/or spawned. As discussed in greater detail herein, device 700 optionally displays keyboard 718 at a different position based on user 702 moving keyboard 718 to a different orientation in three-dimensional environment 706.

At FIG. 7B, device 700 displays keyboard 718 along keyboard line 722a. As depicted, a top edge of keyboard 718 is aligned with keyboard line 722a. Keyboard line 722a has an angle of alpha (a) (e.g., the angle between eyeline 720 and keyboard line 722a). As depicted, keyboard line 722a and eyeline 720 intersect at or near the user's head and/or eyes, with the keyboard line 722a sloping down at the angle of alpha (a). Eyeline 720 is also perpendicular to a plane of email application interface 710. For instance, eyeline 720 intersects email application interface 710 at 90 degrees. In some embodiments, eyeline 720 is an actual (e.g., detected or estimated) line of sight of the user. In some embodiments, eyeline 720 is an estimated line of sight of the user. In some embodiments, eyeline 720 is estimated based on an orientation of the user's head (e.g., including an angle with respect to a vertical axis, such as whether the user's head is tilted up or down, and/or height 704a of the user's head).

At FIG. 7B, eyeline 720 is parallel to horizon 721 (e.g., a line or plane that is parallel to floor 714). In some embodiments, when email application interface 710 has a particular orientation or angle in three-dimensional environment 706 (e.g., when email application interface 710 is perpendicular to floor 714 and/or having an orientation that is aligned with gravity), device 700 designates eyeline 720 as being along horizon 721 as a default position for the user's eyeline. As discussed in greater detail with respect to FIG. 7N, email application interface 710 and/or eyeline 720 optionally has a different orientation. As such, in some embodiments, eyeline 720 is not along the horizon.

At FIG. 7B, in some embodiments, device 700 displays keyboard 718 at a horizontal position (e.g., along the x-axis) that is based on a field-of-view of user 702 (in some embodiments, based on content within the field-of-view of user 702). In such embodiments, device 700 optionally displays keyboard 718 at a horizontal position that is based on a center point of the field-of-view of user 702 (e.g., device 700 determines the center point of the field-of-view of user 702 and positions keyboard 718 so that the center of keyboard 718 aligns with the center point of the field-of-view of user 702). In some embodiments, device 700 displays keyboard 718 at a horizontal position that is based on a horizontal position of text field 712. In such embodiments, device 700 optionally displays keyboard 718 at a horizontal position that is based on a center point of text field 712 (e.g., device 700 determines the center point of text field 712 and positions keyboard 718 so that the center of keyboard 718 aligns with the center point of text field 712). In some embodiments, device 700 displays keyboard 718 at a horizontal position that is based on a horizontal position of email application interface 710. In such embodiments, device 700 optionally displays keyboard 718 at a horizontal position that is based on a center point of email application interface 710 (e.g., device 700 determines the center point of email application interface 710 and positions keyboard 718 so that the center of keyboard 718 aligns with the center point of email application interface 710).

At FIG. 7C, device 700 displays email application interface 710 as having a different orientation in three-dimensional environment 706 than email application interface 710 of FIG. 7A. For instance, email application interface 710 has different coordinates along three-dimensional environment cartesian 708. As depicted, email application interface 710 is shifted along the horizontal (x-axis) to the left. While displaying email application interface 710 at the different orientation, device 700 detects input 750c (e.g., a touch input, an air gesture, a gaze and an air gesture, and/or a mouse click). In response to detecting input 750c, device 700 displays keyboard 718 at illustrated in FIG. 7D.

At FIG. 7D, device 700 displays keyboard 718 at a different orientation in three-dimensional environment 706 than the orientation of keyboard 718 of FIG. 7B. As depicted, device 700 displays keyboard 718 along keyboard line 722a having the angle of alpha (a) relative to eyeline 720. Keyboard 718 of FIG. 7D has a different position along the horizontal axis (e.g., x-axis) of three-dimensional environment cartesian 708 than keyboard 718 of FIG. 7B. As described in greater detail with respect to FIG. 7B, in some embodiments, device 700 of FIG. 7D displays keyboard 178 at a horizontal position (e.g., along the x-axis) that is based on a field-of-view of user 702, based on a horizontal position of text field 712, and/or based on a horizontal position of email application interface 710. As described herein, in some embodiments, device 700 displays keyboard 718 as having a different position along the vertical axis (e.g., y-axis) and depth axis (e.g., z-axis) based on the orientation of email application interface 710 (and/or an orientation of text field 712) along the vertical axis (e.g., y-axis) and/or depth axis (e.g., z-axis).

At FIG. 7E1, user 702 has changed positions relative to the position of user 702 in FIGS. 7A-7D, creating a risk of an obstructed view of a software keyboard. User 702 of FIG. 7E1 is at reclining height 704b relative to floor 714. In some embodiments, device 700 detects that reclining height 704b is within height range 716b. Because user 702 is at reclining height 704b (and/or within height range 716b), a field of view of user 702 is (or is potentially) obstructed by object 719 (e.g., the user's chest, feet, or pillow) in the physical environment (or a representation of object 719 in three-dimensional environment 706), as depicted by double-hatching 738. For clarity, device 700 does not display double-hatching 738. Instead, double-hatching 738 is meant to illustrate a potential risk of (or a detected) obstructed field of view of user 702 caused by a physical or virtual object. For example, the field of view of user 702 is obstructed by a physical object, such as when the user's chest or a pillow limits the user's ability to view keyboard 718 and/or email application interface 710 if the keyboard were to be displayed within the region denoted by double-hatching 738. As a further example, the field of view of user 702 is obstructed by a virtual object when an image of the user's chest or a pillow limits the user's ability to view keyboard 718 and/or email application interface 710 because the image of the user's chest or pillow has a depth between the head of user 702 and keyboard 718 and/or email application interface 710.

At FIG. 7E1, device 700 displays keyboard 718 in response to detecting user input directed at text field 712 (e.g., similar to input 750c to select text field 712 described in greater detail with respect to FIG. 7C). Device 700 displays keyboard 718 at an orientation relative to eyeline 720 that is different from the orientation of keyboard 718 in FIG. 7D. For example, keyboard 718 is displayed higher (e.g., along the y-axis) in three-dimensional environment 706 as compared to keyboard 718 of FIG. 7D. In some embodiments, device 700 displays keyboard 718 at a different horizontal position (e.g., along the x-axis) or depth position (e.g., along the z-axis) in three-dimensional environment 706 as compared to keyboard 718 of FIG. 7D depending on an estimated and/or detected obstructed view. In some embodiments, keyboard 718 is world locked (e.g., the orientation is not updated in response to detecting a change in position of user 702). In some embodiments, device 700 moves keyboard 718 while it is displayed in response to device 700 detecting a change in a position of user 702 (e.g., the user's field of view of keyboard 718 is now obstructed or potentially obstructed).

At FIG. 7E1, device 700 displays keyboard 718 at an orientation that is based on keyboard line 722b. For instance, device 700 displays keyboard 718 along keyboard line 722b at depth 726 (e.g., relative to user 702 and/or relative to device 700). Keyboard line 722b is also at an angle of beta (β) (e.g., the angle between eyeline 720 and keyboard line 722b), which is less than the angle alpha (α) of keyboard line 722a of FIGS. 7B and 7D. By displaying keyboard 718 along keyboard line 722b as opposed to keyboard line 722a, it decreases a risk that keyboard 718 is obstructed from the field of view of user 702 and/or eliminates an actual (e.g., detected) obstructed field of view.

In some embodiments, the techniques and user interface(s) described in FIGS. 7A-7T are provided by one or more of the devices described in FIGS. 1A-1P. For example, FIG. 7E2 illustrates an embodiment in which keyboard 718 (e.g., as described in FIG. 7E1) is displayed on display module X702 of head-mounted device (HMD) X700. In some embodiments, HMD X700 includes a pair of display modules that provide stereoscopic content to different eyes of the same user. For example, HMD X700 includes display module X702 (which provides content to a left eye of the user) and a second display module (which provides content to a right eye of the user). In some embodiments, the second display module displays a slightly different image than display module X702 to generate the illusion of stereoscopic depth.

At FIG. 7E2, user 702 has changed positions relative to the position of user 702 in FIGS. 7A-7D, creating a risk of an obstructed view of a software keyboard. User 702 of FIG. 7E2 is at reclining height 704b relative to floor 714. In some embodiments, HMD X700 detects that reclining height 704b is within height range 716b. Because user 702 is at reclining height 704b (and/or within height range 716b), a field of view of user 702 is (or is potentially) obstructed by object 719 (e.g., the user's chest, feet, or pillow) in the physical environment (or a representation of object 719 in three-dimensional environment 706), as depicted by double-hatching 738. For clarity, HMD X700 does not display double-hatching 738. Instead, double-hatching 738 is meant to illustrate a potential risk of (or a detected) obstructed field of view of user 702 caused by a physical or virtual object. For example, the field of view of user 702 is obstructed by a physical object, such as when the user's chest or a pillow limits the user's ability to view keyboard 718 and/or email application interface 710 if the keyboard were to be displayed within the region denoted by double-hatching 738. As a further example, the field of view of user 702 is obstructed by a virtual object when an image of the user's chest or a pillow limits the user's ability to view keyboard 718 and/or email application interface 710 because the image of the user's chest or pillow has a depth between the head of user 702 and keyboard 718 and/or email application interface 710.

At FIG. 7E2, HMD X700 displays keyboard 718 in response to detecting user input directed at text field 712 (e.g., similar to input 750c to select text field 712 described in greater detail with respect to FIG. 7C). HMD X700 displays keyboard 718 at an orientation relative to eyeline 720 that is different from the orientation of keyboard 718 in FIG. 7D. For example, keyboard 718 is displayed higher (e.g., along the y-axis) in three-dimensional environment 706 as compared to keyboard 718 of FIG. 7D. In some embodiments, HMD X700 displays keyboard 718 at a different horizontal position (e.g., along the x-axis) or depth position (e.g., along the z-axis) in three-dimensional environment 706 as compared to keyboard 718 of FIG. 7D depending on an estimated and/or detected obstructed view. In some embodiments, keyboard 718 is world locked (e.g., the orientation is not updated in response to detecting a change in position of user 702). in some embodiments, HMD X700 moves keyboard 718 while it is displayed in response to HMD X700 detecting a change in a position of user 702 (e.g., the user's field of view of keyboard 718 is now obstructed or potentially obstructed).

At FIG. 7E2, HMD X700 displays keyboard 718 at an orientation that is based on keyboard line 722b. For instance, HMD X700 displays keyboard 718 along keyboard line 722b at depth 726 (e.g., relative to user 702 and/or relative to HMD X700). Keyboard line 722b is also at an angle of beta (β) (e.g., the angle between eyeline 720 and keyboard line 722b), which is less than the angle alpha (α) of keyboard line 722a of FIGS. 7B and 7D. By displaying keyboard 718 along keyboard line 722b as opposed to keyboard line 722a, it decreases a risk that keyboard 718 is obstructed from the field of view of user 702 and/or eliminates an actual (e.g., detected) obstructed field of view.

Any of the features, components, and/or parts, including the arrangements and configurations thereof shown in FIGS. 1B-1P can be included, either alone or in any combination, in HMD X700. For example, in some embodiments, HMD X700 includes any of the features, components, and/or parts of HMD 1-100, 1-200, 3-100, 6-100, 6-200, 6-300, 6-400, 11.1.1-100, and/or 11.1.2-100, either alone or in any combination. In some embodiments, display module X702 includes any of the features, components, and/or parts of display unit 1-102, display unit 1-202, display unit 1-306, display unit 1-406, display generation component 120, display screens 1-122a-b, first and second rear-facing display screens 1-322a, 1-322b, display 11.3.2-104, first and second display assemblies 1-120a, 1-120b, display assembly 1-320, display assembly 1-421, first and second display sub-assemblies 1-420a, 1-420b, display assembly 3-108, display assembly 11.3.2-204, first and second optical modules 11.1.1-104a and 11.1.1-104b, optical module 11.3.2-100, optical module 11.3.2-200, lenticular lens array 3-110, display region or area 6-232, and/or display/display region 6-334, either alone or in any combination. In some embodiments, HMD X700 includes a sensor that includes any of the features, components, and/or parts of any of sensors 190, sensors 306, image sensors 314, image sensors 404, sensor assembly 1-356, sensor assembly 1-456, sensor system 6-102, sensor system 6-202, sensors 6-203, sensor system 6-302, sensors 6-303, sensor system 6-402, and/or sensors 11.1.2-110a-f, either alone or in any combination. In some embodiments, HMD X700 includes one or more input devices, which include any of the features, components, and/or parts of any of first button 1-128, button 11.1.1-114, second button 1-132, and or dial or button 1-328, either alone or in any combination. In some embodiments, HMD X700 includes one or more audio output components (e.g., electronic component 1-112) for generating audio feedback (e.g., audio output), optionally generated based on detected events and/or user inputs detected by the HMD X700.

At FIG. 7F, user 702 has changed positions relative to the position of user 702 in FIGS. 7A-7E2. User 702 of FIG. 7F is at lying height 704c relative to floor 714. In some embodiments, device 700 detects that lying height 704c is within height range 716a. Because user 702 is at lying height 704c (and/or within height range 716a), a field of view of user 702 is (or is potentially) obstructed by object 719 (e.g., the user's chest, the user's feet, and/or pillow) in the physical environment. An amount of double-hatching 738 is greater in FIG. 7F than the amount of double-hatching 738 in FIGS. 7E1 and/or 7E2 (e.g., double-hatching 738 of FIG. 7F is higher up along display 701 than double-hatching 738 of FIGS. 7E1 and/or 7E2) because there is a greater (e.g., actual or estimated) obstructed field of view obstructed field of view of a portion of three-dimensional environment 706.

At FIG. 7F, while user 702 is at lying height 704c, user 702 invokes a software keyboard (e.g., via an input similar to input 750c to select text field 712 described in greater detail with respect to FIG. 7C). In response, device 700 displays keyboard 718 at an orientation relative to eyeline 720 that is different from the orientation of keyboard 718 in FIG. 7D and FIGS. 7E1 and/or 7E2. For example, keyboard 718 is displayed higher (e.g., along the y-axis) in three-dimensional environment 706 as compared to keyboard 718 of FIGS. 7D-7E2. Additionally, device 700 displays keyboard 718 to the right (e.g., along the x-axis) in three-dimensional environment 706 as compared to keyboard 718 of FIGS. 7D-7E2. In some embodiments, device 700 displays keyboard 718 (at height 704a, height 704b, and/or height 704c) based on not obstructing a view of different types of content, such as text field 712 and/or other content of email application interface 710. In some embodiments, device 700 displays keyboard 718 so as to not obscure content of one type (e.g., text field 712, text, and/or a body of an email) different from another type (e.g., text, pictures, subject line of an email, and/or a list of emails of email application interface 710). As described in greater detail with respect to FIG. 7B, in some embodiments, device 700 of FIG. 7F displays keyboard 178 at a horizontal position (e.g., along the x-axis) that is based on a field-of-view of user 702, based on a horizontal position of text field 712, and/or based on a horizontal position of email application interface 710.

At FIG. 7F, in some embodiments, keyboard 718 is environment-locked. In some embodiments, while keyboard 718 is displayed at one orientation and in response to device 700 detecting a change in a position of user 702, device 700 updates the orientation of keyboard 718 based on the change in position of user 702 (and/or based on detecting that the user's field of view of keyboard 718 is obstructed and/or based on a risk that there is a potentially obstructed view of keyboard 718) (e.g., otherwise, device 700 maintains the orientation of keyboard while user 702 moves). In some embodiments, keyboard 718 is displayed as a viewpoint-locked virtual object.

At FIG. 7F, device 700 displays keyboard 718 at an orientation that is along keyboard line 722c and/or eyeline 720. For example, keyboard line 722c is along (e.g., has the same orientation as) eyeline 720. Additionally, device 700 displays keyboard 718 at depth 726, as depicted by top-down schematic 709. By displaying keyboard 718 along keyboard line 722c as opposed to keyboard line 722a and/or keyboard line 722b, device 700 decreases a risk that keyboard 718 is obstructed from the field of view of user 702 and/or eliminates an actual (e.g., detected) obstructed field of view.

At FIG. 7G, user 702 has changed heights relative to the position of user 702 in FIGS. 7A-7F. User 702 of FIG. 7G is at standing height 704d relative to floor 714. In some embodiments, device 700 detects that standing height 704d is within height range 716d. Because user 702 is at standing height 704d (and/or within height range 716d), a field of view of user 702 is not obstructed (or is less likely to be obstructed) by an object in the physical environment or three-dimensional environment 706. As such, double-hatching 738 is not depicted in FIG. 7G.

At FIG. 7G, while user 702 is at standing height 704d, user 702 invokes a software keyboard (e.g., via an input similar to input 750c to select text field 712 described in greater detail with respect to FIG. 7C). In response, device 700 displays keyboard 718 at the same orientation relative to eyeline 720 as keyboard 718 of FIG. 7D (which is different from the orientation of keyboard 718 in FIGS. 7E1, 7E2, and FIG. 7F), though the keyboard 718 has different coordinate in three-dimensional environment 706 based on the user standing. At FIG. 7G, device 700 displays keyboard 718 at an orientation that is along keyboard line 722a and at depth 726 as described with respect to FIG. 7D. Keyboard line 722a is at the angle alpha (α) as described with respect to FIGS. 7B and 7D. Keyboard 718 is displayed along keyboard line 722a as opposed to keyboard line 722b or 722c because it allows user 702 to interact with keyboard 718 when there is little risk of an obstructed from the field of view of user 702 and/or when there is no actual (e.g., detected) obstructed field of view.

At FIG. 7G, device 700 displays keyboard 718 with reposition indicator 732 to indicate that keyboard 718 can be moved to a different position in response to an input (e.g., a touch input, an air gesture, a gaze, a mouse click, and/or a combination thereof). In some embodiments, device 700 does not display reposition indicator 732 if a virtual keyboard cannot be moved (e.g., the virtual keyboard is tied to a position of a hardware keyboard as described in greater detail with respect to FIGS. 9A-9Z). Reposition indicator 732 is depicted with a single hatch, but optionally includes any shapes, symbols, text, and/or colors. While displaying keyboard 718, device 700 detects input 750g (e.g., a touch input, an air gesture, a gaze, a mouse click, and/or a combination thereof) directed at reposition indicator 732 to move keyboard 718 within three-dimensional environment 706. In some embodiments, input 750g is directed to a different portion of keyboard 718 to move keyboard 718 within three-dimensional environment 706.

At FIG. 7H, in some embodiments, device 700 displays keyboard 718 at customized position that has a same depth as the keyboard 718 had prior to detecting input 750g. For example, in response to input 750g of FIG. 7G, device 700 displays keyboard 718 at a same depth (e.g., on the z-axis) as keyboard 718 of FIG. 7G, but at a different orientation along the x-axis and y-axis along three-dimensional environment cartesian 708. Keyboard 718 has depth 726 relative to user 702, but keyboard 718 of FIG. 7H is higher (e.g., along the y-axis) and to the right (e.g., along the x-axis) of keyboard 718 of FIG. 7G. The customized orientation has a positioned along keyboard line 722d that is at an angle theta (θ) relative to eyeline 720 (e.g., the angle between eyeline 720 and keyboard line 722d). As depicted, angle theta (θ) is less than angle alpha (α) of FIG. 7G. In some embodiments, angle theta (θ) is greater than angle alpha (α).

At FIG. 7I, in some embodiments, device 700 displays keyboard 718 at a customized position that has a different depth as the keyboard 718 had prior to detecting input 750g. In response to input 750g of FIG. 7G, device 700 displays keyboard 718 at a different depth (e.g., on the z-axis) as keyboard 718 of FIG. 7G. For example, keyboard 718 has depth 734 relative to user 702, which is closer to user 702 than depth 726 of FIG. 7H. Other than depth, the customized position of keyboard 718 of FIG. 7I is similar to the customized position FIG. 7H. At FIG. 7I, while displaying keyboard 718, device 700 detects input 750i (e.g., a touch input, an air gesture, a gaze, a mouse click, and/or a combination thereof) directed at close affordance 736 to close (e.g., dismiss and/or hide) keyboard 718. In response to detecting input 750i, device 700 stops displaying keyboard 718 as illustrated at FIG. 7J. In some embodiments, closing keyboard 718 ends the content input session (e.g., device 700 will not add content to a text field). In some embodiments, invoking (and/or re-invoking) keyboard 718 begins a new content input session.

At FIG. 7J, user 702 invokes a software keyboard while user 702 is in the same position that he or she was in FIGS. 7H-7I. In response, device 700 displays keyboard 718 with some, if not all, of the parameters of the previous customized orientation. In some embodiments, the previous customized orientation is an orientation in which keyboard 718 was customized during a previous content input session (e.g., a session in which device 700 is in a state that detects various inputs and modifies content of text entry field accordingly).

At FIG. 7J, in some embodiments, powering off and/or setting device 700 down after customizing an orientation affects whether the software keyboard is displayed based on the previous customized orientation. In some embodiments, if device 700 continues to be powered on (e.g., device 700 was not powered off, device 700 did not dim display 701, and/or device 700 was not set down by user 702) between content input sessions, device 700 redisplays keyboard 718 in the previous customized orientation. In some embodiments, in response to detecting that device 700 was powered off (e.g., device 700 was not powered on, device 700 dimmed display 701, and/or device 700 was not set down by user 702) between content input sessions, device 700 does not display keyboard 718 in the customized orientation of a previous content input session. At FIG. 7J, while displaying text field 712, device 700 detects input 750j (e.g., a touch input, an air gesture, a gaze, a mouse click, and/or a combination thereof) directed at text field 712.

At FIG. 7K, in response to input 750j of FIG. 7J, device 700 displays keyboard 718 using all of the parameters of the customized orientation described with respect to FIG. 7H. For example, device 700 displays keyboard 718 at depth 726 and is displayed along keyboard line 722d at angle theta (θ).

At FIG. 7L, in response to input 750j of FIG. 7J, device 700 displays keyboard 718 using some (but not all) of the customized orientation described with respect to FIG. 7I. For example, device 700 displays keyboard 718 at depth 734 (e.g., as opposed to depth 726) and is displayed along keyboard line 722d at angle theta (θ).

Referring to FIGS. 7K-7L, some or all of the parameters of the customized orientation are applied across multiple applications. For example, device 700 displays keyboard 718 using some (or all) of the parameters of the customized orientation described with respect to FIGS. 7H-7I to an application that is different from the email application (e.g., only some of the customized orientation is applied across multiple applications). As a further example, when a user customizes a depth and an angle for one application, device 700 will use the depth but not the angle for a different application.

Referring to FIGS. 7K-7L, in some embodiments, device 700 displays keyboard 718 with some or all of the customized orientation on a per application basis (e.g., a specific application is associated with a specific customized orientation). For example, device 700 optionally displays keyboard 718 at one customized orientation for one application and a different orientation (e.g., a default or customized orientation) for a different application. In some embodiments, when user 702 reinvokes keyboard 718 for an application different from the email application, device 700 displays keyboard 718 at a different orientation for that other application (e.g., device 700 does not display keyboard 718 at the previously customized orientation that was customized for the email application and/or that was customized during an input session for the email application).

At FIG. 7M, user 702 has invoked a software keyboard while user 702 is at a different position (e.g., a different room or a different part of the room) than what he or she was in FIG. 7J, as depicted in part by user 702 being near table 735. In response to detecting the invocation of a software keyboard while at a different position, device 700 displays keyboard 718 at a default orientation (e.g., rather than the customized orientation of FIGS. 7H-7I and 7K-7L). At FIG. 7M, for example, device 700 displays keyboard 718 along keyboard line 722a at angle alpha (α) and at depth 726. Additionally, in side-view schematic 740, a plane of keyboard 718 and a plane of email application interface 710 is aligned with y-axis (where the y-axis is parallel to gravity and/or is perpendicular to floor 714) in the three-dimensional environment 706. Device 700 detects input 750m (e.g., a touch input, an air gesture, a gaze, a mouse click, and/or a combination thereof) directed at close affordance 736 to close keyboard 718.

At FIG. 7N, email application interface 710 has changed orientations relative to the email application interface 710 of FIG. 7M (e.g., based on user movement and/or an input to move the email application interface 710 in the three-dimensional environment). Email application interface 710 of FIG. 7N is higher (e.g., along the y-axis) in three-dimensional environment 706 than email application interface 710 FIG. 7M, as depicted in side-view schematic 740 and by the relationship between the image of furniture 707 and email application interface 710 between FIGS. 7M-7N. Additionally, an angle of the plane of email application interface 710 of FIG. 7N has changed from the angle of the plane of email application interface 710 of FIG. 7M. For example, in side-view schematic 740, email application interface 710 is angled relative to the y-axis and/or x-axis. In some embodiment, email application interface 710 is beyond 10 degrees from the y-axis and/or 100 degrees from the horizon. In some embodiments, email application interface 710 is angled relative to a horizon (e.g., horizon 721). In some embodiments, device 700 determines email application interface 710 is angled beyond a threshold angle (e.g., 5 degrees, 10 degrees, 30 degrees, and/or 90 degrees) of the y-axis and/or the horizon.

At FIG. 7N, the head of user 702 is tilted up as compared to the head of user 702 of FIG. 7M. As such, the angle of eyeline 720 of 7N is different from the angle of eyeline 720 of FIG. 7M. For example, eyeline 720 of FIG. 7N is no longer aligned with the horizon 721. Rather, eyeline 720 intersects horizon 721 at or near the head of user 702 and slopes up as it extends forward (e.g., along the positive direction on z-axis of physical environment cartesian 705 and/or three-dimensional environment cartesian 708) from user 702 and intersects the plane of email application interface 710 at 90 degrees (and/or within a range of 5 degrees of 90 degrees). At FIG. 7N, device 700 detects input 750n (e.g., a touch input, an air gesture, a gaze, a mouse click, and/or a combination thereof) directed at text field 712. In response to detecting input 750n, device 700 displays keyboard 718 as illustrated in FIG. 7O.

At FIG. 7O, device 700 displays keyboard 718 at a different orientation in three-dimensional environment 706 than the orientation of keyboard 718 in FIG. 7M. For example, as depicted in side-view schematic 740, keyboard 718 of FIG. 7O is higher (e.g., along the y-axis) than keyboard 718 of FIG. 7M. The keyboard 718 of FIG. 7O also has a different orientation relative to the orientation of furniture 707 as compared to the relative orientation depicted in FIG. 7M. As a further example, the angle of the plane of keyboard of FIG. 7O is different from the angle of the plane of keyboard of FIG. 7M. For example, in side-view schematic 740, email application interface 710 is angled relative to the y-axis in FIG. 7O as opposed to being parallel to the y-axis in FIG. 7M.

At FIG. 7O, device 700 displays keyboard 718 at an orientation that is along keyboard line 722a, which is based on the new orientation of eyeline 720. For example, keyboard line 722a is based on angle alpha (α) from the new orientation of eyeline 720. Additionally, device 700 displays keyboard 718 at depth 726, as depicted by top-down schematic 709.

At FIG. 7P, device 700 displays email application interface 710 at an orientation in three-dimensional environment 706 that is different from the orientation of email application interface 710 of 7O. For example, email application interface 710 of FIG. 7P is lower (e.g., along the y-axis) in three-dimensional environment 706 than email application interface 710 FIG. 7O, as depicted by the relationship between the image of furniture 707 and email application interface 710 between FIGS. 7O-7P. While email application interface 710 is displayed, device 700 detects input 750p (e.g., a touch input, an air gesture, a gaze, a mouse click, and/or a combination thereof) directed at text field 712. In response to detecting input 750p, device 700 displays keyboard 718 as illustrated in FIG. 7Q

At FIG. 7Q, device 700 displays keyboard 718 at an orientation in three-dimensional environment 706 that is different from the orientation of keyboard 718 of FIG. 7O. For example, keyboard 718 is displayed along keyboard line 722a, which is based on an orientation of eyeline 720 that is different from the eyeline 720 of FIG. 7O. At FIG. 7Q, only a portion of keyboard 718 is displayed while another portion is off-screen. In some embodiments, when device 700 is a head-worn device, a portion of keyboard 718 (and/or a portion of email application interface 710) is not displayed if a user's head is tilted or rotated such that the user's field-of-view is not directed at the keyboard 718 (and/or email application interface 710). At FIG. 7Q, device 700 detects movement 742 along the y-axis. In response to detecting movement 742, device 700 displays a different view (e.g., perspective) of keyboard 718 and/or email application interface 710 because keyboard 718 and/or email application interface 710 are world locked. In some embodiments, movement 742 includes a movement along the y-axis, x-axis, and/or z-axis. In some embodiments, movement 742 includes a change in an angle (e.g., with respect to the y-axis, x-axis, and/or z-axis). In some embodiments, in response to different movements, device 700 displays different perspectives of three-dimensional environment 706, keyboard 718, and/or email application interface 710 (e.g., different movements result in different perspectives).

At FIG. 7R, device 700 displays a previously off-screen portion of keyboard 718. For example, because of the change in orientation of device 700 and because the keyboard 718 is world locked, movement 742 of device 700 results in device 700 displaying a portion of keyboard 718 that was not displayed prior to movement 742. At FIG. 7R, device 700 detects input 750r (e.g., a touch input, an air gesture, a gaze, a mouse click, and/or a combination thereof) directed at close affordance 736. In response, device 700 closes keyboard 718 and ends the text entry session.

At FIG. 7S, email application interface 710 and device 700 have orientations that are different from the orientations of email application interface 710 and device 700 of FIG. 7R. For example, email application interface 710 is oriented in a manner that eyeline 720 of user 702 intersects a portion of email application interface 710 that is different from the portion that eyeline 720 intersects email application interface 710 described with respect to FIGS. 7A-7R. At FIG. 7S, eyeline 720 intersects email application interface 710 above text field 712. While displaying email application interface 710, device 700 detects input 750s (e.g., a touch input, an air gesture, a gaze, a mouse click, and/or a combination thereof) directed at text field 712. In response to detecting input 750s, device 700 displays keyboard 718 described with respect to FIG. 7T.

At FIG. 7T, device displays keyboard 718 along keyboard line 722a and at depth 726, as described herein. However, because eyeline 720 intersects email application interface 710 at a different portion than what is described with respect to FIGS. 7A-7R, device 700 displays keyboard 718 at a different orientation relative to email application interface 710. For example, device 700 displays higher up (e.g., along the y-axis) relative to the email application interface 710. At FIG. 7T, device 700 detects input 750t (e.g., a touch input, an air gesture, a gaze, a mouse click, and/or a combination thereof) directed at keyboard mode affordance 744. In response to detecting input 750t, device 700 displays keyboard augmentation region 918 described with respect to FIGS. 9A-9Z.

Additional descriptions regarding FIGS. 7A-7T are provided below in reference to method 800 described with respect to FIG. 8.

FIG. 8 is a flow diagram of an exemplary method 800 for positioning a virtual keyboard in a three-dimensional environment, in some embodiments. In some embodiments, method 800 is performed at a computer system (e.g., 700, X700, and/or computer system 101 in FIG. 1A) including a display generation component (e.g., a display controller, a touch-sensitive display system, a monitor, and/or a head mounted display system) (e.g., 701, X702, and/or display generation component 120 in FIGS. 1A, 3, and 4) (e.g., a heads-up display, a display, a touchscreen, a projector, etc.) and one or more input devices (e.g., 701, 703, and/or 125) (e.g., a touch-sensitive surface, a keyboard, a controller, a microphone, a motion sensor, a camera (e.g., an infrared camera, a depth camera, a visible light camera, and/or one or more cameras (e.g., a camera (e.g., color sensors, infrared sensors, and other depth-sensing cameras) that point downward at a user's hand or a camera that points forward from the user's head)), and/or a mouse) (in some embodiments, the one or more input devices are capable of detecting movement of a portion of a user's body (e.g., detect air gestures)). In some embodiments, method 800 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 800 are, optionally, combined and/or the order of some operations is, optionally, changed.

The computer system displays (802), via the display generation component, a user interface (e.g., the user interface of FIGS. 7A-7T that include three-dimensional environment 706 and email application interface 710) (e.g., an extended reality user interface) that includes: a representation of a portion of a three-dimensional environment (e.g., 706) (in some embodiments, the portion of the three-dimensional environment is part of an extended reality environment; in some embodiments, the portion is a virtual portion or a pass-through portion (e.g., video or optical pass-through)) and a representation of a respective application (e.g., 710) (e.g., at least a first portion of the application and/or at least a first portion and not a second portion of the application) (e.g., a virtual application user interface).

The computer system receives (804), via the one or more input devices, a request to display a keyboard user interface (e.g., 750a, 750c, 750j 750n, 750p, 750s, 950a, 905d, 950k, and/or 950y) (e.g., a software and/or virtual keyboard that includes a plurality of selectable key elements) (e.g., the first and/or second set of one or more user interface objects of FIGS. 9A-9Z) in the representation of the portion of the three-dimensional environment.

In response to receiving the request to display the keyboard user interface, the computer system displays (806), via the display generation component, the keyboard user interface at a respective keyboard position in the representation of the portion of the three-dimensional environment (e.g., 718 is displayed at different orientations as described in FIGS. 7A-7T). In accordance with a determination that a first set of keyboard placement criteria is satisfied (808), wherein the first set of keyboard placement criteria includes a first application criterion that is satisfied when the representation of the respective application has a first pose (e.g., 710 has an orientation in FIG. 7A; and/or the orientation of 710 as described in FIGS. 7A-7T) (e.g., is at a first position (e.g., a spatial position within the three-dimensional environment (e.g., identifiable by a coordinate (e.g., x, y, and z))) (in some embodiments, a position is independent of orientation such that an object can be described as having separate position and orientation characteristics) and/or the when the representation of the respective application has a first orientation (e.g., relative to the three-dimensional environment and/or a portion (e.g., a head or torso of the user) of a user of the computer system)) in the representation of the portion of the three-dimensional environment, the respective keyboard position is at a first keyboard position (e.g., 718 has an orientation described with respect to FIG. 7B; and/or the orientation of 718 as described with respect to FIGS. 7A-7T) (in some embodiments, and in a first keyboard orientation) (in some embodiments, the first keyboard position and/or first keyboard orientation has a first predetermined relationship to the first pose of the representation of the respective application) in the representation of the portion of the three-dimensional environment. In accordance with a determination that a second set of keyboard placement criteria is satisfied (810), wherein the second set of keyboard placement criteria includes a second application criterion that is satisfied when the representation of the respective application has a second pose (e.g., 710 has one orientation described with respect to FIG. 7C; and/or the orientation of 710 as described with respect to FIGS. 7A-7T) (e.g., is at a third position (e.g., a spatial position within the three-dimensional environment (e.g., identifiable by a coordinate (e.g., x, y, and z))) and/or the when the representation of the respective application has a second orientation (e.g., relative to the three-dimensional environment and/or a portion (e.g., a head or torso of the user) of a user of the computer system)) in the representation of the portion of the three-dimensional environment, wherein the second pose is different from the first pose (e.g., the first pose has a different position and/or orientation than the second pose), the respective keyboard position is at a second keyboard position (e.g., 718 has an orientation in FIG. 7D; and/or the orientation of 718 described with respect to FIGS. 7A-7T) (in some embodiments, and in a first keyboard orientation) (in some embodiments, the second keyboard position has a second predetermined relationship to the second pose of the representation of the respective application that is different than the first predetermined relationship) in the representation of the portion of the three-dimensional environment that is different from the first keyboard position in the representation of the portion of the three-dimensional environment (e.g., based on having a different coordinates along a horizontal axis (e.g., x), vertical axis (e.g., y), and/or depth axis (e.g., z) in the three-dimensional environment). In some embodiments, the computer system displays the keyboard user interface as a transparent overlay over a portion of the representation of the respective application (and/or the portion of the three-dimensional environment) while the keyboard user interface is displayed in the respective keyboard position (e.g., the first keyboard position and/or the second keyboard position). In some embodiments, a pose of the representation of the respective application (and/or the keyboard user interface) in the three-dimensional environment is independent of the orientation of the computer system (e.g., the representation of the respective application in the three-dimensional environment is world locked and/or does not change when the computer system moves). In some embodiments, the pose of the representation of the respective application (and/or the position and/or orientation of the keyboard user interface) in the three-dimensional environment is independent of (e.g., is not based on) a portrait and/or landscape mode of the computer system. In some embodiments, the representation of the respective application maintains a respective pose (and/or the keyboard user interface maintains a respective position and/or orientation) relative to a representation of a physical object (e.g., that is in the field of view of the one or more cameras) in the three-dimensional environment as the computer system moves. In some embodiments, the pose of the representation of the respective application in the three-dimensional environment (and/or the position and/or orientation the keyboard user interface) is dependent on the orientation of the computer system (e.g., the representation of the respective application in the three-dimensional environment changes when the computer system moves and/or is not world locked). In some embodiments, the computer system updates the pose of the representation of the respective application (and/or the position and/or orientation of the keyboard user interface) relative to a representation of a physical object in the three-dimensional environment as the computer system moves. Conditionally displaying the keyboard user interface based on criteria including a pose of the representation of the respective application in the three-dimensional environment performs an operation when a set of conditions has been met without requiring further user input and improves how the keyboard user interface is displayed in three-dimensional environment and reduces the possibility of an obstructed view of the keyboard user interface.

In some embodiments, the first set of keyboard placement criteria is satisfied when the representation of the respective application that has the first pose is at a first angle (e.g., 710 is angled in FIG. 7N), relative to a first reference line (e.g., horizon 721 and/or y-axis or x-axis of FIG. 7N) (e.g., an axis parallel to gravity (e.g., a y-axis)) (e.g., a horizon line, a line that extends parallel to the ground, and/or a level line) (in some embodiments, a reference and/or level plane) (in some embodiments, a level line that extends from the head of the user), that is greater than a first angle threshold (e.g., 710 is angled beyond 10 degrees of y-axis and/or is angled beyond 100 degrees from a horizon in FIG. 7N) (e.g., a threshold of 10 degrees from the first reference line, a threshold of 10 5 degrees from the first reference line, a threshold of 1 degree from the first reference line) (e.g., the representation of the respective application is in a pose that places the representation at which is it angled above (or below) a level line extending from the head of the user). In some embodiments, the first keyboard position is a position based on a line (e.g., eyeline 720) that intersects a body part (e.g., head, eyes, and/or hands) of a user (e.g., 702) of the computer system and the representation of the respective application (e.g., a center of the representation or an edge of the representation). In some embodiments, the line that intersects the body party of the user and the representation of the respective application is perpendicular to (e.g., normal to and/or 90 degrees relative to) a plane (e.g., viewing pane) of the representation of the respective application. In some embodiments, an orientation of the plane of the representation of the respective application in the representation of the three-dimensional environment is independent of the plane of the display generation component of the computer system (e.g., the plane of the representation of the respective application is defined by its dimensions in the three-dimensional environment (and/or not by the surface of the screen)). Conditionally displaying the keyboard user interface at a first angle, relative to a first reference line, that is greater than a first angle threshold performs an operation when a set of conditions has been met without requiring further user input and improves how the keyboard user interface is displayed in three-dimensional environment and reduces the possibility of an obstructed view of the keyboard user interface.

In some embodiments, the second set of keyboard placement criteria is satisfied when the representation of the respective application that has the second pose is at a second angle (e.g., 710 is parallel to the y-axis and/or is 90 degrees from the horizon in FIGS. 7A-7M), relative to the first reference line, that is less than the first angle threshold. In some embodiments, the second keyboard position is based on (e.g., in accordance with and/or dependent on; in some embodiments, along or on a horizon line) a horizon line (e.g., 718 is based on horizon 721) (e.g., a line of sight (e.g., actual and/or estimated), a line parallel to a floor, and/or an axis perpendicular to gravity) of the three-dimensional environment. In some embodiments, the horizon line is a line that is independent of a determination of a line that intersects a body part (e.g., head, eyes, and/or hands) of the user and representation of the respective application. In some embodiments, the horizon line is independent of a physical orientation of the display generation component and/or the computer system. In some embodiments, horizon line is perpendicular to a plane of the representation of the respective application. In some embodiments, the horizon line is based on a predetermined orientation (e.g., as opposed to a currently detected orientation) (e.g., angle and/or tilt) of the body part of the user. Conditionally displaying the keyboard user interface at the second position that is based on horizontal line when the pose of the representation of the respective application is at a second angle that is less the threshold angle performs an operation when a set of conditions has been met without requiring further user input and improves how the keyboard user interface is displayed in three-dimensional environment and reduces the possibility of an obstructed view of the keyboard user interface.

In some embodiments, the first keyboard position is based on a position (e.g., one of heights 704a-704d; and/or a position of a torso depicted in FIGS. 12A-12T, including 1218a, 1218b, and/or 1218c) of a respective body part (e.g., head, eyes, torso, and/or hands) of a user (e.g., head of user 702) of the computer system within the three-dimensional environment (e.g., a first height relative to the ground/floor of the three-dimensional environment) (e.g., in some embodiments, the ground/floor is actual and/or expected position of the ground/floor in the physical environment). In some embodiments, in accordance with a determination that the respective body part of the user of the computer system has a first position (e.g., one of heights 704a-704d; and/or 1218a, 1218b, and/or 1218c) of the respective body part (e.g., a first height and/or a first set of spatial coordinates; and/or 1218a, 1218b, and/or 1218c as described in greater detail with respect to FIGS. 12A-12T) within the three-dimensional environment (e.g., the head of the user is at a height indicative of the user standing; and/or a torso of the user is in user position 1218a, 1218b, and/or 1218c as described in greater detail with respect to FIGS. 12A-12T), the first keyboard position is a third keyboard position (e.g., one of the orientations of 718 described in FIGS. 7A-7L) (in some embodiments, a position at a height and/or angle that improves viewing while standing). In some embodiments, in accordance with a determination that the respective body part of the user of the computer system has a second position (e.g., one of heights 704a-704d; and/or 1218a, 1218b, and/or 1218c) of the respective body part (e.g., a second height and/or a second set of spatial coordinates; and/or 1218a, 1218b, and/or 1218c as described in greater detail with respect to FIGS. 12A-12T) within the three-dimensional environment (e.g., the head of the user is at a height indicative of the user sitting or reclining; and/or a torso of the user is in user position 1218a, 1218b, and/or 1218c as described in greater detail with respect to FIGS. 12A-12T) that is different from the first position of the respective body part, the first keyboard position is a fourth keyboard position (e.g., one of the orientations of 718 described in FIGS. 7A-7L) (in some embodiments, a position at a height and/or angle that improves viewing while sitting or reclining) that is different from the third keyboard position. Conditionally displaying the keyboard user interface as having different positions based on different positions of a body party of the user performs an operation when a set of conditions has been met without requiring further user input and improves how the keyboard user interface is displayed in three-dimensional environment depending on the detected position of the user and reduces the possibility of an obstructed view of the keyboard user interface.

In some embodiments, the position of the respective body part of the user of the computer system within the three-dimensional environment is a position relative to a floor (e.g., heights 704a-704d are relative to floor 714) (e.g., a floor on which the user is standing (e.g., the ground)) of the three-dimensional environment. In some embodiments, a position of the floor is determined by the computer system (e.g., approximated by the computer system) (in some embodiments, an approximate position determined by one or more sensors of the computer system (e.g., one or more cameras, proximity sensor, LiDAR, an accelerometer, and/or a gyroscope)). Conditionally displaying the keyboard user interface based on different heights relative to a detected position of the floor performs an operation when a set of conditions has been met without requiring further user input and improves how the keyboard user interface is displayed in three-dimensional environment depending on the detected position of the floor, including preventing an obstructed view of the keyboard user interface.

In some embodiments, the third keyboard position is based on (e.g., at least in part) (e.g., is in accordance with) a first angle (e.g., one of angles alpha, beta, or no angle as described in FIGS. 7A-7T) relative to a respective line (e.g., eyeline 720). In some embodiments, the respective line is perpendicular to a plane of the representation of the respective application (e.g., the respective line intersects the surface of the plane of the representation in the three-dimensional environment at 90 degrees). In some embodiments, the respective line is defined in part by a body part of the user (e.g., the respective line moves up or down as the height of a head or eyes of a user moves up or down) while still remaining perpendicular to the plane of the representation of the respective application (e.g., the respective line remains perpendicular but intersects a different a portion of the plane). In some embodiments, the fourth keyboard position is based on (e.g., at least in part) (e.g., is in accordance with) a second angle (e.g., one of angles alpha, beta, or no angle as described in FIGS. 7A-7T), different (e.g., a larger angle and/or a smaller angle) from the first angle, relative to the respective line. In some embodiments, the second angle is less than the first angle when the second position is at a height that is less than a height of the first position (e.g., the angle is reduced as the body part of the user moves closer to the floor). In some embodiments, the first angle is an angle that is selected from the range of 25 degrees to 30 degrees. In some embodiments, the first angle is 27 degrees. In some embodiments, the second angle is an angle that is selected from the range of 22 degrees to 26 degrees. In some embodiments, the second angle is 24 degrees. Conditionally displaying the keyboard user interface based on different angles relative to a respective line when a set of conditions has been met without requiring further user input and improves how the keyboard user interface is displayed in three-dimensional environment depending on the detected position of the user and prevents an obstructed view of the keyboard user interface.

In some embodiments, the first position of the respective body part (e.g., head, eyes, or hands) (e.g., at least a portion of the body part) of the user of the computer system is in a first range of positions (e.g., ranges 716a-716d) (e.g., relative to an object in the physical environment, relative to the floor, and/or relative to an object in the three-dimensional environment) (e.g., 105 cm to 120 cm or 100 cm to 140 cm) within the three-dimensional environment. In some embodiments, the second position of the respective body part of the user of the computer system is a second range of positions (e.g., ranges 716a-716d) (e.g., 70 cm to 104 cm or 60 cm to 99 cm) within the three-dimensional environment, different from the first range of positions (in some embodiments, the first range and second range of positions do not overlap). In some embodiments, the first range of position and the second range of positions correspond to a height of the respective body part (e.g., of the height of the computer system when the computer system is worn on the respective body part of the user). In some embodiments, the first and second range of heights are measured along an axis that is parallel to gravity and/or along an axis that is perpendicular to the ground/floor. Conditionally displaying the keyboard user interface as having different positions based on a first a first range of positions of the body part of the user and a second range of heights of the body part of the user performs an operation when a set of conditions has been met without requiring further user input, improves how the keyboard user interface is displayed in three-dimensional environment, and prevents the keyboard user interface from being hidden or obstructed from view based on physical and/or virtual elements.

In some embodiments, the first keyboard position is based on the position of the respective body part of the user of the computer system within the three-dimensional environment. In some embodiments, in accordance with a determination that the respective body part of the user of the computer system has a third position of the respective body part (e.g., a third height and/or a third set of spatial coordinates) that is in a third range of positions (e.g., ranges 716a-716d) (e.g., relative to an object in the physical environment, relative to the floor, and/or relative to an object in the three-dimensional environment) (e.g., 0-59 cm, 70 cm to 104 cm, or 60 cm to 99 cm) within the three-dimensional environment (e.g., the head of the user is at a height indicative of the user sitting or reclining) that is different from the first position of the respective body part and the second position of the respective body part, the first keyboard position is a fifth keyboard position (e.g., one of orientations of 718 as described in FIGS. 7A-7T) (in some embodiments, a position at a height and/or angle that improves viewing while sitting or reclining) that is different from the third keyboard position and the fourth keyboard position. In some embodiments, the fifth keyboard position is based on (e.g., at least in part) (e.g., is in accordance with) a third angle, different from the first angle and the second angle, relative the first respective line. In some embodiments, the third angle is an angle that is selected from the range of zero (0) degrees to 10 degrees. In some embodiments, the third angle is zero degrees. Conditionally displaying the keyboard user interface as having a fifth keyboard position when the third position of the respective body part of the user of the computer system is a third range of positions performs an operation when a set of conditions has been met without requiring further user input and improves how the keyboard user interface is displayed in three-dimensional environment depending on the position of the user and reduces the possibility of an obstructed view of the keyboard user interface.

In some embodiments, the first keyboard position is based on a respective device position of the computer system within the three-dimensional environment (e.g., a first height relative to the ground/floor of the three-dimensional environment and/or at a first angle relative to the horizon and/or the ground/floor). In some embodiments, in accordance with a determination that the computer system has a first position (e.g., heights 704a-704d are relative to floor 714; and/or tilt as described at 7N) (e.g., a first height and/or a first set of spatial coordinates) within the three-dimensional environment (e.g., the computer system is at a height indicative of the user standing and/or the computer system is at an angle indicative of the user looking straight ahead), the first keyboard position is a sixth keyboard position (e.g., one of the orientations of 718 as described in FIGS. 7A-7T) (in some embodiments, a position at a height and/or angle that improves viewing while standing). In some embodiments, in accordance with a determination that the computer system has a second position (e.g., heights 704a-704d are relative to floor 714; and/or tilt as described at 7N) (e.g., a second height and/or a second set of spatial coordinates) within the three-dimensional environment (e.g., the computer system is at a height indicative of the user sitting or reclining and/or the computer system is at an angle indicative of a head of the user tilting up and/or down), the first keyboard position is a seventh keyboard position (e.g., one of the orientations of 718 as described in FIGS. 7A-7T) (in some embodiments, a position at a height and/or angle that improves viewing while sitting or reclining) that is different from the sixth keyboard position. Conditionally displaying the keyboard user interface as having different positions based on different positions of the computer system performs an operation when a set of conditions has been met without requiring further user input and improves how the keyboard user interface is displayed in three-dimensional environment depending on the detected position of the computer system and reduces the possibility of an obstructed view of the keyboard user interface.

In some embodiments, the first position of the computer system within the three-dimensional environment is a position relative to a first body part (e.g., a chest or feet of user 702; and/or a torso of the user in user position 1218a, 1218b, and/or 1218c as described in greater detail with respect to FIGS. 12A-12T) (e.g., head, eyes, torso, hands, chest, and/or, feet) (and/or a representation thereof) of a user of the computer system (e.g., a relationship between the position of the computer system relative to a position of the user's body obstructs a view of the keyboard user interface in a first manner; as depicted by 738 in FIG. 12A and FIG. 12T, the user's body obstructs a view of 718). In some embodiments, the second position of the computer system within the three-dimensional environment is a position (e.g., one of the orientations of 718 as described in FIGS. 7A-7T; and/or a torso of the user in user position 1218a, 1218b, and/or 1218c as described in greater detail with respect to FIGS. 12A-12T) relative to the first body part of the user of the computer system (e.g., a relationship between the position of the computer system relative to a position of the user's body obstructs a view of the keyboard user interface in a second manner different from the first manner; while in user position 1218a, 1218b, and/or 1218c, the user's body obstructs more or less of a view of 718 than what is obstructed in FIG. 12A and FIG. 12T). Conditionally displaying the keyboard user interface at different positions based on a position of the computer system relative to the first body part of the user performs an operation when a set of conditions has been met without requiring further user input and improves how the keyboard user interface is displayed in three-dimensional environment and prevents the keyboard user interface from being hidden or obstructed from view based on physical and/or virtual elements.

In some embodiments, the first position of the computer system within the three-dimensional environment is a position (e.g., one of the orientations of 718 as described in FIGS. 7A-7T) relative to a physical object (e.g., 707 and/or 719) (e.g., furniture, pillow, table, chair, and/or person) (and/or a representation thereof) (e.g., a relationship between the position of the computer system relative to a physical object obstructs a view of the keyboard user interface in a third manner). In some embodiments, the second position of the computer system within the three-dimensional environment is a position (e.g., one of the orientations of 718 as described in FIGS. 7A-7T) relative to a physical object (e.g., 707 and/or 719) (e.g., furniture, pillow, table, chair, and/or person) (and/or a representation thereof) (e.g., a relationship between the position of the computer system relative to a position of a physical object obstructs a view of the keyboard user interface in a fourth manner different from the third manner) (optionally, the first position and the second positions are both positions relative to the same physical object). Conditionally displaying the keyboard user interface at different positions based on a position of the computer system relative to a position of a physical object performs an operation when a set of conditions has been met without requiring further user input and improves how the keyboard user interface is displayed in three-dimensional environment and prevents the keyboard user interface from being hidden or obstructed from view based on physical and/or virtual elements.

In some embodiments, displaying the keyboard user interface at the first keyboard position (or the second keyboard position) is in accordance with a determination that a set of intersection criteria is satisfied, wherein the set of intersection criteria includes a criterion (e.g., one of the orientations of 718 as described in FIGS. 7A-7T does not intercept a chest of user 702 and/or object 719) that is satisfied when the first keyboard position (or the second keyboard position) does not cause the keyboard user interface to intersect with (e.g., intercept, obstruct, and/or extends through) (e.g., a representation of a user's chest and/or a representation of a user's stomach) (and/or intersect with a representation of at least a portion of a physical object) at least a portion of a physical object (e.g., user 702 and/or object 719) in the representation of the portion of the three-dimensional environment (e.g., the keyboard user interface does not extend through the representation of the user's body). In some embodiments, the criterion is satisfied when three dimensional coordinates of the first keyboard position does not overlap with three dimensional coordinates of a representation of at least a portion of a body of the user. In some embodiments, physical coordinates (e.g., on a physical x-, y-, z-axis) of the portion of the user's body (or physical object) correspond a set of one or more virtual coordinates (e.g., on a virtual x-, y-, z-axis) of the representation of the user's body such that a set of one or more virtual coordinates (e.g., on the virtual x-, y-, z-axis) of the keyboard user interface do not intersect with (e.g., does not overlap) the set of one or more virtual coordinates (e.g., on the virtual x-, y-, z-axis) of the representation of the user's body. In some embodiments, displaying the keyboard user interface at the respective keyboard position in the representation of the portion of the three-dimensional environment further includes in accordance with a determination that the first set of keyboard placement criteria (or the second set of keyboard placement criteria) is satisfied and in accordance with a determination that the set of intersection criteria is not satisfied, the respective keyboard position is at an eighth keyboard position (e.g., one of the orientations of 718 as described in FIGS. 7A-7T), different from the first keyboard position (e.g., a position that does not intersect a portion of the user (e.g., a position that is higher when the intersection occurs at the bottom of the interface and lower when the intersection is at the top of the interface)), in the representation of the portion of the three-dimensional environment. In some embodiments, the set of intersection criteria includes a criterion that is satisfied when the first keyboard position does not intersect a representation of a first type of physical object (e.g., floor, ceiling, table). In some embodiments, a portion of the keyboard user interface that intersects the representation of the portion of the body of the user is hidden (obstructed from view). Conditionally displaying the keyboard user interface at different positions based on whether the keyboard user interface intersects a representation of a portion of the body of the user performs an operation when a set of conditions has been met without requiring further user input and improves how the keyboard user interface is displayed in three-dimensional environment and prevents the keyboard user interface from being hidden or obstructed from view based the orientation of the keyboard and the virtual portion of user's body.

In some embodiments, the keyboard user interface includes a first character key (e.g., one character button of 724) (e.g., affordance and/or button) that, when selected, causes input (e.g., into a text field and/or at an insertion point) of a first alphanumeric character (e.g., a letter or number; in some embodiments, a first punctuation character). In some embodiments, the keyboard user interface includes a second character key (e.g., a different character button of 724) that, when selected, causes input of a second alphanumeric character, different from the first alphanumeric character. Including a first character key that, when selected, causes input of a first alphanumeric character and a second character key that, when selected, causes input of a second alphanumeric character, different from the first alphanumeric character allows a user to input characters using a graphical object, which reduces the need for additional, physical input devices (e.g., a hardware keyboard).

In some embodiments, the keyboard user interface includes a respective interface object for suggested content (e.g., 727a-727c) (e.g., suggested alphanumeric text, suggested emojis, and/or suggested words). In some embodiments, while displaying the keyboard user interface at the respective keyboard position, the computer system detects, via a hardware keyboard (e.g., 907 and/or 910) (a hardware keyboard that is in communication with the computer system), an input to add respective content (e.g., 702 types on 904 and/or 908) (e.g., the user of the computer system is typing on a physical hardware keyboard). In response to detecting the input to add respective content and in accordance with a determination that the respective content is first content, the respective interface object for first content includes first suggested content (e.g., 727a-727c is updated based on what is typed) (e.g., the suggested content region is updated with one or more suggested words or emoji based on input detected via the hardware keyboard such as selecting one or more characters based on activation of one or more character keys). In response to detecting the input to add respective content and in accordance with a determination that the respective content is second content, different from the first content, the respective interface object for suggested content includes second suggested content (e.g., 727a-727c is updated based on what is typed), different from the first suggested content (e.g., the suggested content region is updated with a different set of one or more suggested words and/or suggested emoji based on input detected via the hardware keyboard such as selecting one or more characters based on activation of one or more character keys). Including an interface object for suggested content that conditionally includes first suggested content or second suggested content based on input detected via a hardware keyboard reduces the need for additional, physical input on the hardware keyboard.

In some embodiments, the computer system detects, via the one or more input devices, a key selection input (e.g., input on one of character buttons 724, input on one of suggested text buttons 727a-727c, and/or an input on one of keys of 904 or 908) (e.g., a keystroke or an input on a respective key), wherein the key selection input is an input (e.g., input on one of character buttons 724) detected on the keyboard user interface or an input detected via a hardware keyboard (e.g., 904 and/or 908) (e.g., a hardware keyboard that is in communication with the computer system). In response to detecting the key selection input, the computer system displays, via the display generation component, content (e.g., 906 of FIGS. 9E1, 9E2, and 9F) (e.g., alphanumeric text and/or punctuation marks) corresponding to the key selection input in a text entry field (e.g., 712) (e.g., a text entry field in the representation of the application such as a text entry input field that is currently configured to receive text input from the keyboard). In some embodiments, the hardware keyboard includes a set of one or more physical keys (e.g., physical keys on a physical keyboard) corresponding the content. Displaying content in a text entry field where the content corresponds to the key selection input of the keyboard user interface and/or a hardware keyboard provides visual feedback that user input was detected.

In some embodiments, displaying the keyboard user interface at the first keyboard position includes displaying the keyboard user interface with a first set of one or more position parameters (e.g., one or more coordinates of an orientation of 718 in FIGS. 7A-7T) (e.g., angle and/or coordinates on the virtual coordinate system, such as x-, y-, z-axis). In some embodiments, while displaying the keyboard user interface at the first keyboard position, the computer system detects, via the one or more input devices, a request (e.g., 750g and/or 950c2) to modify the first set of one or more position parameters (e.g., angle and/or coordinates on the virtual coordinate system, such as x-, y-, z-axis) of the keyboard user interface. In response to detecting the request to modify the first set of one or more position parameters of the keyboard user interface, the computer system displays, via the display generation component, the keyboard user interface with a second set of one or more position parameters (e.g., 718 has updated coordinates in FIGS. 7H and 71) (e.g., angle and/or coordinates on the virtual coordinate system, such as x-, y-, z-axis) (in some embodiments, displaying the keyboard user interface with the second set of one or more position parameters includes displaying the keyboard user interface at a modified position different from the first position). After displaying the keyboard user interface with the second set of one or more position parameters (in some embodiments, at the modified keyboard position), the computer system detects, via the one or more input devices, a set of one or more inputs (e.g., 750i) (e.g., corresponding to a request to stop displaying the keyboard user interface, corresponding to a user closing the respective application, one or more movements of a user, and/or a request to terminate a text entry session) (e.g., an air gesture, a user's gaze, a speech input, a touch input, and/or mouse click). In response to detecting the set of one or more inputs, the computer system ceases display of the keyboard user interface (e.g., as illustrated in FIG. 7J). While the keyboard user interface is not displayed, the computer system receives, via the one or more input devices, a second request (e.g., 750j) to display the keyboard user interface in the representation of the portion of the three-dimensional environment. In response to receiving the second request to display the keyboard user interface, the computer system displays, via the display generation component, the keyboard user interface with a third set of one or more position parameters (e.g., coordinates of 718 in FIGS. 7K and 7L) (e.g., angle and/or coordinates on the virtual coordinate system, such as x-, y-, z-axis), wherein the third set of one or more position parameters includes at least one position parameter included in (e.g., based on and/or selected based on) the second set of one or more position parameters (e.g., 718 has the same depth and/or angle in FIGS. 7K and 7L) (e.g., at least a portion, if not all, of the modified parameters are used when the keyboard user interface is redisplayed). In some embodiments, the third set of one or more position parameters is the same as the second (and/or the first) set of one or more position parameters. In some embodiments, the third set of one or more position is different from the second (and/or the first) set of one or more position parameters. Displaying the keyboard user interface with the third set of one or more position parameters at least one position parameter included in the second set of one or more position parameters in response to receiving a second request to display the keyboard user interface and improves how the keyboard user interface is displayed in three-dimensional environment after one or more position parameters have been modified.

In some embodiments, displaying the keyboard user interface with the second set of one or more position parameters includes displaying the keyboard user interface at a respective position (e.g., one of the orientations of 718 as described in FIGS. 7A-7T) (e.g., respective angle and/or respective distance) relative to the computer system. In some embodiments, displaying the keyboard user interface with the third set of one or more position parameters includes: in accordance with a determination that a set of one or more positioning criteria are met, wherein the set of one or more positioning criteria includes a criterion that is met when at least a portion of a body of a user of the computer system has moved less than a threshold amount (user has not moved as described with respect to FIGS. 7K and 7L) (e.g., of distance, such as 1 inch, 6 inches, and/or two feet) (e.g., of an angle, such as 5 degrees, 20 degrees, 90 degrees) after ceasing display of the keyboard user interface, displaying the keyboard user interface at the respective position relative to the computer system (e.g., one of the orientations of 718 as described in FIGS. 7A-7T) (or, alternatively, relative to the three-dimensional environment) (e.g., the second set of one or more position parameters and the third set of one or more position parameters are the same or different depending on if the user has not moved or moved less than a threshold amount). In some embodiments, in accordance with a determination that the at least a portion of a body of a user of the computer system has moved more than the threshold amount after ceasing display of the keyboard user interface, the computer system displays the keyboard user interface at the respective position relative to the computer system (or, alternatively, relative to the three-dimensional environment) (e.g., and at a set of one or more position parameters that is different from the third set of set of one or more position parameters). In some embodiments, a movement of the portion of the body of the user corresponds to (or does not correspond to) the same amount of movement as the computer system if the computer system is worn on the part of the user's body that has moved. In some embodiments, the threshold distance is based on a current position of the portion of the body part (e.g., when the second request to display the keyboard user interface was received) and a position of the portion of the body part at a point in time that the keyboard user interface was last displayed. Conditionally displaying the keyboard user interface at a respective position relative to the computer system (or, alternatively, relative to the three-dimensional environment) based on when a portion of a body of the user has moved less than a threshold amount after ceasing display of the keyboard user interface performs an operation when a set of conditions has been met without requiring further user input and improves how the keyboard user interface is displayed in three-dimensional environment after one or more position parameters have been modified.

In some embodiments, the request to modify the first set of one or more position parameters of the keyboard user interface is a request to modify a position of the keyboard user interface for a first application (e.g., the email application of FIGS. 7A-7T). in some embodiments, while the keyboard user interface is not displayed, the computer system receives, via the one or more input devices, a third request (e.g., 750a, 750c, 750j 750n, 750p, 750s, 950a, 905d, 950k, and/or 950y) to display the keyboard user interface in the representation of the portion of the three-dimensional environment. In response to receiving the third request to display the keyboard user interface and in accordance with a determination that the third request to display the keyboard user interface corresponds to a request to display the keyboard user interface for the first application, the computer system displays, via the display generation component, the keyboard user interface with the third set of one or more position parameters (e.g., 718 is displayed using a modified position, similar to a modified orientation of FIGS. 7K and 7L) (e.g., angle and/or coordinates on the virtual coordinate system, such as x-, y-, z-axis) (e.g., the keyboard is displayed in the modified position for the same application). In response to receiving the third request to display the keyboard user interface and in accordance with a determination that the third request to display the keyboard user interface corresponds to a request to display the keyboard user interface for a second application (e.g., an application other than the email application of FIGS. 7A-7T), different from the first application, the computer system displays, via the display generation component, the keyboard user interface with a fourth set of one or more position parameters (e.g., 718 is displayed using default position and/or a modified position that is specific for the different application) (e.g., angle and/or coordinates on the virtual coordinate system, such as x-, y-, z-axis) that is different from the third set of one or more position parameters (e.g., the modified position is used on a per application basis and/or the modified position of the keyboard user interface for the first application is not applied to other applications) (e.g., at least one position parameter (e.g., angle and/or coordinate on the virtual coordinate system, such as x-, y-, z-axis) from the fourth set of one or more position parameters is different from a corresponding position parameter from the third set of one or more position parameters). In some embodiments, the first application is an application for which the keyboard user interface was initially invoked. In some embodiments, the fourth set of one or more position parameters are the same (or different from) the first set of one or more position parameters. Conditionally displaying the keyboard user interface with the third set of one or more position parameters based on whether the third request to display the keyboard user interface corresponds to a request to display the keyboard user interface for the first application or a second application performs an operation when a set of conditions has been met without requiring further user input and improves how the keyboard user interface is displayed in three-dimensional environment after one or more position parameters have been modified for a specific application.

In some embodiments, displaying the keyboard user interface with the third set of one or more position parameters includes: in accordance with a determination that a second body part (e.g., eyes, head, hands, chest, and/or entire body) has moved more than a threshold amount (e.g., of distance, such as 1 inch, 6 inches, and/or two feet) (e.g., of an angle, such as 5 degrees, 20 degrees, 90 degrees) after ceasing display of the keyboard user interface (e.g., user 702 has moved to different part of the room in FIG. 7M) (in some embodiments, the movement of the second body part more than the threshold amount causes the user interface of the application to move from a first application position to a second application different from the first application position), displaying, via the display generation component, the keyboard user interface at a respective position that is offset from a default position (e.g., as described at FIG. 7M, 718 is displayed at a default orientation) (e.g., a predetermined position at which the keyboard user interface is displayed in the absence of user adjustments) by a first offset value (e.g., 718 is displayed as being offset along the x-axis, y-axis, and/or z-axis), wherein the first offset value is based on the second set of one or more position parameters (e.g., 718 is displayed as being offset based on one of the coordinates of the modified orientation) (in some embodiments, based on a characteristic of the request to modify the first set of one or more position parameters) (e.g., and, optionally, at a fifth set of one or more position parameters that is different from the third set of one or more position parameters) (e.g., the keyboard user interface is displayed based on a relative position of the user interface of the application). In some embodiments, the first offset value from the default position after the second body part has moved more than the threshold amount is the same as a respective offset value from a respective default position the keyboard user interface had prior to moving (e.g., the current offset from the default position is the same as the offset from the default position that the keyboard had before the user moved). In some embodiments, the user interface of the application is in the same (or different) position relative to the user interface of the application as it was after the user's movement is more than the threshold amount. In some embodiments, in accordance with a determination that the second body part has not moved more than the threshold amount after ceasing display of the keyboard user interface, the computer system displays the keyboard user interface at the respective position that is offset from the default position relative to the user interface of the application (or, optionally, the computer system displays the keyboard user interface at the default position relative to the user interface). Conditionally displaying the keyboard user interface at the respective position relative to the user interface based on whether the second body part has moved more than a threshold amount performs an operation when a set of conditions has been met without requiring further user input and improves how the keyboard user interface is displayed in three-dimensional environment after one or more position parameters have been modified.

In some embodiments, aspects/operations of methods 800, 1000, 1100, and 1300 may be interchanged, substituted, and/or added between these methods. For example, methods 1000, 1100, and 1300 optionally includes features for positioning a virtual keyboard differently based what criteria or conditions are satisfied (e.g., including pose of the application and/or based on position of user 702, device 700, and/or HMD X700) as described in method 800. For brevity, these details are not repeated here.

FIGS. 9A-9Z illustrate examples of displaying various types of virtual keyboards. FIG. 10 is a flow diagram of an exemplary method 1000 for displaying various types of virtual keyboard. FIG. 11 is a flow diagram of an exemplary method 1100 for switching between virtual keyboards. The user interfaces in FIGS. 9A-9Z are used to illustrate the processes described below, including the processes in FIGS. 10-11.

FIGS. 9A-9Z illustrate examples of device 700 sitting on table 902 in front of user 702. In some embodiments, device 700 is a head-mounted device. In some embodiments, a virtual keyboard is displayed as part of an extended reality user interface and/or extended reality environment/experience. In some such embodiments, different virtual keyboards can be displayed within the extended reality environment, along with other virtual objects (e.g., virtual user interfaces and/or text entry fields). In some such embodiments, a user can switch between different virtual keyboards displayed in the extended reality environment, including switching based on one or more hardware keyboards that are detected in the physical environment. In some such embodiments, user 702 interacts with a hardware keyboard while wearing device 700 on the head of user 702.

At FIG. 9A, device 700 displays an image of table surface 902 and email application interface 710 (which is the same as email application interface 710 shown in FIGS. 7A-7T but has a different state). Device 700 of FIGS. 9A-9Z is the same as device 700 of FIGS. 7A-7T, but is on a stand on table surface 902. Notably, device 700 has at least one camera that has a field of view that includes table surface 902. While displaying email application interface 710, device 700 detects input 950a (e.g., a touch input, an air gesture, a gaze, a mouse click, and/or a combination thereof) directed at text field 712.

At FIG. 9B, in response to detecting input 950a, device 700 displays keyboard 718 of FIG. 9B. Keyboard 718 of FIG. 9B is similar to keyboard 718 of FIGS. 7A-7T, including character buttons 724, suggested text buttons 727a-727c, view 728 of text field 712, keyboard mode affordance 744, and close affordance 736. Additionally, keyboard 718 of FIG. 9B includes reposition indicator 732 to move keyboard 718 to a different position. As described with reference to FIGS. 9A-9Z, device 700 displays various software keyboard interfaces based on whether a hardware keyboard is detected and/or what type of hardware keyboard is detected. Additionally, as described herein, device 700 detects whether the hardware keyboard is near user 702 and, in response, displays various virtual keyboard interfaces. At FIG. 9B, device 700 displays keyboard 718 because no hardware keyboard is currently connected (e.g., wirelessly connected) and/or no hardware keyboard is near user 702.

At FIG. 9C1, unrecognized hardware keyboard 904 is connected to device 700 and is within the field of view of the various cameras of device 700. In some embodiments, unrecognized hardware keyboard 904 is a hardware keyboard that is registered with device 700 (e.g., is in communication with device 700) but is otherwise unknown and/or unidentified by device 700, as illustrated by dotted outline 907. In some embodiments, unrecognized keyboard is a keyboard that is not recognized as a keyboard of respective type (e.g., a keyboard of specific make and/or model) or is expressly recognized as not being a keyboard of the respective type (e.g., is recognized as a keyboard of a different type). In some embodiments, unrecognized hardware keyboard 904 is a keyboard that includes at least one unknown keyboard parameter (e.g., size, shape, keyboard layout, model number, manufacturer, and/or brand). As described in greater detail herein, device 700 identifies recognized hardware keyboard 908 but does not identify unrecognized hardware keyboard 904. Accordingly, device 700 identifies one hardware keyboard type but not a different hardware keyboard type. In some embodiments, unrecognized hardware keyboard 904 is one type of recognized hardware keyboard (e.g., having one size, shape, and/or keyboard layout) while recognized hardware keyboard 908 is a different type of recognized hardware keyboard (e.g., having different size, shape, and/or keyboard layout).

At FIG. 9C1, unrecognized hardware keyboard 904 includes a plurality of hardware keys that, when selected, add a respective character (e.g., alphanumeric text, punction marks, and/or symbols) to text entry field 712. While displaying keyboard 718, device 700 detects input 905c via hardware keyboard 904 (e.g., a press of a hardware keyboard key and/or an input that adds content to text field 712 via a hardware keyboard). In response to detecting input 905c via hardware keyboard 904, device 700 displays keyboard augmentation region 918 of FIGS. 9E1 and/or 9E2 and adds text to text entry field 712. In some embodiments, keyboard augmentation region 918 is used in conjunction with a physical keyboard so that the user primarily type basic characters via the physical keyboards and uses keyboard augmentation region 918 for keyboard-related auxiliary functions.

In some embodiments, the techniques and user interface(s) described in FIGS. 9A-9Z are provided by one or more of the devices described in FIGS. 1A-1P. For example, FIG. 9C2 illustrates an embodiment in which keyboard 718 (e.g., as described in FIG. 9C1) is displayed on display module X702 of head-mounted device (HMD) X700. In some embodiments, HMD X700 includes a pair of display modules that provide stereoscopic content to different eyes of the same user. For example, HMD X700 includes display module X702 (which provides content to a left eye of the user) and a second display module (which provides content to a right eye of the user). In some embodiments, the second display module displays a slightly different image than display module X702 to generate the illusion of stereoscopic depth.

At FIG. 9C2, unrecognized hardware keyboard 904 is connected to HMD X700 and is within the field of view of the various cameras of HMD X700. In some embodiments, unrecognized hardware keyboard 904 is a hardware keyboard that is registered with HMD X700 (e.g., is in communication with HMD X700) but is otherwise unknown and/or unidentified by HMD X700, as illustrated by dotted outline 907. In some embodiments, unrecognized keyboard is a keyboard that is not recognized as a keyboard of respective type (e.g., a keyboard of specific make and/or model) or is expressly recognized as not being a keyboard of the respective type (e.g., is recognized as a keyboard of a different type). In some embodiments, unrecognized hardware keyboard 904 is a keyboard that includes at least one unknown keyboard parameter (e.g., size, shape, keyboard layout, model number, manufacturer, and/or brand). As described in greater detail herein, HMD X700 identifies recognized hardware keyboard 908 but does not identify unrecognized hardware keyboard 904. Accordingly, HMD X700 identifies one hardware keyboard type but not a different hardware keyboard type. In some embodiments, unrecognized hardware keyboard 904 is one type of recognized hardware keyboard (e.g., having one size, shape, and/or keyboard layout) while recognized hardware keyboard 908 is a different type of recognized hardware keyboard (e.g., having different size, shape, and/or keyboard layout).

At FIG. 9C2, unrecognized hardware keyboard 904 includes a plurality of hardware keys that, when selected, add a respective character (e.g., alphanumeric text, punction marks, and/or symbols) to text entry field 712. While displaying keyboard 718, HMD X700 detects input X905c via hardware keyboard 904 (e.g., a press of a hardware keyboard key and/or an input that adds content to text field 712 via a hardware keyboard). In response to detecting input X905c via hardware keyboard 904, HMD X700 displays keyboard augmentation region 918 of FIGS. 9E1 and/or 9E2 and adds text to text entry field 712. In some embodiments, keyboard augmentation region 918 is used in conjunction with a physical keyboard so that the user primarily type basic characters via the physical keyboards and uses keyboard augmentation region 918 for keyboard-related auxiliary functions.

Any of the features, components, and/or parts, including the arrangements and configurations thereof shown in FIGS. 1B-1P can be included, either alone or in any combination, in HMD X700. For example, in some embodiments, HMD X700 includes any of the features, components, and/or parts of HMD 1-100, 1-200, 3-100, 6-100, 6-200, 6-300, 6-400, 11.1.1-100, and/or 11.1.2-100, either alone or in any combination. In some embodiments, display module X702 includes any of the features, components, and/or parts of display unit 1-102, display unit 1-202, display unit 1-306, display unit 1-406, display generation component 120, display screens 1-122a-b, first and second rear-facing display screens 1-322a, 1-322b, display 11.3.2-104, first and second display assemblies 1-120a, 1-120b, display assembly 1-320, display assembly 1-421, first and second display sub-assemblies 1-420a, 1-420b, display assembly 3-108, display assembly 11.3.2-204, first and second optical modules 11.1.1-104a and 11.1.1-104b, optical module 11.3.2-100, optical module 11.3.2-200, lenticular lens array 3-110, display region or area 6-232, and/or display/display region 6-334, either alone or in any combination. In some embodiments, HMD X700 includes a sensor that includes any of the features, components, and/or parts of any of sensors 190, sensors 306, image sensors 314, image sensors 404, sensor assembly 1-356, sensor assembly 1-456, sensor system 6-102, sensor system 6-202, sensors 6-203, sensor system 6-302, sensors 6-303, sensor system 6-402, and/or sensors 11.1.2-110a-f, either alone or in any combination. In some embodiments, HMD X700 includes one or more input devices, which include any of the features, components, and/or parts of any of first button 1-128, button 11.1.1-114, second button 1-132, and or dial or button 1-328, either alone or in any combination. In some embodiments, HMD X700 includes one or more audio output components (e.g., electronic component 1-112) for generating audio feedback (e.g., audio output), optionally generated based on detected events and/or user inputs detected by the HMD X700.

At FIG. 9D, device 700 displays text field 712 of email application interface 710 and is connected to unrecognized hardware keyboard 904. While displaying email application interface 710, device 700 detects input 905d via hardware keyboard 904 (e.g., a press of a hardware keyboard key and/or an input that adds content to text field 712 via a hardware keyboard). In response to detecting input 905d via hardware keyboard 904, device 700 displays keyboard augmentation region 918 of FIGS. 9E1 and/or 9E2 and adds text to text entry field 712.

At FIG. 9E1, in response to detecting input 905c of FIG. 9C1, input X905c of FIG. 9C2, and/or input 905d FIG. 9D, device 700 displays keyboard augmentation region 918 and text 906 in text field 712. Augmented keyboard 918 includes a portion of keyboard 718. For example, keyboard augmentation region 918 includes view 728 of text field 712, where view 728 has been updated to include text 906. As a further example, keyboard augmentation region 918 includes suggested text 727a, 727b, and 727c. Augmented keyboard 918 also includes keyboard mode affordance 744 (e.g., to switch back to keyboard 718). However, keyboard augmentation region 918 does not include character buttons 724. In some embodiments, keyboard augmentation region 918 includes a portion (e.g., some but not all of) character buttons 724. In some embodiments, keyboard augmentation region 918 includes a fewer character buttons 724 and/or fewer number of rows (or columns) of character buttons 724 than keyboard 718. In some embodiments, keyboard augmentation region 918 occupies a different (e.g., smaller and/or larger) region of display 701 than a region occupied by keyboard 718.

At FIG. 9E1, keyboard augmentation region 918 is displayed in a portion of display 701 that was previously occupied by keyboard 718 of FIGS. 9C1 and/or 9C2. In some embodiments, the orientation of keyboard augmentation region 918 is a similar orientation as that of keyboard 718 of FIGS. 9C1 and/or 9C2. In some embodiments, keyboard augmentation region 918 has the same depth and/or angle of keyboard 718 of FIGS. 9C1 and/or 9C2. In some embodiments, keyboard augmentation region 918 has an orientation in three-dimensional environment 706 as described in greater detail with respect to keyboard 718 of FIGS. 7A-7T. Device 700 detects input 950e1 (e.g., a touch input, an air gesture, a gaze, a mouse click, and/or a combination thereof) directed at suggested text 727b. Device 700 also detects input 950e2 (e.g., a touch input, an air gesture, a gaze, a mouse click, and/or a combination thereof) directed at reposition indicator 732 to move keyboard augmentation region 918. Reposition indicator 732 of FIG. 9E1 is the same as reposition indicator 732 described with respect to FIG. 7G but has a different state (e.g., different size, different orientation, different symbol, and/or different color). In some embodiments, reposition indicator 732 is displayed when the location of keyboard augmentation region 918 (and/or keyboard 718) is not tied to a physical keyboard, as described in greater detail with respect to FIGS. 9M1-9N. In some embodiments, device 700 does not display reposition indicator 732 when keyboard augmentation region 918 (and/or keyboard 718) is tied to the physical keyboard.

At FIG. 9E1, in response to detecting input 950e1, device 700 displays keyboard augmentation region 918 at a new orientation in three-dimensional environment 706, similar to how the orientation of keyboard 718 is changed as described with respect to keyboard 718 of FIGS. 7A-7T. For example, keyboard augmentation region 918 in FIG. 9E1 is closer to the image of unrecognized keyboard 904 as compared to the position of keyboard augmentation region 918 of FIG. 9D. In response to detecting input 950e2, device 700 displays text 906 in text field 712.

In some embodiments, the techniques and user interface(s) described in FIGS. 9A-9Z are provided by one or more of the devices described in FIGS. 1A-1P. For example, FIG. 9E2 illustrates an embodiment in which keyboard augmentation region 918 (e.g., as described in FIG. 9E1) is displayed on display module X702 of head-mounted device (HMD) X700. In some embodiments, HMD X700 includes a pair of display modules that provide stereoscopic content to different eyes of the same user. For example, HMD X700 includes display module X702 (which provides content to a left eye of the user) and a second display module (which provides content to a right eye of the user). In some embodiments, the second display module displays a slightly different image than display module X702 to generate the illusion of stereoscopic depth.

At FIG. 9E2, in response to detecting input 905c of FIG. 9C1, input X905c of FIG. 9C2, and/or input 905d FIG. 9D, HMD X700 displays keyboard augmentation region 918 and text 906 in text field 712. Augmented keyboard 918 includes a portion of keyboard 718. For example, keyboard augmentation region 918 includes view 728 of text field 712, where view 728 has been updated to include text 906. As a further example, keyboard augmentation region 918 includes suggested text 727a, 727b, and 727c. Augmented keyboard 918 also includes keyboard mode affordance 744 (e.g., to switch back to keyboard 718). However, keyboard augmentation region 918 does not include character buttons 724. In some embodiments, keyboard augmentation region 918 includes a portion (e.g., some but not all of) character buttons 724. In some embodiments, keyboard augmentation region 918 includes a fewer character buttons 724 and/or fewer number of rows (or columns) of character buttons 724 than keyboard 718. In some embodiments, keyboard augmentation region 918 occupies a different (e.g., smaller and/or larger) region of display X702 than a region occupied by keyboard 718.

At FIG. 9E2, keyboard augmentation region 918 is displayed in a portion of display X702 that was previously occupied by keyboard 718 of FIGS. 9C1 and/or 9C2. In some embodiments, the orientation of keyboard augmentation region 918 is a similar orientation as that of keyboard 718 of FIGS. 9C1 and/or 9C2. In some embodiments, keyboard augmentation region 918 has the same depth and/or angle of keyboard 718 of FIGS. 9C1 and/or 9C2. In some embodiments, keyboard augmentation region 918 has an orientation in three-dimensional environment 706 as described in greater detail with respect to keyboard 718 of FIGS. 7A-7T. HMD X700 detects input X950e1 (e.g., a touch input, an air gesture, a gaze, a mouse click, and/or a combination thereof) directed at suggested text 727b. HMD X700 also detects input X950e2 (e.g., a touch input, an air gesture, a gaze, a mouse click, and/or a combination thereof) directed at reposition indicator 732 to move keyboard augmentation region 918. Reposition indicator 732 of FIG. 9E2 is the same as reposition indicator 732 described with respect to FIG. 7G but has a different state (e.g., different size, different orientation, different symbol, and/or different color). In some embodiments, reposition indicator 732 is displayed when the location of keyboard augmentation region 918 (and/or keyboard 718) is not tied to a physical keyboard, as described in greater detail with respect to FIGS. 9M1-9N. In some embodiments, HMD X700 does not display reposition indicator 732 when keyboard augmentation region 918 (and/or keyboard 718) is tied to the physical keyboard.

At FIG. 9E2, in response to detecting input X950e1, HMD X700 displays keyboard augmentation region 918 at a new orientation in three-dimensional environment 706, similar to how the orientation of keyboard 718 is changed as described with respect to keyboard 718 of FIGS. 7A-7T. For example, keyboard augmentation region 918 in FIG. 9E2 is closer to the image of unrecognized keyboard 904 as compared to the position of keyboard augmentation region 918 of FIG. 9D. In response to detecting input X950e2, HMD X700 displays text 906 in text field 712.

Any of the features, components, and/or parts, including the arrangements and configurations thereof shown in FIGS. 1B-1P can be included, either alone or in any combination, in HMD X700. For example, in some embodiments, HMD X700 includes any of the features, components, and/or parts of HMD 1-100, 1-200, 3-100, 6-100, 6-200, 6-300, 6-400, 11.1.1-100, and/or 11.1.2-100, either alone or in any combination. In some embodiments, display module X702 includes any of the features, components, and/or parts of display unit 1-102, display unit 1-202, display unit 1-306, display unit 1-406, display generation component 120, display screens 1-122a-b, first and second rear-facing display screens 1-322a, 1-322b, display 11.3.2-104, first and second display assemblies 1-120a, 1-120b, display assembly 1-320, display assembly 1-421, first and second display sub-assemblies 1-420a, 1-420b, display assembly 3-108, display assembly 11.3.2-204, first and second optical modules 11.1.1-104a and 11.1.1-104b, optical module 11.3.2-100, optical module 11.3.2-200, lenticular lens array 3-110, display region or area 6-232, and/or display/display region 6-334, either alone or in any combination. In some embodiments, HMD X700 includes a sensor that includes any of the features, components, and/or parts of any of sensors 190, sensors 306, image sensors 314, image sensors 404, sensor assembly 1-356, sensor assembly 1-456, sensor system 6-102, sensor system 6-202, sensors 6-203, sensor system 6-302, sensors 6-303, sensor system 6-402, and/or sensors 11.1.2-110a-f, either alone or in any combination. In some embodiments, HMD X700 includes one or more input devices, which include any of the features, components, and/or parts of any of first button 1-128, button 11.1.1-114, second button 1-132, and or dial or button 1-328, either alone or in any combination. In some embodiments, HMD X700 includes one or more audio output components (e.g., electronic component 1-112) for generating audio feedback (e.g., audio output), optionally generated based on detected events and/or user inputs detected by the HMD X700.

At FIG. 9G, device 700 detects that unrecognized keyboard 904 is disconnected. In some embodiments, device 700 lost wireless connection with unrecognized keyboard 904 and/or unrecognized keyboard 904 was powered down. In response to detecting that unrecognized keyboard 904 is disconnected, device 700 switches to displaying keyboard 718 (e.g., while maintaining the input session). In some embodiments, keyboard 718 occupies at least a portion of the display that was previously occupied by keyboard augmentation region 918 of FIG. 9F.

At FIG. 9H, device 700 detects that unrecognized keyboard 904 is reconnected (e.g., during the input session). In some embodiments, device 700 regains wireless connection with unrecognized keyboard 904 and/or unrecognized keyboard 904 was powered on. In response to detecting that unrecognized keyboard 904 is reconnected, device 700 switches to displaying keyboard augmentation region 918 (e.g., while maintaining the input session). In some embodiments, keyboard augmentation region 918 occupies at least a portion of the display that was previously occupied by keyboard 718 of FIG. 9G. In some embodiments, while displaying keyboard augmentation region 918, device 700 detects input 950h (e.g., a touch input, an air gesture, a gaze, a mouse click, and/or a combination thereof) directed at keyboard mode affordance 744. In such embodiments, in response to detecting input 950h, device 700 displays keyboard 718 as depicted in FIG. 9G. As described herein, device 700 will switch between displaying keyboard 718 and keyboard augmentation region 918 in response to detecting an input directed at keyboard mode affordance 744.

At FIG. 9I, device 700 detects that unrecognized hardware keyboard 904 is still connected and that unrecognized hardware keyboard 904 is beyond a threshold distance (e.g., six inches, one foot, or two feet) from device 700 and/or user 702. For example, unrecognized hardware keyboard 904 is on the floor and/or not in front of user 702. In response, device 700 displays keyboard 718 instead of keyboard augmentation region 918. In some embodiments, device 700 detects that unrecognized hardware keyboard 904 is out of reach of user 702 and, in response, displays keyboard 718. In some embodiments, device 700 detects that unrecognized hardware keyboard 904 is connected but is not within a portion of a field of view of a camera of device 700 and/or is not within a field of view of user 702. In such embodiments, device 700 displays keyboard 718.

At FIG. 9J, device 700 detects that unrecognized hardware keyboard 904 is still connected and is now within the threshold distance. For example, unrecognized hardware keyboard 904 is on table surface 902, is in front of user 702, and/or is within reach of user 702. In response, device 700 displays keyboard augmentation region 918 with reposition indicator 732. At FIG. 9J, device 700 detects input 950j (e.g., a touch input, an air gesture, a gaze, a mouse click, and/or a combination thereof) directed at close affordance 736 to close keyboard augmentation region 918.

At FIG. 9K, device 700 is connected to recognized hardware keyboard 908. In some embodiments, as described herein, recognized hardware keyboard 908 is a hardware keyboard that is registered with device 700 (e.g., is in communication with device 700), is a known hardware keyboard, and/or is identifiable by device 700, as illustrated by solid outline 910. In some embodiments, recognized hardware keyboard 908 is a keyboard where the keyboard parameters are known (e.g., keyboard parameters such as a size, shape, keyboard layout, model number, manufacturer, and/or brand). In some embodiments, recognized keyboard is a keyboard of respective type (e.g., a respective make and/or model). In some embodiments, recognized keyboard is recognized based on data transmitted by recognized keyboard. In some embodiments, recognized keyboard is recognized based on camera image data (e.g., identifying a physical appearance that matches a known appearance). While device 700 is connected to recognized hardware keyboard 908, device 700 detects input 950k (e.g., a touch input, an air gesture, a gaze, a mouse click, and/or a combination thereof) directed at text field 712.

At FIG. 9L, in response to detecting input 950k of FIG. 9K, device 700 displays animation 924 of keyboard augmentation region 918 sliding into position. Animation 924 includes sliding keyboard augmentation region 918 up from the top (e.g., adjacent to the top) of recognized hardware keyboard 908. Animation 924 provides a visual effect that keyboard augmentation region 918 is sliding out from behind a top edge of recognized hardware keyboard 908. Device 700 continues to display animation 924 until keyboard augmentation region 918 is full displayed, as depicted in FIG. 9L. In some embodiments, animation 924 includes decreasing a transparency of keyboard augmentation region 918 over time, sliding keyboard augmentation region 918 in a different direction, and/or increasing a size of keyboard augmentation region 918.

At FIG. 9M1, device 700 displays keyboard augmentation region 918 at an orientation that is automatically defined, at least in part, by the orientation of recognized hardware keyboard 908. As depicted in FIG. 9M1, keyboard augmentation region 918 is centered relative to the text character keys of recognized hardware keyboard 908. Additionally, keyboard augmentation region 918 is displayed adjacent to a top edge of recognized hardware keyboard 908. This is in contrast to the orientation of keyboard augmentation region 918 of FIGS. 9E1 and/or 9E2, which is not centered relative to the text character keys of unrecognized hardware keyboard 904 and/or is not displayed adjacent to the top edge (unless user 702 manually moves keyboard augmentation region 918, as described with respect to FIGS. 9E1-9F). Further, device 700 does not display reposition indicator 732 at FIG. 9M1, which is in contrast to device 700 displaying reposition indicator 732 when unrecognized hardware keyboard 904 is detected as described in reference to FIGS. 9E1 and/or 9E2. This helps user 702 quickly identify whether the orientation of keyboard augmentation region 918 is automatically defined by the orientation of a hardware keyboard or not. In some embodiments, keyboard augmentation region 918 is world locked when the orientation of keyboard augmentation region 918 is automatically defined by the orientation of recognized hardware keyboard 908. In such embodiments, as a user's changes his or her viewpoint, the orientation of keyboard augmentation region 918 within three-dimensional environment 706 stays the same, but the user's point of view of keyboard augmentation region 918 changes. At FIG. 9M1, device 700 detects movement 914 (e.g., shifting or rotation) of recognized hardware keyboard 908.

In some embodiments, the techniques and user interface(s) described in FIGS. 9A-9Z are provided by one or more of the devices described in FIGS. 1A-1P. For example, FIG. 9M2 illustrates an embodiment in which keyboard augmentation region 918 (e.g., as described in FIGS. 9E1-9M1) is displayed on display module X702 of head-mounted device (HMD) X700. In some embodiments, HMD X700 includes a pair of display modules that provide stereoscopic content to different eyes of the same user. For example, HMD X700 includes display module X702 (which provides content to a left eye of the user) and a second display module (which provides content to a right eye of the user). In some embodiments, the second display module displays a slightly different image than display module X702 to generate the illusion of stereoscopic depth.

At FIG. 9M2, HMD X700 displays keyboard augmentation region 918 at an orientation that is automatically defined, at least in part, by the orientation of recognized hardware keyboard 908. As depicted in FIG. 9M2, keyboard augmentation region 918 is centered relative to the text character keys of recognized hardware keyboard 908. Additionally, keyboard augmentation region 918 is displayed adjacent to a top edge of recognized hardware keyboard 908. This is in contrast to the orientation of keyboard augmentation region 918 of FIGS. 9E1 and/or 9E2, which is not centered relative to the text character keys of unrecognized hardware keyboard 904 and/or is not displayed adjacent to the top edge (unless user 702 manually moves keyboard augmentation region 918, as described with respect to FIGS. 9E1-9F). Further, HMD X700 does not display reposition indicator 732 at FIG. 9M2, which is in contrast to HMD X700 displaying reposition indicator 732 when unrecognized hardware keyboard 904 is detected as described in reference to FIGS. 9E1 and/or 9E2. This helps user 702 quickly identify whether the orientation of keyboard augmentation region 918 is automatically defined by the orientation of a hardware keyboard or not. In some embodiments, keyboard augmentation region 918 is world locked when the orientation of keyboard augmentation region 918 is automatically defined by the orientation of recognized hardware keyboard 908. In such embodiments, as a user's changes his or her viewpoint, the orientation of keyboard augmentation region 918 within three-dimensional environment 706 stays the same, but the user's point of view of keyboard augmentation region 918 changes. At FIG. 9M2, HMD X700 detects movement 914 (e.g., shifting or rotation) of recognized hardware keyboard 908.

Any of the features, components, and/or parts, including the arrangements and configurations thereof shown in FIGS. 1B-1P can be included, either alone or in any combination, in HMD X700. For example, in some embodiments, HMD X700 includes any of the features, components, and/or parts of HMD 1-100, 1-200, 3-100, 6-100, 6-200, 6-300, 6-400, 11.1.1-100, and/or 11.1.2-100, either alone or in any combination. In some embodiments, display module X702 includes any of the features, components, and/or parts of display unit 1-102, display unit 1-202, display unit 1-306, display unit 1-406, display generation component 120, display screens 1-122a-b, first and second rear-facing display screens 1-322a, 1-322b, display 11.3.2-104, first and second display assemblies 1-120a, 1-120b, display assembly 1-320, display assembly 1-421, first and second display sub-assemblies 1-420a, 1-420b, display assembly 3-108, display assembly 11.3.2-204, first and second optical modules 11.1.1-104a and 11.1.1-104b, optical module 11.3.2-100, optical module 11.3.2-200, lenticular lens array 3-110, display region or area 6-232, and/or display/display region 6-334, either alone or in any combination. In some embodiments, HMD X700 includes a sensor that includes any of the features, components, and/or parts of any of sensors 190, sensors 306, image sensors 314, image sensors 404, sensor assembly 1-356, sensor assembly 1-456, sensor system 6-102, sensor system 6-202, sensors 6-203, sensor system 6-302, sensors 6-303, sensor system 6-402, and/or sensors 11.1.2-110a-f, either alone or in any combination. In some embodiments, HMD X700 includes one or more input devices, which include any of the features, components, and/or parts of any of first button 1-128, button 11.1.1-114, second button 1-132, and or dial or button 1-328, either alone or in any combination. In some embodiments, HMD X700 includes one or more audio output components (e.g., electronic component 1-112) for generating audio feedback (e.g., audio output), optionally generated based on detected events and/or user inputs detected by the HMD X700.

At FIG. 9N, recognized hardware keyboard 908 has moved to a different orientation in the physical environment. In response to detecting movement 914, device 700 displays an animation of keyboard augmentation region 918 following (and/or lagging behind) the movement of recognized hardware keyboard 908. In some embodiments, the animation includes a lazy follow behavior that follows the movement of recognized hardware keyboard 908, as described in greater detail herein. As depicted, device 700 displays keyboard augmentation region 918 in an orientation that is different from the orientation of keyboard augmentation region 918 of FIGS. 9M1 and/or 9M2 so as to follow recognized hardware keyboard 908.

At FIG. 9O, recognized hardware keyboard 908 has not moved and keyboard augmentation region 918 has caught up to the new orientation of recognized hardware keyboard 908. Specifically, device 700 displays keyboard augmentation region 918 centered on recognized hardware keyboard 908 while recognized hardware keyboard 908 is at the new orientation. Accordingly, the orientation of keyboard augmentation region 918 is tied to, at least in part, to the orientation of the recognized hardware keyboard 908.

At FIG. 9P, device 700 is no longer able to visually detect recognized hardware keyboard 908. As depicted, recognized hardware keyboard 908 is hidden under paper 920. As such, device 700 detects that recognized hardware keyboard 908 is not within a field of view of a camera of device 700 and/or a field of view of user 702. While device 700 detects that recognized hardware keyboard 908 is still connected to device 700 but is not visually detected, device 700 displays reposition indicator 732 while maintaining display of keyboard augmentation region 918. In some embodiments, while device 700 detects that recognized hardware keyboard 908 is still connected to device 700 but is not visually detected, device 700 displays keyboard 718. While displaying reposition indicator 732, device 700 detects input 950p (e.g., a touch input, an air gesture, a gaze, a mouse click, and/or a combination thereof) directed at reposition indicator 732 to move keyboard augmentation region 918.

At FIG. 9Q, in response to detecting input 950p, device 700 displays keyboard augmentation region 918 as having a new orientation in three-dimensional environment 706. Device 700 is still unable to visually detect recognized hardware keyboard 908 because paper 920 is still hiding recognized hardware keyboard 908. Additionally, device 700 still displays keyboard augmentation region 918 with reposition indicator 732. In some embodiments, keyboard augmentation region 918 is world locked (e.g., both prior and after moving).

At FIG. 9R, paper 920 has been removed and, as such, device 700 visually detects recognized hardware keyboard 908. In response to visually detecting recognized hardware keyboard 908, device 700 automatically updates the orientation of keyboard augmentation region 918 to be centered above recognized hardware keyboard 908. Additionally, device 700 stops displaying reposition indicator 732.

At FIG. 9S, device 700 detects that recognized hardware keyboard 908 is disconnected. In some embodiments, recognized hardware keyboard 908 has been turned off and/or is no longer in communication with device 700. In response to detecting that recognized hardware keyboard 908 is disconnected, device displays keyboard 718 with reposition indicator 732 (e.g., while maintaining the input session).

At FIG. 9T, device 700 detects that recognized hardware keyboard 908 is reconnected. In response to detecting that recognized hardware keyboard 908 is reconnected, device 700 displays keyboard augmentation region 918 centered above recognized hardware keyboard 908. Additionally, device 700 does not display reposition indicator 732. Returning briefly to FIG. 9S, in some embodiments, device 700 updates an orientation of keyboard 718 of FIG. 9S in response to detecting an input directed at reposition indicator 732, as described herein. In such embodiments, the orientation of keyboard 718 is displayed at an orientation that is off centered from recognized hardware keyboard 908. In such embodiments, in response to detecting that recognized hardware keyboard 908 is connected, as described at FIG. 9T, device 700 displays keyboard augmentation region 918 centered above recognized hardware keyboard 908 and without reposition indicator 732. In some embodiments, device 700 detects input 950t directed at keyboard mode affordance 744 and, in response, displays keyboard 718.

At FIG. 9T, in some embodiments, device 700 initiated an input session while unrecognized hardware keyboard 909 is connected to device 700, as described with respect to FIGS. 9C1 and/or 9C2. In such embodiments, device 700 displays keyboard 718. In such embodiments, while displaying keyboard 718, device 700 detects that recognized hardware keyboard 908 is connected (and/or detects an input via recognized hardware keyboard 908). In such embodiments, in response to detecting that recognized hardware keyboard 908 is connected (and/or a keystroke detected via recognized hardware keyboard 908), device 700 displays keyboard augmentation region 918 centered above recognized hardware keyboard 908, as depicted in FIG. 9T.

At FIG. 9U, device 700 detects that recognized hardware keyboard 908 is connected and that recognized hardware keyboard 908 is beyond a threshold distance (e.g., six inches, one foot, or two feet) from device 700 and/or user 702 (and/or that recognized hardware keyboard 908 is out of reach of user 702). For example, recognized hardware keyboard 908 is not on table surface 902 and/or is not in front of user 702. In response, device 700 displays keyboard 718 and reposition indicator 732. In some embodiments, device 700 detects recognized hardware keyboard 908 is connected but is not within a portion of a field of view of a camera of device 700 and/or is not within a field of view of user 702. In such embodiments, device 700 displays keyboard 718 and reposition indicator 732. In some embodiments, device 700 detects that recognized hardware keyboard 908 is connected and that recognized hardware keyboard 908 is beyond the threshold distance from device 700 and/or user 702 (and/or not within a portion of a field of view of a camera of device 700) upon a beginning an input session (e.g., as opposed to during an ongoing input session). In such embodiments, device 700 displays keyboard 718 and reposition indicator 732 as depicted in FIG. 9U.

At FIG. 9V, device 700 detects that recognized hardware keyboard 908 is still connected and is now within the threshold distance. For example, recognized hardware keyboard 908 is on table surface 902 and/or in front of user 702 (and/or is within reach of user 702). In response to detecting that recognized hardware keyboard 908 is connected and that recognized hardware keyboard 908 is within the threshold distance, device 700 displays keyboard augmentation region 918 without reposition indicator 732. In some embodiments, device 700 detects that recognized hardware keyboard 908 is connected but is not within a field of view of a camera of device 700 and/or is not within a field of view of user 702 and, in response, displays keyboard augmentation region 918 without reposition indicator 732. At FIG. 9V, device 700 detects input 950v (e.g., a touch input, an air gesture, a gaze, a mouse click, and/or a combination thereof) directed at close affordance 736 to close keyboard augmentation region 918.

At FIG. 9W, in response to detecting input 950v, device 700 displays animation 922 of closing keyboard augmentation region 918. Animation 922 includes sliding keyboard augmentation region 918 down until keyboard augmentation region 918 is no longer displayed, providing a visual effect that keyboard augmentation region 918 is sliding down behind recognized hardware keyboard 908. In some embodiments, animation 922 includes increasing a transparency of keyboard augmentation region 918, sliding keyboard augmentation region 918 in a different direction, and/or decreasing a size of keyboard augmentation region 918.

At FIG. 9X, device 700 has detected an input to change from keyboard augmentation region 918 to keyboard 718 while known keyboard 908 is detected. For example, in some embodiments, device 700 detects an input (e.g., a touch input, an air gesture, a gaze, a mouse click, and/or a combination thereof) directed at keyboard mode affordance 744 of keyboard augmentation region 918 of FIG. 9V. In response, device 700 displays keyboard 718 as depicted in FIG. 9X. At FIG. 9X, device 700 detects an input 950x (e.g., a touch input, an air gesture, a gaze, a mouse click, and/or a combination thereof) directed at close affordance 736 to close keyboard 718.

At FIG. 9Y, in response to detecting input 950x, device 700 closes keyboard 718 and ended the input session. Device 700 detects input 950y (e.g., a touch input, an air gesture, a gaze, a mouse click, and/or a combination thereof) directed at text field 712 to start a new input session.

At FIG. 9Z, device 700 displays a most recently used virtual keyboard (e.g., the virtual keyboard that was last displayed in the previous input session). For example, in response to detecting input 950y, device 700 displays keyboard 718 because keyboard 718 was the last virtual keyboard used in FIG. 9X. In some embodiments, device 700 displays keyboard 718 at a previously customized orientation, as described with respect to FIGS. 7G-7M. Notably, device 700 displays keyboard 718 instead of keyboard augmentation region 918 of FIG. 9V even though device 700 detects that recognized hardware keyboard 908 is connected and within a threshold distance (and/or within a field of view of a camera of device 700 and/or within the user's field of view). In some embodiments, device 700 displays keyboard augmentation region 918 when keyboard augmentation region 918 was the last virtual keyboard that was displayed in the previous input session. In some embodiments, in response to detecting an input to start an input session for a specific application and/or a specific text field, device 700 will override the display of keyboard 718 and/or keyboard augmentation region 918 and display a different virtual keyboard that is specific to the parameter of email application 710 and/or text field 712. For example, in some embodiments, in response to detecting a setting of email application 710 and/or text field 712 suppresses keyboard 718 and/or keyboard augmentation region 918, device 700 will display a different virtual keyboard.

At FIG. 9Z, in some embodiments, device 700 does not display a most recently used virtual keyboard. For example, if a user 702 has moved to a different room and/or beyond a threshold amount, device 700 will display keyboard 718 unless recognized hardware keyboard 908 is detected, as described with respect to FIGS. 9K-9L.

Additional descriptions regarding FIGS. 9A-9Z are provided below in reference to method 1000 and method 1100 described with respect to FIGS. 10 and 11.

FIG. 10 is a flow diagram of an exemplary method 1000 for displaying various types of virtual keyboards, in some embodiments. In some embodiments, method 1000 is performed at a (e.g., 700, X700, and/or computer system 101 in FIG. 1A) including a display generation component (e.g., a display controller, a touch-sensitive display system, a monitor, and/or a head mounted display system) (e.g., 701, X702, and/or display generation component 120 in FIGS. 1A, 3, and 4) (e.g., a heads-up display, a display, a touchscreen, a projector, etc.) and one or more input devices (e.g., 701, 703, and/or 125) (e.g., a touch-sensitive surface, a keyboard, a controller, a microphone, a motion sensor, a camera (e.g., an infrared camera, a depth camera, a visible light camera, and/or one or more cameras (e.g., a camera (e.g., color sensors, infrared sensors, and other depth-sensing cameras) that point downward at a user's hand or a camera that points forward from the user's head)), and/or a mouse) (in some embodiments, the one or more input devices are capable of detecting movement of a portion of a user's body (e.g., detect air gestures)). In some embodiments, method 1000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1000 are, optionally, combined and/or the order of some operations is, optionally, changed.

While a representation of a three-dimensional environment (e.g., 706) (in some embodiments, the three-dimensional environment is part of an extended reality environment, with the environment being presented via optical passthrough or virtual passthrough) is visible via the display generation component, the computer system detects (1002), via the one or more input devices, a request (e.g., 750a, 750c, 750j 750n, 750p, 750s, 950a, 905d, 950k, and/or 950y) (e.g., an air gesture and/or a speech command) to use a keyboard (e.g., a software keyboard similar to 718 and/or 918). In some embodiments, the request to use the keyboard corresponds to a request to display a representation of an application (e.g., a virtual application user interface) that includes a text field. In some embodiments, the request to use the keyboard corresponds to a selection of a text field. In some embodiments, the request to use the keyboard corresponds to a request to enter a text entry mode. In some embodiments, the request to use the keyboard corresponds to detecting an input on a physical key of a physical keyboard. In response to detecting the request to use the keyboard (1004) and in accordance with a determination that a first set of one or more criteria is satisfied (1006), wherein the first set of one or more criteria includes a requirement (e.g., a criterion) that a hardware keyboard is not available for input in order for the first set of one or more criteria to be met (e.g., 904 and/or 908 is not available for input), the computer system displays, via the display generation component, a first keyboard user interface (e.g., 718) that includes a plurality of character entry keys (e.g., 724) (e.g., alphanumeric text characters and/or punctuation mark characters) in a software keyboard (e.g., a virtual keyboard having one or more selectable interface objects). In some embodiments, the keyboard user interface includes a first set of one or more selectable interface objects for adding content to a text field (e.g., quick type, suggested text, and/or emojis) and/or for ceasing display (or displaying) of the plurality of character entry keys in a software keyboard. In some embodiments, the first set of one or more selectable interface objects are (or, in some embodiments, are not) displayed when the first set of one or more criteria is met. In response to detecting the request to use the keyboard (1004) and in accordance with a determination that a second set of criteria is satisfied (1008), wherein the second set of one or more criteria includes a requirement that a hardware keyboard is available for input in order for the second set of one or more criteria to be met, the computer system displays, via the display generation component, a second keyboard user interface (e.g., 918) (e.g., the same as or different from the first keyboard user interface) (e.g., the first keyboard user interface is the same as the second keyboard user interface but does not include the plurality of character entry keys) that does not include the plurality of character entry keys (e.g., in a first region and/or in a keyboard augmentation region). In some embodiments, the first set of one or more selectable interface objects are (or, in some embodiments, are not) displayed when the second set of one or more criteria is met. In some embodiments, the hardware keyboard is (or is not) available for input if the hardware keyboard is in a field-of-view of one or more cameras. In some embodiments, the hardware keyboard is (or is not) available for input if the hardware keyboard is in a field-of-view of a user of the computing device (e.g., an estimated and/or determined field of view of the user). In some embodiments, the respective keyboard is in the field of view of the one or more cameras but is not in the field of view of the user (e.g., based on which direction of the user's head is facing). In some embodiments, the hardware keyboard is (or is not) available for input when the hardware keyboard is (or is not) in communication (e.g., physically and/or wirelessly) with the computer system (e.g., the hardware keyboard is currently Bluetooth connected and communicating with the computer system). In some embodiments, the hardware keyboard is (or is not) available for input when the hardware keyboard is (or is not) detected as being a threshold distance from the computer system (e.g., the hardware keyboard is within the reach of the user). In some embodiments, the computer system modifies (adds, deletes, and/or changes) content (e.g., alphanumeric text, emojis, and/or images) in a text field in response to detecting input corresponding to a selection of one of the plurality of character entry keys and/or one of the first set of user interface graphical objects. In some embodiments, the plurality of character entry keys includes at least one user interface graphical object that is not included in the first set of user interface graphical objects (e.g., the plurality of character entry keys includes a key that is not available in the first set of user interface graphical objects) or vice versa (e.g., the first set of user interface objects includes a key that is not available in the plurality of character entry keys). In some embodiments, in accordance with a determination that the second set of criteria is satisfied, the computer system concurrently displays the first set of one or more user interface graphical objects with the plurality of character entry keys (e.g., the computer system displays both the keyboard augmentation region and the keyboard having keys for alphanumeric text). In some embodiments, the plurality of character entry keys and/or the first set of one or more user interface graphical objects are displayed in the respective keyboard position described with reference to FIGS. 7A-7T. Conditionally displaying a keyboard user interface that does (or does not) include the plurality of character entry keys in response to detecting the request to use a keyboard performs an operation when a set of conditions has been met without requiring further user input, reduces the number of inputs needed to perform an operation, and declutters the user interface.

In some embodiments, detecting the request to use the keyboard includes detecting to a selection (e.g., 750a, 750c, 750j 750n, 750p, 750s, 950a, 905d, 950k, and/or 950y) of a text entry field (e.g., 712) (e.g., an air gesture directed toward the text entry field, a user's gaze directed toward the text entry field, a speech input while gaze is directed toward the text entry field, a touch input directed toward the text entry field, and/or mouse click directed toward the text entry field) (e.g., a field for adding content and/or a field that allows a user to modify content) (in some embodiments, a text entry field within a user interface (e.g., a representation) of a respective application). Using a selection of a text entry field to conditionally display a keyboard user interface that does (or does not) include the plurality of character entry keys performs an operation when a set of conditions has been met without requiring further user input and reduces the number of inputs needed to perform an operation.

In some embodiments, the second set of one or more criteria includes a criterion that is satisfied when the hardware keyboard is a keyboard of a first type (e.g., recognized hardware keyboard 908) (e.g., a type that is identifiable by the computing system and/or a keyboard that has one or more characteristics (e.g., a physical appearance and/or a wireless signal) that are detectable or known to the computer system). In some embodiments, the second set of one or more criteria includes a criterion that is not met when the hardware keyboard is a keyboard of a second type (e.g., unrecognized hardware keyboard 904 and/or a different type of recognized hardware keyboard 908) (in some embodiments, the second set of one or more criteria are not met if a hardware keyboard of the second type is detected), different from the first type. In some embodiments, the second type of hardware keyboard is a type that is identifiable by the computing system and/or a type that has one or more characteristics (e.g., a physical appearance and/or a wireless signal) that are detectable or known (or, optionally, are not detectable or are not known) to the computer system. In some embodiments, the first type and/or the second type of hardware keyboard is based on a physical appearance (e.g., shape, size, and/or key location) of the hardware keyboard and/or a wireless signal (e.g., a signal including identifying information (e.g., a model number, a serial number, a brand, and/or driver information)) received from the hardware keyboard. Using different keyboard types as part of the criteria to conditionally display a keyboard user interface that does (or does not) include the plurality of character entry keys performs an operation when a set of conditions has been met without requiring further user input, reduces the number of inputs needed to perform an operation, and declutters the user interface.

In some embodiments, the first keyboard user interface includes a set of keys (e.g., 724) for entering a first set of alphabetical characters (in some embodiments, a full set of alphabetical characters (e.g., A-Z)). In some embodiments, the second keyboard user interface does not include the set of keys (e.g., 724) (e.g., any keys) for entering the first set of alphabetical characters. Conditionally display a keyboard user interface that includes a set of keys for entering a first set of alphabetical characters performs an operation when a set of conditions has been met without requiring further user input, reduces the number of inputs needed to perform an operation, and declutters the user interface.

In some embodiments, the second keyboard user interface that does not include the plurality of character entry keys includes one or more selectable interface objects (e.g., 727a-727c) (e.g., a set of one or more selectable interface objects) corresponding to (e.g., includes) suggested (e.g., proposed and/or recommended) (e.g., a set of one or more suggestions for) content (e.g., the suggested text associated with 727a-727c) (e.g., letter, word, image, and/or emoji). In some embodiments, the suggested content is suggested based on a context (e.g., time of day and/or location). In some embodiments, the suggested content is suggested based on associated content (e.g., content of a prior message or communication and/or content that is currently in the text entry field). In some embodiments, the suggested content is suggested based on one or more previously selected characters (e.g., a set of most recently selected character). In some embodiments, displaying the keyboard user interface that includes the plurality of character entry keys includes displaying the selectable interface object (e.g., a set of one or more selectable interface objects) corresponding to the suggested (e.g., proposed and/or recommended) (e.g., a set of one or more suggestions for) content (e.g., letter, word, image, and/or emoji). In some embodiments, selecting the selectable interface object corresponding to suggested content adds the suggested content to a text entry field. Displaying a selectable interface object corresponding to suggested content reduces the number of inputs needed to perform an operation (e.g., such as adding content to a text entry field).

In some embodiments, the second keyboard user interface that does not include the plurality of character entry keys includes a selectable interface object (e.g., 744) that, when selected, causes display of the first keyboard user interface that includes the plurality of character entry keys (e.g., as described at FIG. 9H). In some embodiments, displaying the first keyboard user interface that includes the plurality of character entry keys includes displaying the selectable interface object that, when selected, causes the display of second keyboard user interface. Displaying selectable interface object that, when selected, causes a display of the of the first keyboard user interface that includes the plurality of character entry keys allows a user to control whether the plurality of character entry keys are displayed, which declutters the user interface when the plurality of character entry keys are not needed.

In some embodiments, displaying the second keyboard user interface includes displaying the second keyboard user interface at a respective position (e.g., orientation of 908 as described in FIGS. 9M1 and/or 9M2) (e.g., a position within the representation of the three-dimensional environment) that is based on (e.g., dependent on and/or in accordance with a determination of) a position (e.g., within the representation of the three-dimensional environment) of a set of one or more hardware alphanumeric keys of the hardware keyboard that is available for input (e.g., orientation of 908 is centered relative to text character keys of 908 as described in FIGS. 9M1 and/or 9M2). In some embodiments, the respective position is within a threshold distance (e.g., 1 inch, 2 inches, 100 pixels, and/or 200 pixels) of a respective portion (e.g., a left side, a right side, and/or a center) of the set of one or more hardware alphanumeric keys. In some embodiments, the respective position is offset in a vertical direction. In some embodiments, displaying the first keyboard user interface object is displayed independent of the position of the set of one or more hardware alphanumeric keys. Displaying the second keyboard user interface at a respective position that is based on a position of a set of one or more hardware alphanumeric keys performs an operation when a set of conditions has been met without requiring further user input and reduces the number of inputs needed to perform an operation.

In some embodiments, displaying the second keyboard user interface includes: in accordance with a determination that the hardware keyboard that is available for input is at a first position (e.g., the position of 908 in FIGS. 9L-9O) within the three-dimensional environment, displaying the second keyboard user interface at a first interface position (e.g., the position of 918 in FIGS. 9L-9O) within the three-dimensional environment (e.g., a position that aligns the second user interface with a respective edge of the hardware keyboard). In some embodiments, the second keyboard user interface is displayed within a threshold distance (e.g., 1 inch, 2 inches, 100 pixels, and/or 200 pixels) from the hardware keyboard (e.g., the physical hardware keyboard and/or a representation of physical hardware keyboard). In some embodiments, displaying the second keyboard user interface includes: in accordance with a determination that the hardware keyboard that is available for input is at a second position (e.g., the position of 908 in FIGS. 9L-9O) within the three-dimensional environment, different from the first position, displaying the second keyboard user interface at a second interface position (e.g., the position of 918 in FIGS. 9L-9O) within the three-dimensional environment, wherein the second interface position within the three-dimensional environment is different from the first interface position within the three-dimensional environment (e.g., a position that aligns the second user interface with a respective edge of the hardware keyboard). Conditionally displaying the second keyboard user interface dependent on a position of the hardware keyboard performs an operation when a set of conditions has been met without requiring further user input and reduces the number of inputs needed to perform an operation.

In some embodiments, displaying the second keyboard user interface at the first interface position within the three-dimensional environment includes initially displaying the second keyboard user interface at the first interface position within the three-dimensional environment (e.g., the position of 918 in FIG. 9L is an initial position), in response to the detecting the request to use the keyboard. In some embodiments, displaying the second keyboard user interface at the second interface position within the three-dimensional environment includes initially displaying the second keyboard user interface at the second interface position (e.g., the position of 918 in FIG. 9O is an initial position) within the three-dimensional environment, in response to the detecting the request to use the keyboard. Initially displaying the second keyboard user interface dependent at the first interface position or the second interface position reduces the number of inputs needed to perform an operation.

In some embodiments, while displaying the second keyboard user interface at a third interface position (e.g., the position of 918 in FIG. 9Q) within the three-dimensional environment and while a hardware keyboard of a first type is not detected (e.g., 918 is hidden by 920 in FIGS. 9P-9Q) (in some embodiments, is not detected as being available for input), the computer system detects the hardware keyboard of the first type within the representation of the three-dimensional environment (in some embodiments, detecting within a field-of-view of one or more cameras in communication with the computer system). In response to detecting the hardware keyboard of the first type within the representation of the three-dimensional environment, the computer system shifts display (in some embodiments, an animated shifting of display) of the second keyboard user interface to a fourth interface position (e.g., position of 918 in FIG. 9R) that is based on a position of the hardware keyboard of the first type within the representation of the three-dimensional environment (e.g., as described in FIG. 9R), wherein the fourth interface position is different from the third interface position. Detecting a hardware keyboard of the first type within the representation of the three-dimensional environment while displaying the second keyboard user interface at a third interface position within the three-dimensional environment and while a hardware keyboard of a first type is not detected and, in response, shifting display of the second keyboard user interface to a fourth interface position that is based on a position of the hardware keyboard of the first type within the representation of the three-dimensional environment performs an operation when a set of conditions has been met without requiring further user input and reduces the number of inputs needed to perform an operation.

In some embodiments, while displaying the second keyboard user interface and in accordance with a determination that the second keyboard user interface is displayed at a position (e.g., as described in FIG. 9O) that is based on (e.g., aligns with, dependent on, and/or in accordance with a determination of) a first position of the hardware keyboard within the representation of the three-dimensional environment, the computer system forgoes display (e.g., display within the second keyboard user interface) of a selectable user interface object that, when selected, causes a position at which the second keyboard user interface is displayed to change (e.g., 732 is not displayed in FIG. 9O). In some embodiments, in accordance with a determination that the second user keyboard user interface is not displayed at a position that is based on (e.g., aligns with) a respective position of the hardware keyboard within the representation of the three-dimensional environment (e.g., the second keyboard user interface is not currently aligned with a hardware keyboard), the second keyboard user interface includes the selectable user interface object that, when selected, causes a position at which the second keyboard user interface is displayed to change. Conditionally forgoing display of a selectable interface object that, when selected, causes a position at which the second keyboard user interface is displayed to change when the second keyboard user interface is displayed at a position that is based on a first position of the hardware keyboard performs an operation when a set of conditions has been met without requiring further user input and reduces the number of inputs needed to perform an operation.

In some embodiments, while displaying the second keyboard user interface and in accordance with a determination that the second keyboard user interface is displayed at a position that is not based on (e.g., does not align with) a second position of the hardware keyboard within the representation of the three-dimensional environment (e.g., 918 is not based on a position of 908 in FIGS. 9P-9Q), the computer system detects, via the one or more input devices, a request (e.g., 950p) (e.g., including a set of one or more inputs (e.g., an air gesture, a user's gaze, a speech input, a touch input, and/or mouse click)) to modify a position (e.g., position within the three-dimensional environment) (e.g., identifiable by a coordinate (e.g., x, y, and z)) of the second keyboard user interface. In response to detecting the request to modify a position of the second keyboard user interface, modifying the position of the second keyboard user interface from a first keyboard position to a second keyboard position different from the first keyboard position (e.g., 918 has moved in FIGS. 9P-9Q) (e.g., while the hardware keyboard maintains the second position) (e.g., the second keyboard user interface moves independently of the hardware keyboard). In some embodiments, the position of second keyboard user interface is modified in a direction that is based on a direction (e.g., detected direction) of an input of the request to modify the position. In some embodiments, the position of second keyboard user interface is modified by a magnitude that is based on a magnitude (e.g., detected magnitude) of an input of the request to modify the position. In some embodiments, the position of the second keyboard user interface cannot be moved in accordance with a determination that the second keyboard user interface is displayed at a position that is based on (e.g., does not align with) the second position of the hardware keyboard within the representation of the three-dimensional environment. Modifying the position of the second keyboard user interface from a first keyboard position to a second keyboard position different from the first keyboard position in response to detecting the request that is detected when the second keyboard user interface is displayed at a position that is not based on a second position of the hardware keyboard allows a user to reposition of the second keyboard user interface and it provides visual feedback that an input has been detected.

In some embodiments, after modifying the position of the second keyboard user interface, the second keyboard user interface is environment-locked (e.g., 918 is world-locked). Environmentally locking the second keyboard user interface after modifying the position of the second keyboard user interface improves the user interface because the position of the second keyboard user interface is customizable and does not change in response to a movement of the computer system.

In some embodiments, the second keyboard user interface has a third position (e.g., position of 918 in FIGS. 9M1 and/or 9M2) (e.g., displayed position) (e.g., a relative to hardware keyboard). In some embodiments, in accordance with a determination that the second keyboard user interface is displayed at a position that is based on (e.g., aligns with and/or in accordance with) a third position of the hardware keyboard within the representation of the three-dimensional environment, the computer system detects, via one or more input devices, a change in a point of view (e.g., perspective and/or viewpoint) of a user (e.g., user's view of 918 in FIGS. 9M1 and/or 9M2) of the second keyboard user interface (e.g., a user moves so as to have a different point of view of the second keyboard interface). In response to detecting the change in point of view of the user of the second keyboard user interface, modifying the third position (e.g., displayed position) (e.g., a displayed position of 918 via display 701 of device 700 and/or display X702 of HMD X700) of the second keyboard user interface in the three-dimensional environment so that the second keyboard user interface continues to be displayed based on a position of the hardware keyboard within the point of view of the user of the second keyboard user interface (e.g., user's view of 918 in FIGS. 9M1 and/or 9M2 changes while the position of 918 is still based on the position of 908). In some embodiments, in accordance with a determination that the respective change in point of view of the user corresponds to a first amount of change, the computer system modifies the third position of the second keyboard user interface by a first amount. In some embodiments, in accordance with a determination that the respective change in point of view of view of the user corresponds to a second amount of change different from the first amount of change, the computer system modifies the third position of the second keyboard user interface by a second amount that is different from the first amount. Modifying the third keyboard position of the second keyboard user interface in the three-dimensional environment so that the second keyboard user interface continues to be displayed based on a position of the hardware keyboard within the point of view of the user of the second keyboard user interface in response to detecting a change in a point of view of a user of the second keyboard user interface when the second keyboard user interface is displayed at a position that is based on a third position of the hardware keyboard performs an operation when a set of conditions has been met without requiring further user input, reduces the number of user inputs to change the first respective position of the second keyboard, and improves a user's view of the second keyboard user interface in the three-dimensional environment.

In some embodiments, the second keyboard user interface has a fourth respective position (e.g., position of 918 in FIGS. 9M1 and/or 9M2) (e.g., the same or different from the first respective position). In some embodiments, in accordance with a determination that the second keyboard user interface is displayed at a position that is based on (e.g., aligns with and/or in accordance with) a fourth position (e.g., the same as or different from the third position) of the hardware keyboard within the representation of the three-dimensional environment (e.g., as described in FIGS. 9M1 and/or 9M2), the computer system detects, via one or more input devices, a change in position (e.g., change in position in response to 914) (e.g., up, down, left, and/or right) of the hardware keyboard from the fourth position to a fifth position (e.g., the hardware keyboard is moved within the three-dimensional environment), different from the fourth position (e.g., position of 908 in FIGS. 9N and 9O) (e.g., the hardware keyboard is moved to a different position). In response to detecting the change in position of the hardware keyboard, modifying the fourth respective position (e.g., displayed position) of the second keyboard user interface in the three-dimensional environment so that the second keyboard user interface continues to be displayed based on a position of the hardware keyboard (e.g., position of 918 in FIGS. 9N and 9O) (e.g., the second keyboard user interface moves when the hardware keyboard moves). In some embodiments, in response to detecting the change in position of the hardware keyboard and in accordance with a determination that the second keyboard user interface is displayed at a position that is not based on a position of the hardware keyboard within the representation of the three-dimensional environment, the computer system forgoes modifying the fourth respective position (e.g., displayed position) of the second keyboard user interface in the three-dimensional environment. In some embodiments, the keyboard user interface moving based on the position of the keyboard occurs based on a determination that the amount (e.g., speed and/or distance) of movement of the keyboard is below a movement threshold, and in response to detecting movement of the keyboard if the keyboard has been moved more than the threshold amount (e.g., speed and/or distance), the keyboard user interface ceases to be displayed either temporarily (e.g., and the keyboard user interface is redisplayed when the movement stops or slows down below a redisplay movement threshold speed) or permanently (e.g., and the keyboard user interface is not redisplayed when the movement stops or slows down below a redisplay movement threshold speed). Detecting a change in position of the hardware keyboard and, in response, modifying the fourth respective position of the second keyboard user interface in the three-dimensional environment so that the second keyboard user interface continues to be displayed based on a position of the hardware keyboard when the second keyboard user interface is displayed at a position that is based on a fourth position of the hardware keyboard performs an operation when a set of conditions has been met without requiring further user input and improves how the second keyboard user interface is positioned in the three-dimensional environment.

In some embodiments, modifying the fourth respective position of the second keyboard user interface exhibits lazy follow behavior relative to the change in position of the hardware keyboard from the fourth position to the fifth position (e.g., as described in FIGS. 9N and 9O) (e.g., there is an intentional delay in moving the second keyboard user interface when following the hardware keyboard). Modifying second respective position of the second keyboard user interface to exhibit lazy follow behavior after detecting the change in position of the hardware keyboard provides visual feedback that the hardware keyboard has moved and improves how virtual object track with physical objects.

In some embodiments, the second set of one or more criteria includes a requirement that the hardware keyboard is within a threshold distance of a body part of the user (e.g., 904 and/or 908 is within a threshold distance of a hand, head, and/or eyes of user 702) (e.g., within a threshold distance of the computer system (e.g., when the computer system is worn by the user)). In some embodiments, in accordance with a determination that the hardware keyboard is within the threshold distance of a body part of the user (e.g., computer system), the computer system displays the second keyboard user interface that does not include the plurality of character entry keys is displayed. In some embodiments, in accordance with a determination that the hardware keyboard is not within the threshold distance of the body part of the user (e.g., computer system), the computer system displays the first keyboard user interface that includes the plurality of character entry keys in the software keyboard. Conditionally displaying the second keyboard user interface based on whether the hardware keyboard is within a threshold distance of a body part of the user performs an operation when a set of conditions has been met without requiring further user input, reduces the number of inputs needed to perform an operation, and declutters the user interface.

In some embodiments, in response to detecting the request to use the keyboard and in accordance with a determination that a third set of one or more criteria is satisfied, wherein the third set of one or more criteria includes a criterion that is satisfied when an application (e.g., the email application of FIGS. 9A-9Z) (e.g., a currently active application and/or an application that includes a text field that the request is interacting with) associated with the request to use the keyboard is configured (e.g., via a settings menu and/or via an API) to suppress (e.g., withhold and/or forgo) display of the first keyboard user interface and the second keyboard user interface (e.g., a setting of the email application of FIGS. 9A-9Z causes 718 and/or 918 to be suppressed) (in some embodiments, the application is configured to cause display of a third keyboard user interface (e.g., an application specific keyboard and/or a non-keyboard interface (e.g., a selection menu or a set of predetermined options)) that is different than the first and second keyboard user interfaces), the computer system forgoes display of the first keyboard user interface and the second keyboard user interface (e.g., 718 and/or 918 are not displayed). In some embodiments, in response to detecting the request to use the keyboard and in accordance with a determination that the third set of one or more criteria is not satisfied, displaying the first keyboard interface or the second keyboard interface. Conditionally suppressing display of the first keyboard user interface and the second keyboard user interface when an application associated with the request to use the keyboard is configured suppress the first keyboard user interface and the second keyboard user interface performs an operation when a set of conditions has been met without requiring further user input, reduces the number of inputs needed to perform an operation, and declutters the user interface.

In some embodiments, displaying the first keyboard user interface includes displaying the first keyboard user interface as an environment-locked object (e.g., 718 and/or 918 are world locked). In some embodiments, displaying second first keyboard user interface includes displaying the second keyboard user interface as an environment-locked object (e.g., 718 and/or 918 are world locked). In some embodiments, the first keyboard user interface and the second keyboard user interface are world locked. Displaying the first keyboard user interface as an environment-locked object and displaying the second keyboard user interface as an environment-locked object improves the user interface because it provides a sense that the first keyboard user interface and the second keyboard user interface are world locked in the three-dimensional environment.

In some embodiments, the first keyboard user interface includes a first graphical object (e.g., selectable interface object, a suggested text option, a button to switch between the two keyboard user interfaces) that is included in the second keyboard user interface (e.g., 718 includes a button that is included in 918). Including a graphical object in the both the first keyboard user interface and the second keyboard user interface provides access to a common graphical object regardless of whether the first keyboard user interface or the second keyboard user interface is displayed.

In some embodiments, after ceasing to display a respective keyboard user interface that was displayed in response to the request to use the keyboard (e.g., the first keyboard user interface and/or the second keyboard user interface), the computer system detects, via the one or more input devices, a third request to use a keyboard (e.g., 950y of FIG. 9Y). In response to detecting the third request to use the keyboard, in accordance with a determination that a body part of the user has not moved more than a threshold amount (e.g., a body part of user 702 has not moved) (e.g., a threshold amount of distance and/or threshold amount of rotation) (e.g., of distance, such as 1 inch, 6 inches, and/or two feet) (e.g., of an angle, such as 5 degrees, 20 degrees, 90 degrees) (e.g., since the last text entry session and/or since a time corresponding to when a keyboard user interface was closed), and in accordance with a determination that the first keyboard user interface corresponds to a most recently displayed (in some embodiments, used) keyboard user interface (e.g., 718 is the most recently displayed software keyboard as described with respect to FIG. 9Z) (e.g., last used keyboard user interface and/or a keyboard user interface of the most recent text entry input session), the computer system displays, via the display generation component, the first keyboard user interface. In response to detecting the third request to use the keyboard, in accordance with a determination that the body part of the user has not moved more than the threshold amount, and in accordance with a determination that the second keyboard user interface corresponds to the most recently displayed keyboard user interface (e.g., 918 is the most recently displayed software keyboard), the computer system displays, via the display generation component, the second keyboard user interface. Conditionally displaying the first or second keyboard user interface depending on the most recently displayed keyboard and depending on whether a body part of the user has moved more than a threshold amount performs an operation when a set of conditions has been met without requiring further user input and reduces the number of inputs needed to perform an operation.

In some embodiments, in response to detecting the third request to use the keyboard and in accordance with a determination that the body part of the user (e.g., when the computer system (e.g., when the computer system is worn on the body part of the user that moves)) has moved more than the threshold amount (e.g., user 702 has moved to a different room) and the hardware keyboard (e.g., a first type hardware keyboard) is not available for input, the computer system displays, via the display generation component, the first keyboard user interface (e.g., device 700 and/or HMD X700 displays 718 if recognized hardware keyboard 908 is not detected, as described with respect to FIGS. 9K-9L, and 9Z). In some embodiments, in accordance with a determination that the body part of the user (e.g., when the computer system (e.g., when the computer system is worn on the body part of the user that moves)) has moved more than the threshold amount and the hardware keyboard is available for input (and/or that a second type of hardware keyboard, different from the first type of hardware keyboard, is available), the computer system displays the second keyboard user interface. In some embodiments, the hardware keyboard is available for input when the hardware keyboard is in communication with the computer system and is in a field of view of one or more cameras (and/or field of view of the user). Conditionally displaying the first user interface when the body part of the user has moved more than a threshold amount of movement performs an operation when a set of conditions has been met without requiring further user input and reduces the number of inputs needed to perform an operation.

In some embodiments, the computer system detects, via the one or more input devices, a key selection input (e.g., input on one of character buttons 724, input on one of suggested text buttons 727a-727c, and/or an input on one of keys of 904 or 908) (e.g., a keystroke or an input on a respective key), wherein the key selection input is an input detected on the first keyboard user interface (e.g., input on one of character buttons 724), an input detected on the second keyboard user interface (e.g., input on one of suggested text buttons 727a-727c of 918), or an input detected via the hardware keyboard (e.g., input on one of keys of 904 or 908). In response to detecting the key selection input, the computer system displays, via the display generation component, content (e.g., 906 of FIGS. 9E1, 9E2, and 9F) (e.g., alphanumeric text and/or punctuation marks) corresponding to the key selection input in a text entry field (e.g., 712). In some embodiments, the hardware keyboard includes a set of one or more physical keys (e.g., physical keys on a physical keyboard) corresponding the content. Displaying content in a text entry field where the content corresponds to the key selection input of the first keyboard user interface, the second keyboard user interface, or a hardware keyboard provides visual feedback that user input was detected.

In some embodiments, displaying, via the display generation component, the first keyboard user interface that includes the plurality of character entry keys (e.g., alphanumeric text characters and/or punctuation mark characters) in the software keyboard includes: in accordance with a determination that a first set of keyboard placement criteria is satisfied, wherein the first set of keyboard placement criteria includes a first criterion that is satisfied when a representation of an application (e.g., 710) has a first pose (e.g., 710 has an orientation described with respect to FIG. 7A; and/or the orientation of 710 described with respect to FIGS. 7A-7T) in a representation of a three-dimensional environment (e.g., 706) (e.g., as described with reference to FIGS. 7A-7T), displaying, via the display generation component, the first keyboard user interface at a second keyboard position in the representation of the three-dimensional environment (e.g., 718 has an orientation described with respect to FIG. 7B; and/or the orientation of 718 described with respect to FIGS. 7A-7T) (e.g., a position as described with reference to FIGS. 7A-7T). In some embodiments, displaying, via the display generation component, the first keyboard user interface that includes the plurality of character entry keys (e.g., alphanumeric text characters and/or punctuation mark characters) in the software keyboard includes: in accordance with a determination that a second set of keyboard placement criteria is satisfied, wherein the second set of keyboard placement criteria includes a second criterion that is satisfied when the representation of the application has a second pose (e.g., 718 has an orientation described with respect to FIG. 7C; and/or the orientation of 718 described with respect to FIGS. 7A-7T) in the representation of the three-dimensional environment (e.g., 706) (e.g., as described with reference to FIGS. 7A-7T), wherein the second pose is different from the first pose, displaying, via the display generation component, the first keyboard user interface at a third keyboard position (e.g., 718 has an orientation described with respect to FIG. 7D; and/or the orientation of 718 described with respect to FIGS. 7A-7T), different from the second keyboard position, in the representation of the three-dimensional environment (e.g., a position as described with reference to FIGS. 7A-7T). Conditionally displaying the first keyboard user interface based on criteria including a pose of the representation of the respective application in the three-dimensional environment performs an operation when a set of conditions has been met without requiring further user input and improves how the keyboard user interface is displayed in three-dimensional environment and reduces the possibility of an obstructed view of the keyboard user interface

In some embodiments, displaying, via the display generation component, the second keyboard user interface (e.g., the same as or different from the first keyboard user interface) (e.g., the first keyboard user interface is the same as the second keyboard user interface but does not include the plurality of character entry keys) that does not include the plurality of character entry keys includes: in accordance with a determination that the first set of keyboard placement criteria is satisfied, displaying, via the display generation component, the second keyboard user interface at a fourth keyboard position (e.g., 918 has a similar orientation as the orientation of 718 that is described with respect to FIG. 7B; and/or the orientation of 718 described with respect to FIGS. 7A-7T) (e.g., a position as described with reference to FIGS. 7A-7T) in the representation of the three-dimensional environment (e.g., a position as described with reference to FIGS. 7A-7T). In some embodiments, displaying, via the display generation component, the second keyboard user interface (e.g., the same as or different from the first keyboard user interface) (e.g., the first keyboard user interface is the same as the second keyboard user interface but does not include the plurality of character entry keys) that does not include the plurality of character entry keys includes: in accordance with a determination that the second set of keyboard placement criteria is satisfied, displaying, via the display generation component, the second keyboard user interface at a fifth keyboard position (e.g., 918 has a similar orientation as the orientation of 718 that is described with respect to FIG. 7D; and/or the orientation of 718 described with respect to FIGS. 7A-7T) (e.g., a position as described with reference to FIGS. 7A-7T), different from the fourth keyboard position, in the representation of the three-dimensional environment (e.g., a position as described with reference to FIGS. 7A-7T). Conditionally displaying second keyboard user interface based on criteria including a pose of the representation of the respective application in the three-dimensional environment performs an operation when a set of conditions has been met without requiring further user input and improves how the keyboard user interface is displayed in three-dimensional environment and reduces the possibility of an obstructed view of the keyboard user interface.

In some embodiments, while the first keyboard user interface is displayed, the computer system detects an event (e.g., disconnection and/or reconnection of a hardware keyboard as described with respect to FIGS. 9G-9H and 9S-9T; and/or moved beyond or moved within a threshold distance as described with respect to FIGS. 9I-9J and 9U-9V) associated with (e.g., triggered by and/or related to) a hardware keyboard (e.g., 904 and/or 908) (e.g., a physical keyboard and/or non-virtual keyboard). In response to detecting the event associated with the hardware keyboard: the computer system displays, via the display generation component, the second keyboard user interface (e.g., 918 is displayed in FIGS. 9H, 9J, 9T, and 9V), and ceases display of the first keyboard user interface (e.g., 718 is not displayed in FIGS. 9H, 9J, 9T, and 9V) (e.g., as described in further detail with respect to FIGS. 9A-9Z). Detecting an event associated with a hardware keyboard while a first keyboard user interface is displayed and, in response, displaying a second keyboard user interface different from the first keyboard user interface and ceasing to display of the first user interface reduces the number of user inputs to change between keyboard user interfaces, declutters the user interface, and provides visual feedback that an event associated with a hardware keyboard was detected.

In some embodiments, aspects/operations of methods 800, 1000, 1100, and 1300 may be interchanged, substituted, and/or added between these methods. For example, methods 800, 1100, and 1300 include features of method 1000 related to displaying various types of virtual keyboards. For example, methods 800, 1100, and 1300 include features related to displaying various types of keyboards based on different criteria associated with a hardware keyboard (e.g., the hardware keyboard being available for input, which type of hardware keyboard is available for input, whether a hardware keyboard is connected and/or within a threshold distance). For brevity, these details are not repeated here.

FIG. 11 is a flow diagram of an exemplary method 1100 for switching between virtual keyboards, in some embodiments. In some embodiments, method 1100 is performed at a computer system (e.g., 700, X700, and/or computer system 101 in FIG. 1A) including a display generation component (e.g., a display controller, a touch-sensitive display system, a monitor, and/or a head mounted display system) (e.g., 701, X702, and/or display generation component 120 in FIGS. 1A, 3, and 4) (e.g., a heads-up display, a display, a touchscreen, a projector, etc.) and, optionally, one or more input devices (e.g., 701, 703, and/or 125) (e.g., a touch-sensitive surface, a keyboard, a controller, a microphone, a motion sensor, a camera (e.g., an infrared camera, a depth camera, a visible light camera, and/or one or more cameras (e.g., a camera (e.g., color sensors, infrared sensors, and other depth-sensing cameras) that point downward at a user's hand or a camera that points forward from the user's head)), and/or a mouse) (in some embodiments, the one or more input devices are capable of detecting movement of a portion of a user's body (e.g., detect air gestures)). In some embodiments, method 1100 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1100 are, optionally, combined and/or the order of some operations is, optionally, changed.

The computer system displays (1102), via the display generation component, a first keyboard user interface (e.g., 718 or 918) (e.g., a user interface having one or more selectable interface objects that, when selected, adds content into a text entry field, a user interface including one or more selectable interface objects that, when selected, adds suggested content into a text entry field, a user interface having a plurality of character entry keys that, when selected, adds a character to a text entry field, and/or a virtual keyboard having one or more selectable interface objects) in an augmented reality environment. In some embodiments, instead of being displayed in an augmented reality environment, the first keyboard user interface is displayed in an extended reality environment or a virtual reality environment. While displaying the first keyboard user interface in the augmented reality environment, the computer system detects (1104) an event associated with (e.g., disconnection and/or reconnection of a hardware keyboard as described with respect to FIGS. 9G-9H and 9S-9T; and/or moved beyond or moved within a threshold distance as described with respect to FIGS. 9I-9J and 9U-9V) (e.g., triggered by and/or related to) a first hardware keyboard (e.g., 904 and/or 908) (e.g., a physical keyboard and/or non-virtual keyboard) (e.g., a hardware keyboard that is in communication with the computer system). In response to detecting the event associated with the first hardware keyboard (1106), the computer system displays (1108), via the display generation component, a second keyboard user interface (e.g., 718 or 918) (e.g., a user interface having one or more selectable interface objects that, when selected, adds content into a text entry field, a user interface including one or more selectable interface objects that, when selected, adds suggested content into a text entry field, a user interface having a plurality of character entry keys that, when selected, adds a character to a text entry field, and/or a virtual keyboard having one or more selectable interface objects), different from the first keyboard user interface, in the augmented reality environment. In response to detecting the event associated with the first hardware keyboard (1106), the computer system ceases (1110) display of the first keyboard user interface (e.g., 718 or 918) (e.g., the second keyboard interface replaces the first keyboard user interface). In some embodiments, the first keyboard user interface is an expanded version of the second keyboard user interface or vice versa. In some embodiments, the first keyboard user interface includes at least one keyboard interface object not included in the second keyboard user interface or vice versa. In some embodiments, the first keyboard user interface includes at least one keyboard interface object that is included in the second keyboard user interface or vice versa. Detecting an event associated with a first hardware keyboard while a first keyboard user interface is displayed and, in response, displaying a second keyboard user interface different from the first keyboard user interface and ceasing to display of the first user interface reduces the number of user inputs to change between keyboard user interfaces, declutters the user interface, and provides visual feedback that an event associated with a hardware keyboard was detected.

In some embodiments, displaying the first keyboard user interface includes displaying the first keyboard user interface at a first keyboard position (e.g., a position within the representation of the three-dimensional environment) that is based on (e.g., aligns with, dependent on, and/or in accordance with a determination of) a position (e.g., within the augmented reality environment) of the first hardware keyboard (e.g., 918 is displayed at a position that is based on 908). In some embodiments, displaying the second keyboard user interface includes displaying the second keyboard user interface at a second keyboard position (e.g., the same and/or different as the first keyboard position) (e.g., a position within the augmented reality environment) that is not based on (e.g., not dependent on and/or in accordance with a determination of) a position (e.g., within the augmented reality environment) of the first hardware keyboard (e.g., 718 is not displayed at a position that is based on 908). In some embodiments, the second keyboard user interface includes a plurality of character entry keys (e.g., alphanumeric text characters and/or punctuation mark characters) of a software keyboard that is not included in the first keyboard user interface. Detecting an event associated with a first hardware keyboard while displaying the first keyboard user interface at a first keyboard position that is based on a position of the first hardware keyboard and, in response, displaying the second keyboard user interface that is not based on a position of the hardware keyboard reduces the number of user inputs to change between keyboard user interfaces and provides visual feedback that an event associated with a hardware keyboard was detected.

In some embodiments, displaying the first keyboard user interface at the first keyboard position that is based on the position of the first hardware keyboard the first keyboard user interface includes locking (e.g., restricting movement and/or limiting movement) the first keyboard user interface to a position of the first hardware keyboard (e.g., 918 cannot be moved away from 908). In some embodiments, while displaying the first keyboard user interface at the first keyboard position, the computer system detects, via one or more input devices (e.g., a camera and/or a motion sensor), a change in position of the first hardware keyboard from a first hardware keyboard position to a second hardware keyboard position (e.g., as depicted in FIGS. 9M1-9O). In response to detecting the change in position of the first hardware keyboard: the computer shifts display (in some embodiments, an animated shifting of display) of the first keyboard user interface to a third keyboard position that is based on the second hardware keyboard position within augmented reality environment (e.g., as depicted in FIGS. 9M1-9O) (e.g., the first keyboard user interface moves when the first hardware keyboard moves). In some embodiments, in response to detecting the change in position of the first hardware keyboard and in accordance with a determination that the first keyboard user interface is displayed at a position that is not based on a position of the first hardware keyboard within the augmented reality environment, the computer system forgoes shifting display of the first keyboard user interface to the third keyboard position that is based on the second hardware keyboard position within the augmented reality environment. Shifting display of the first keyboard user interface to a position that is based on the position of the first hardware keyboard of the first type in response detecting the change in position of the first hardware keyboard performs an operation when a set of conditions has been met without requiring further user input and improves how the first keyboard user interface is positioned in the three-dimensional environment.

In some embodiments, displaying the first keyboard user interface includes progressively (e.g., gradually and/or incrementally over time) revealing portions of the first keyboard user interface extending from (e.g., adjacent and/or within a threshold distance of) a side (e.g., an edge (e.g., top, bottom, left, and/or right)) of the first hardware keyboard until the first keyboard user interface is completely displayed (e.g., as described with respect to FIGS. 9L-9M2). In some embodiments, the first keyboard user interface is progressively revealed as portions are shifted in a first direction (e.g., up, down, left, and/or right) relative to the side of the first hardware keyboard. Progressively revealing portions of the first keyboard user interface extending from a side of the first hardware keyboard until the first keyboard user interface is completely displayed improves how the first keyboard user interface is displayed in a three-dimensional environment when a hardware keyboard is present and provides visual feedback that a request was detected.

In some embodiments, while displaying the first keyboard user interface, the computer system detects, via the one or more input devices, a request (e.g., 950s and/or 950v) (e.g., an air gesture, a user's gaze, a speech input, a touch input, and/or mouse click) to dismiss (e.g., not use and/or close) a keyboard. In some embodiments, the request to dismiss the keyboard corresponds to a request to stop displaying a representation of an application (e.g., a virtual application user interface) that includes a text field. In some embodiments, the request to dismiss the keyboard corresponds to a termination of a text entry session. In some embodiments, the request to dismiss the keyboard corresponds to a request to exit a text entry mode. In response to detecting the request to dismiss the keyboard, the computer system progressively (e.g., gradually and/or incrementally over time) ceases display of portions of the first keyboard user interface adjacent (e.g., next to and/or within a threshold distance of) to the side (e.g., an edge (e.g., top, bottom, left, and/or right)) of the first hardware keyboard until the first keyboard user interface is not displayed (e.g., as described with respect FIGS. 9V-9W) (e.g., the first keyboard user interface gradually disappears as if it were sliding into and/or behind the first hardware keyboard). In some embodiments, the first keyboard user interface is progressively ceases to be displayed as portions are shifted in a second direction (e.g., up, down, left, and/or right), different from the first direction, relative to the side of the first hardware keyboard. Detecting a request to dismiss the keyboard and, in response, progressively ceasing display of portions of the first keyboard user interface adjacent to the side of the first hardware keyboard until the first keyboard user interface is not displayed improves how and where the first keyboard user interface ceases to be displayed in a three-dimensional environment and provides visual feedback that input was detected.

In some embodiments, while displaying the second keyboard user interface at the second keyboard position, the computer system detects, via the one or more input devices, a request to move the second keyboard user interface (e.g., 950p). In response to detecting the request to move the second keyboard user interface, the computer system moves the second keyboard user interface to a new keyboard position (e.g., the position of 918 in FIG. 9O as compared to position of 918 in FIG. 9P) (e.g., based on a direction and/or magnitude of movement of an input of the request to move the second keyboard user interface) that is not based on the position of the first hardware keyboard. In some embodiments, a position of the second keyboard user interface is independent of the position of the first hardware keyboard user interface (e.g., a user can move the second keyboard user interface without moving the hardware keyboard). Detecting a request to move the second keyboard user interface and, in response, moving the second keyboard user interface to a new keyboard position that is not based on the position of the hardware keyboard improves how and where the second keyboard user interface is positioned in the three-dimensional environment.

In some embodiments, displaying the first keyboard user interface includes displaying the first keyboard user interface as an environment-locked object (e.g., 718 or 918 are world locked) (e.g., displayed as an environment-locked object). In some embodiments, displaying the second keyboard user interface includes displaying the second keyboard user interface as an environment-locked object (e.g., 718 or 918 are world locked) (e.g., displayed as an environment-locked object). In some embodiments, the first keyboard user interface and the second keyboard user interface are world locked. Displaying the first keyboard user interface as an environment-locked object and displaying the second keyboard user interface as an environment-locked object improves the user interface because it provides a sense that the first keyboard user interface and the second keyboard user interface are world locked in the three-dimensional environment.

In some embodiments, the first keyboard user interface includes a greater amount (e.g., a greater number) (or, optionally, a lesser amount) of character entry keys (e.g., 718 includes 724 and 918 does not include 724) (e.g., alphanumeric text characters and/or punctuation mark characters) than what is included in the second keyboard user interface. Switching from a first keyboard user interface that includes a greater amount of character keys than what is included in the second keyboard user interface in response to detecting an event associated with a first hardware keyboard declutters the user interface, reduces the number of inputs to switch between keyboards, and provides visual feedback that a hardware event was detected.

In some embodiments, detecting the event associated with the first hardware keyboard includes detecting that the first hardware keyboard is no longer visually detected (e.g., 904 or 908 are no longer visually detected in FIGS. 9I, 9P, 9Q, and 9U) (e.g., via one or more cameras and/or by the user). In some embodiments, the first hardware keyboard is no longer visually detected when the first hardware keyboard is hidden from a field of view (e.g., of the one or more cameras and/or by the user). In some embodiments, the first hardware keyboard is no longer visually detected when the first hardware keyboard is moved out of at least a portion of a field of view (e.g., of at least a portion of a field of view one or more cameras and/or at least a portion of a field of view of the user). Detecting that the first hardware keyboard is no longer visually detected while a first keyboard user interface is displayed and, in response, displaying a second keyboard user interface different from the first keyboard user interface and ceasing to display of the first user interface reduces the number of user inputs to change between keyboard user interfaces, declutters the user interface, and provides visual feedback that an event associated with a hardware keyboard was detected.

In some embodiments, the first keyboard user interface is locked to the first hardware keyboard (e.g., 918 is locked to 908 in FIG. 9O). In some embodiments, the second keyboard user interface is not locked to the first hardware keyboard (e.g., 918 is not locked to 908 in FIG. 9P and includes reposition indicator 732) (e.g., as described with respect to FIGS. 9A-9Z and 10). In some embodiments, the first keyboard user interface and the second user interface do not include does not include a plurality of character entry keys (e.g., both the first keyboard user interface and the second keyboard user interface are an augmented keyboard). In some embodiments, while displaying the second keyboard user interface that is not locked to the first hardware keyboard, the computer system displays (e.g., display within the second keyboard user interface) a selectable user interface object that, when selected, causes a position at which the second keyboard user interface is displayed to change. In some embodiments, while displaying the computer system that is locked to the first hardware keyboard, the computer system does not display the selectable user interface object that, when selected, causes a position at which the first keyboard user interface is displayed to change. Locking the first keyboard user interface to the first hardware keyboard and not locking the second keyboard user interface improves how and where a software keyboard is displayed in a three-dimensional environment.

In some embodiments, detecting the event associated with the first hardware keyboard includes detecting that the first hardware keyboard is no longer wirelessly connected to (e.g., no longer wirelessly communicating with) the computer system (e.g., as described with respect to FIGS. 9S and 9G) (e.g., the first hardware keyboard is not connected to the computer system over a wireless network (e.g., via Bluetooth and/or Wi-Fi)). In some embodiments, the first hardware keyboard is not connected to the computer system because the first hardware keyboard is out of range, out of power, turned off, and/or wireless communication capabilities has been turned off. Detecting that the first hardware keyboard is no longer wirelessly connected while a first keyboard user interface is displayed and, in response, displaying a second keyboard user interface different from the first keyboard user interface and ceasing to display of the first user interface reduces the number of user inputs to change between keyboard user interfaces, declutters the user interface, improves how and where a software keyboard is displayed in a three-dimensional environment, and provides visual feedback that an event associated with a hardware keyboard was detected.

In some embodiments, the first keyboard user interface (e.g., 718) includes fewer (e.g., a fewer number) (or, optionally, a greater amount) of character entry keys (e.g., 724) (e.g., alphanumeric text characters and/or punctuation mark characters) than what is included in the second keyboard user interface (e.g., 918). In some embodiments, the second keyboard user interface includes a plurality of character entry keys, and the first keyboard does not include the plurality of character entry keys (e.g., as described in more detail with respect to FIGS. 9A-9Z and 10). In some embodiments, the first keyboard user interface includes fewer rows (and/or columns) of character entry keys (e.g., the first keyboard user interface includes at least one less row (and/or column) of character entry keys than the second keyboard user interface). Switching from a first keyboard user interface including fewer character entry key than what is included the second keyboard user interface in response to detecting an event associated with the first hardware keyboard reduces the number of user inputs to change between keyboard user interfaces and provides visual feedback that an event associated with a hardware keyboard was detected.

In some embodiments, detecting the event associated with the first hardware keyboard includes detecting that a wireless connection (e.g., wireless communication) with the first hardware keyboard has started (e.g., as described with respect to FIGS. 9H and 9T) (e.g., is beginning and/or has recently established) (e.g., the computer system has started a wireless connection with the first hardware keyboard over a wireless network (e.g., via Bluetooth and/or Wi-Fi)). Detecting that that a wireless connection with the first hardware keyboard has started while a first keyboard user interface is displayed and, in response, displaying a second keyboard user interface different from the first keyboard user interface and ceasing to display of the first user interface reduces the number of user inputs to change between keyboard user interfaces, improves what type of software keyboard is displayed, and provides visual feedback that an event associated with a hardware keyboard was detected.

In some embodiments, the first keyboard user interface (e.g., 718) includes more (e.g., a greater number) (or, optionally, fewer) character entry keys (e.g., 724) (e.g., alphanumeric text characters and/or punctuation mark characters) than what is included in the second keyboard user interface (e.g., 918). In some embodiments, the first keyboard user interface includes a plurality of character entry keys, and the second keyboard does not include the plurality of character entry keys (e.g., as described in more detail with respect to FIGS. 9A-9Z and 10). Switching from a first keyboard user interface including a greater amount of character entry key than what is included the second keyboard user interface in response to detecting an event associated with the first hardware keyboard reduces the number of user inputs to change between keyboard user interfaces, declutters the user interface, and provides visual feedback that an event associated with a hardware keyboard was detected.

In some embodiments, detecting the event associated with the first hardware keyboard includes detecting that a key press (e.g., 905c, X905c, and 905d) (e.g., an input and/or keystroke) has been detected via the first hardware keyboard. Detecting that a key press has been detected via the first hardware keyboard while a first keyboard user interface is displayed and, in response, displaying a second keyboard user interface different from the first keyboard user interface and ceasing to display of the first user interface reduces the number of user inputs to change between keyboard user interfaces, improves how and where a software keyboard is displayed in a three-dimensional environment, and provides visual feedback that an event associated with a hardware keyboard was detected.

In some embodiments, the first keyboard user interface includes a first plurality of character entry keys (e.g., 724) (e.g., alphanumeric text characters and/or punctuation mark characters). In some embodiments, the second keyboard user interface does not include the first plurality of character entry keys (e.g., in a first region and/or in a keyboard augmentation region) (e.g., as described in more detail with respect to FIGS. 9A-9Z and 10). Switching from a first keyboard user interface that includes a first plurality of character entry keys to the second keyboard user interface does not include the first plurality of character entry keys in response to detecting an event associated with the first hardware keyboard reduces the number of user inputs to change between keyboard user interfaces, declutters the user interface, and provides visual feedback that an event associated with a hardware keyboard was detected.

In some embodiments, the first keyboard user interface includes a second plurality of character entry keys (e.g., 724) (e.g., alphanumeric text characters and/or punctuation mark characters) (e.g., the same as or different from the first plurality of character keys), and wherein the second keyboard user interface does (e.g., 918) not include the second plurality of character entry keys (e.g., in a first region and/or in a keyboard augmentation region) (e.g., as described in more detail with respect to FIGS. 9A-9Z and 10). In some embodiments, while displaying the second keyboard user interface (e.g., and while not displaying the first keyboard user interface) (e.g., after detecting the event associated with the first hardware keyboard and/or before detecting the event associated with the first hardware keyboard), the computer system detects a respective input (e.g., 950t). In some embodiments, the respective input corresponds to a request to display the first keyboard user interface (e.g., a request that is made a user of the computer system). In some embodiments, the input is a second event associated with first hardware keyboard. In response detecting the respective input, the computer system displays, via the display generation component, the first keyboard user interface (e.g., 718 depicted in FIG. 9S) and ceases display of the second keyboard user interface (e.g., 918 is not depicted in FIG. 9S). Switching from the second keyboard user interface that does not include a second plurality of character entry keys to the first keyboard user interface that includes the second plurality of character entry keys in response to detecting a respective input improves how different keyboard user interfaces are displayed in a three-dimensional environment and provides visual feedback that an input was detected.

In some embodiments, the respective input is a user input (e.g., 950t) (e.g., an air gesture, a user's gaze, a speech input, a touch input, and/or mouse click) directed at a selectable interface object (e.g., 744) included in the second keyboard user interface.

In some embodiments, the computer system detects a request to use a keyboard (e.g., 750a, 750c, 750j 750n, 750p, 750s, 950a, 905d, 950k, and/or 950y) (in some embodiments, while the first keyboard user interface and/or the second keyboard user interface are not displayed). In some embodiments, the request to use the keyboard is detected while a respective keyboard user interface (e.g., the first keyboard user interface and/or the second keyboard user interface) is not displayed. In some embodiments, the request to use the keyboard is detected while a text entry session is not active (and/or while the computer system is not in a text entry mode). In response to detecting the request to use the keyboard and in accordance with a determination that a user of the computer system requested (e.g., manually requested and/or provide an input to switch from the first keyboard user interface to the second keyboard user interface) to display the second keyboard user interface in a most recent text entry session (e.g., as described with respect to FIGS. 9X-9Z) (e.g., an input session that is immediately prior to a current text entry session) (and/or that the second user interface was the most recent keyboard user interface that was displayed in the most recent text entry session), the computer system displays, via the display generation component, the second keyboard user interface (in some embodiments, without displaying the first keyboard user interface). In some embodiments, the computer system displays the second keyboard user interface independent of (e.g., regardless and/or despite) a hardware keyboard being available for input (e.g., the first hardware keyboard is connected and/or is visually detected). In some embodiments, in accordance with a determination that a user of the computer system did not request to display the second keyboard user interface in the most recent text entry session, displaying, via the display generation component, a respective keyboard (e.g., the first keyboard user interface and/or the second keyboard user interface) in accordance with a determination that a hardware keyboard is available for input (e.g., in accordance with a determination that the first set of one or more criteria or the second set of one or more criteria is satisfied, as described herein). Conditionally displaying the second keyboard user interface when a user of the computer system requested to the display the second keyboard user interface in a most recent text entry session in response to detecting the request to use the keyboard performs an operation when a set of conditions has been met without requiring further user input and provides visual feedback that a request to use the keyboard was detected.

In some embodiments, the first keyboard user interface (e.g., 718) includes a second plurality of character entry keys (e.g., 724) (e.g., alphanumeric text characters and/or punctuation mark characters) (e.g., the same as or different from the first plurality of character keys), and wherein the second keyboard user interface (e.g., 918) does not include the second plurality of character entry keys (e.g., in a first region and/or in a keyboard augmentation region) (e.g., as described in more detail with respect to FIGS. 9A-9Z and 10). In some embodiments, while displaying the first keyboard user interface and in accordance with a determination that a wireless connection (e.g., wireless communication) with a second hardware keyboard (e.g., 904 or 908) (e.g., the same as or different from the first hardware keyboard) has started (e.g., is beginning and/or has recently established) (e.g., the computer system has started a wireless connection with the second hardware keyboard over a wireless network (e.g., via Bluetooth and/or Wi-Fi)), displaying, via the display generation component, the second keyboard user interface (e.g., as described with reference to FIG. 9V). In some embodiments, in accordance with a determination that the wireless connection with the second hardware keyboard has not started (and/or that there is no wireless connection with any hardware keyboard), the computer system maintains display of the first keyboard user interface. Conditionally displaying the first keyboard user interface that does not include the third plurality of character entry keys depending on whether the a wireless connection with a second hardware keyboard has started performs an operation when a set of conditions has been met without requiring further user input, reduces the number of user inputs to change between keyboard user interfaces, and provides visual feedback that wireless connection with a hardware keyboard has started.

In some embodiments, the first keyboard user interface includes a third plurality of character entry keys (e.g., 724) (e.g., alphanumeric text characters and/or punctuation mark characters) (e.g., the same as or different from the first plurality of character keys). In some embodiments, the second keyboard user interface does not include the third plurality of character entry keys (e.g., 724) (e.g., in a first region and/or in a keyboard augmentation region) (e.g., as described in more detail with respect to FIGS. 9A-9Z and 10). In some embodiments, while the second keyboard user interface is displayed and while a third hardware keyboard (e.g., 904 or 908) (e.g., the same or different from the first hardware keyboard or the second hardware keyboard) (in some embodiments, the third hardware keyboard is the most recently connected hardware keyboard) is wirelessly connected (e.g., via Bluetooth and/or Wi-Fi), the computer system detects that the wireless connection (e.g., wireless communication) with the third hardware keyboard has ended (e.g., was terminated and/or has recently ended) (e.g., the computer system is no longer communicating with the third hardware keyboard over a wireless network). In response to detecting that the wireless connection with the third hardware keyboard has ended, the computer system displays, via the display generation component, the first keyboard user interface (e.g., as described with respect to FIG. 9G). Detecting that a wireless connection with the third hardware keyboard has ended while the second keyboard user interface (not including the third plurality of character entry keys) and while a third hardware keyboard is wirelessly connected and, in response, displaying the first keyboard user interface (including the third plurality of character entry keys) automatically performs an operation without requiring further user input, reduces the number of user inputs to change between keyboard user interfaces, and provides visual feedback that a wireless connection with a hardware keyboard has ended.

In some embodiments, the computer system detects a key selection input (e.g., input on one of character buttons 724, input on one of suggested text buttons 727a-727c, and/or an input on one of keys of 904 or 908) (e.g., a keystroke or an input on a respective key), wherein the key selection input is an input detected on the first keyboard user interface (e.g., input on one of character buttons 724), an input on the second keyboard user interface (e.g., input on one of suggested text buttons 727a-727c), or an input detected via the first hardware keyboard (e.g., input on one of keys of 904 or 908). In response to detecting the key selection input, the computer system displays, via the display generation component, content (e.g., 906 of FIGS. 9E1, 9E2, and 9F) (e.g., alphanumeric text and/or punctuation marks) corresponding to the key selection input in a text entry field (e.g., 712) (e.g., a text entry field in the representation of the application). In some embodiments, the first hardware keyboard includes a set of one or more physical keys (e.g., physical keys on a physical keyboard) corresponding the content. Displaying content in a text entry field where the content corresponds to the key selection input of the first keyboard user interface, the second keyboard user interface, or a hardware keyboard provides visual feedback that user input was detected.

In some embodiments, aspects/operations of methods 800, 1000, 1100, and 1300 may be interchanged, substituted, and/or added between these methods. For example, methods 800, 1000, and 1300 include features of method 1100 for switching between virtual keyboards. For example, methods 800, 1000, and 1300 include features related to detecting an event associated with a hardware keyboard (e.g., hardware keyboard's wireless connection status, a key press on the hardware keyboard, a hardware keyboard being hidden, and/or the hardware keyboard position with respect to a threshold distance) and switching between two virtual keyboards. As a further example, methods 800, 1000, and 1300 include features related basing a position of a virtual keyboard on a position of a hardware keyboard (including locking a position of the virtual keyboard) and/or features related to how virtual keyboards are moved. For brevity, these details are not repeated here.

FIGS. 12A-12T illustrate examples of positioning a virtual keyboard based on a person's position. FIG. 13 is a flow diagram of an exemplary method 1300 for positioning a virtual keyboard based on a person's position. The user interfaces in FIGS. 12A-12T are used to illustrate the processes described below, including the processes in FIG. 13.

The description of FIGS. 12A-12T describes features that are further described with reference to FIGS. 7A-7T and FIGS. 9A-9Z. The features in FIGS. 12A-12T that have the same reference numbers as the features in FIGS. 7A-7T and FIGS. 9A-9Z are intended to be similar features. As such, the description of features having the same number in FIGS. 12A-12T and FIGS. 7A-7T and FIGS. 9A-9Z are further described with respect to FIGS. 7A-7T and FIGS. 9A-9Z. As described with respect to FIGS. 12A-12T, device X700 displays keyboard 718 of FIGS. 7A-7T. In some embodiments, device X700 of FIGS. 12A-12T displays keyboard augmentation region 918 as described with respect to FIGS. 9A-9Z. In some embodiments, device X700 of FIGS. 12A-12T displays keyboard 718 based at least in part on a height of user 702 being in ranges 716a-716d, as described with respect to FIGS. 7A-7T. In some embodiments, device X700 of FIGS. 12A-12T does not display keyboard 718 based on a height of user 702 being in ranges 716a-716d, as described with respect to FIGS. 7A-7T.

At FIG. 12A, user 702 is lying flat with device X700 on bunk bed 1200. As depicted in display X702, user 702 has an obstructed view of keyboard 718, as depicted by double-hatching 738. Keyboard 718 is displayed at an angle of alpha (α) (e.g., the angle between eyeline 720 and keyboard line 722a), as described in further detail with respect to FIGS. 7A-7T. In some embodiments, device X700 displays keyboard 718 at an angle of alpha (α) based on determining user 702 is at standing height 704d relative to floor 714. In such embodiments, the position of keyboard 718 is incorrectly positioned, which results in the obstructed view of keyboard 718. In some embodiments, device X700 displays keyboard 718 at a different position (e.g., using an angle that is less than alpha) while user 702 is lying flat on bunk bed 1200. In some embodiments, device X700 detects that user 702 is at a lying height (e.g., lying height 704c of FIGS. 7A-7T) on bunk bed 1200 based on detecting a height from a horizontal surface of bunk bed 1200 (e.g., as opposed to floor 714). In such embodiments, in response to detecting that user 702 is at lying height 704c on bunk bed 1200, device X700 displays keyboard 718 at a horizontal position (e.g., along the x-axis and/or along eyeline 720) as described in greater detail with respect to FIG. 7F.

At FIG. 12B, as depicted in side view 1201, email application interface 710 and text field 712 are displayed. As described in further detail herein, text field 712 is configured to receive content (e.g., text and/or images) in response to detecting input via a hardware keyboard and a virtual keyboard (e.g., keyboard 718). Text field 712 occupies a portion of email application interface 710, as depicted in side view 1201 and on display X702. Vector 1204 (and/or a plane that corresponds to or is parallel to vector 1204) intersects a top edge of text field 712 and a head of user 702. In some embodiments, vector 1204 intersects an eye of user 702. As described herein, vector 1204 provides a reference point for displaying keyboard 718. In some embodiments, vector 1204 intersects a different portion of text field 712 and/or a different portion of email application interface 710. In some embodiments, vector 1204 intersects a head of user 702 while intersecting a top edge of email application interface 710 and/or a bottom edge of text field 712. In some embodiments, vector 1204 is a line of sight of the user that is detected via one or more sensors (e.g., one or more cameras). In some embodiments, vector 1204 is an estimated line of sight of the user (e.g., is not based on measurements from one or more sensors).

At FIG. 12B, device X700 determines a position of torso zone 1206 in physical space and/or relative to user 702. As described herein, a position of torso zone 1206 affects where device X700 displays keyboard 718 (e.g., to prevent an obstructed view of keyboard 718). In some embodiments, torso zone 1206 defines an area and/or volume in two-dimensional space and/or three-dimensional space that provides a reference point for where device X700 displays keyboard 718. As described herein, in some embodiments, device X700 does not display keyboard 718 in an area and/or volume occupied by torso zone 1206. At FIG. 12B, device X700 determines torso zone position 1216a based at least in part on user position 1218a. User position 1218a corresponds to a position in which user 702 is not reclining and/or is in a standing position. In some embodiments, user position 1218a corresponds to a position in which user 702 is sitting and not reclining.

At FIG. 12B, device X700 determines user position 1218b based on a position of torso axis 1210. At FIG. 12B, torso axis 1210 is parallel to a y-axis (e.g., an axis that is parallel to the direction of gravity) of cartesian 708. In some embodiments, torso axis 1210 extends through at least two points of user 702. In some embodiments, the torso axis 1210 extends through a head (and/or neck) of user 702 and a stomach (and/or hip) of user 702. In some embodiments, torso axis 1210 is parallel to and/or is on a plane (e.g., a coronal plane and/or a plane parallel to the coronal plane) that divides the person into an anterior portion (e.g., a front portion) and a posterior portion (e.g., back portion). In some embodiments, the torso axis 1210 is parallel to and/or is on a plane (e.g., a sagittal plane and/or a plane parallel to the sagittal plane) that divides the person into a left portion and a right portion.

At FIG. 12B, torso zone 1206 has the shape of a cone. The cone has an angle lambda (a) relative to torso axis 1210. In some embodiments, torso zone 1206 is a cone having a radius that extends from the edge of torso zone 1206 to torso axis 1210. In some embodiments, the radius of the torso zone 1206 is smaller at a neck and/or shoulder area of user 702 as compared to the radius of torso zone 1206 at a stomach and/or hip area of user 702. In some embodiments, angle lambda (a) is an opening angle (e.g., vertex angle) of torso zone 1206 when torso zone 1206 is a cone (e.g., oblique cone and/or right-angle cone). In some embodiments, angle lambda (a) is fixed (e.g., does not change and/or is not user configurable). In some embodiments, angle lambda (a) is dynamic (e.g., changes in response to a trigger and/or is user configurable), as described in greater detail herein. In some embodiments, torso zone 1206 is not a cone. In some embodiments, torso zone 1206 has a shape (e.g., rectangle, sphere, and/or pyramid) that is different from a cone.

At FIG. 12B, torso zone 1206 increases in size at it extends from a shoulder area of user 702 to a stomach area of user 702. As depicted, torso zone 1206 starts at the neck of user 702 and extends toward a hip and/or feet of user 702. In some embodiments, a cross-sectional area of torso zone 1206 is smaller at a neck and/or shoulder area of user 702 as compared to a cross-sectional area of torso zone 1206 at a stomach and/or hip area of user 702. In some embodiments, the cross-sectional area increases as torso zone 1206 extends from a chest area to a stomach area of user 702 (e.g., an edge of torso zone 1206 is farther from the body of user 702 as torso zone 1206 extends from the chest area to the stomach area of user 702). As depicted in top-down schematic 709, torso zone 1206 extends around at least a portion (e.g., some but not all and/or all) of user 702. In some embodiments, torso zone 1206 surrounds at least a portion (e.g., some but not all and/or all) of a chest and/or stomach of user 702. In some embodiments, a size of torso zone 1206 is based on information about a size (e.g., estimated and/or detected via one or more sensors) of user 702. In some embodiments, a size of torso zone 1206 is based on a height and/or weight of user 702. As described in greater detail herein, in some embodiments, a size of torso zone 1206 is based on user interactions with a graphical element displayed by X700 that indicate a size of user 702.

At FIG. 12B, device X700 detects a selection of text field 712 as part of a trigger to display a virtual keyboard. For example, device X700 detects pinch 1205b while gaze 1203b of user 702 is directed toward text field 712. In response to detecting pinch 1205b and gaze 1203b, device X700 displays keyboard 718 as shown in FIG. 12C. As described in greater detail herein, device X700 can detect other triggers to display a virtual keyboard (e.g., moving email application interface 710 and/or launching email application interface 710).

At FIG. 12C, device X700 displays keyboard 718 based on user position 1218a (and/or torso zone 1206). As depicted in side view 1201, keyboard 718 does not overlap with an area occupied by torso zone 1206. In some embodiments, device X700 determines a position of keyboard 718 in response to (or, optionally, prior to and/or after) detecting pinch 1205b and gaze 1203b. After (and/or in response to) detecting that keyboard 718 will not overlap with an area occupied by torso zone 1206, device X700 displays keyboard 718 at keyboard position 1213a.

At FIG. 12C, keyboard position 1213a is offset from the top edge of text field 712. For example, keyboard position 1213a is displayed along keyboard line 1214 that has an angle of sigma (a) relative to vector 1204. In some embodiments, sigma (a) is an angle that extends down from vector 1204 and toward a torso of user 702 (e.g., in a direction of gravity while user 702 is in user position 1218a). In some embodiments, angle sigma (a) is an angle that is in the range of 28 to 48 degrees. In some embodiments, angle sigma (a) is 38 degrees. Keyboard line 1214 is similar to keyboard line 722 of FIGS. 7A-7T, but has a different state (e.g., keyboard line 1214 is determined based on vector 1204). In some embodiments, as depicted in top-down schematic 709, device X700 displays keyboard 718 at depth 726 (e.g., relative to user 702 and/or relative to device X700) along keyboard line 1214, as described in greater detail with respect to FIGS. 7A-7T. In some embodiments, device X700 displays keyboard 718 at different depths as described in greater detail with respect to FIGS. 7A-7T.

At FIG. 12D, in response to detecting a triggering event to display keyboard 718 (e.g., an event similar to the event of detecting a pinch while a gaze of user 702 is directed toward text field 712, similar to pinch 1205b and gaze 1203b of FIG. 12C), device X700 displays keyboard 718 based on user position 1218b of user 702 (and/or torso position 1216b of torso zone 1206). User position 1218b of user 702 in FIG. 12D is different from user position 1218a of user 702 in FIG. 12C. For example, user 702 (and/or the torso of user 702) of FIG. 12D is semi-reclining (e.g., user 702 is partially leaning back in a chair and/or bed). The position of torso zone 1206 in FIG. 12D is different from the position of torso zone 1206 in FIG. 12C. At FIG. 12D, device X700 determines torso zone position 1216b based at least in part on user 702 semi-reclining. In some embodiments, device X700 determines user position 1218b based on a position of torso axis 1210 in FIG. 12D. As depicted, the orientation of torso axis 1210 of FIG. 12D is different from (e.g., has a different angle than and/or is on a different plane than) the orientation of torso axis 1210 of FIG. 12C. For example, torso axis 1210 of FIG. 12D is not parallel with gravity because user 702 of FIG. 12D is semi-reclining. In some embodiments, in response to determining the orientation of torso axis 1210 in FIG. 12D, device X700 determines torso zone position 1216b of torso zone 1206. In some embodiments, torso zone 1206 of FIG. 12D is the same size and/or shape of torso zone 1206 of FIG. 12C. For example, even though the position of torso zone 1206 of FIG. 12D is different from the position of torso zone 1206 in FIG. 12C, torso zone 1206 of FIG. 12D still has a conical shape. As depicted, device X700 determines torso zone 1206 based on angle lambda (a) relative to torso axis 1210. In some embodiments, torso zone 1206 has an orientation relative to a portion (e.g., torso, chest, and/or stomach) of user 702 in FIG. 12D that is the same as an orientation of torso zone 1206 relative to the same portion of user 702 in FIG. 12C.

At FIG. 12D, device X700 displays keyboard 718 at keyboard position 1213b, which does not overlap with an area occupied by user 702 (and/or torso zone 1206). In some embodiments, in response to detecting torso zone 1206 has torso zone position 1216b, device X700 displays keyboard 718 at keyboard position 1213b. As depicted in side view 1201, device X700 displays keyboard 718 along keyboard line 1214. Keyboard line 1214 of FIG. 12D has angle of chi (X) relative to vector 1204, where angle chi (X) is different from angle sigma (a) of FIG. 12C. For example, keyboard line 1214 in FIG. 12D is closer to vector 1204 as compared to keyboard line 1214 of FIG. 12C. As depicted on display X702, device X700 displays keyboard 718 at an area above torso zone 1206. In some embodiments, device X700 displays keyboard 718 at a position that is non-overlapping with and/or is within a threshold distance from torso zone 1206. In some embodiments, device X700 displays keyboard 718 immediately adjacent to torso zone 1206 (e.g., no intervening gap between keyboard 718 and torso zone 1206). Torso zone 1206 is depicted as a dashed line in display X702 for illustrative purposes. In some embodiments, device X700 does not display torso zone 1206. In some embodiments, device X700 displays bottom edge 1222 of keyboard 718 at a position that is adjacent to (and/or within a threshold distance from) an edge of torso zone 1206. As such, a portion of keyboard 718 does not overlap with torso zone 1206. Hatching region 1220 depicts where a portion of keyboard 718 would have been displayed had device X700 not adjusted the position of keyboard 718 to account for user position 1218b and/or torso zone position 1216b. For example, hatching region 1220 depicts a position of keyboard 718 along a keyboard line having an angle of sigma (a) (e.g., as depicted in FIG. 12C). Hatching region 1220 depicts a position of keyboard 718 that is closer to the body of user 702 as compared to keyboard position 1213b. As depicted in FIG. 12D, device X700 displays keyboard 718 closer to text field 712 as compared to keyboard 718 in FIG. 12C.

At FIG. 12D, device X700 detects a request to move keyboard 718. For example, device X700 detects pinch 1205d1 while gaze 1203d of user 702 is directed toward reposition indicator 732. While device X700 detects that pinch 1205d1 is maintained (e.g., pinch 1205d1 was not released after making an initial pinch gesture), device X700 detects movement 1205d2 of pinch 1205d1 from one position (e.g., the position in which the pinch was made) to a different position. In response to detecting pinch 1205d1 and movement 1205d2 of pinch 1205d1, device X700 displays keyboard 718 in keyboard position 1213d of FIG. 12F. While device X700 displays keyboard 718 at keyboard position 1213d, device X700 detects an end of pinch 1205d1 (e.g., pinch 1205d1 is released).

At FIG. 12E, in response to detecting a triggering event to display keyboard 718 (e.g., an event similar to the event of detecting a pinch while a gaze of user 702 is directed toward text field 712, similar to pinch 1205b and gaze 1203b of FIG. 12C), device X700 displays keyboard 718 based on user position 1218c of user 702 (and/or torso position 1216c of torso zone 1206). User position 1218c of user 702 in FIG. 12E is different than user positions 1218a-1218b of user 702 of FIGS. 12C-12D. For example, user 702 (and/or the torso of user 702) of FIG. 12E is fully reclining (e.g., lying flat) and/or is horizontal. Torso zone position 1216c of torso zone 1206 in FIG. 12E is also different from torso zone positions 1216a-1216b of torso zone 1206 of FIGS. 12C-12D (e.g., torso zone position 1216c is rotated as compared to torso zone positions 1216a-1216b and/or is lower than torso zone positions 1216a-1216b). At FIG. 12E, device X700 determines torso zone position 1216c based on user 702 having user position 1218c. In some embodiments, device X700 determines user position 1218c based on a position of torso axis 1210 in FIG. 12E. As depicted, the orientation of torso axis 1210 of FIG. 12E is different from (e.g., has a different angle than and/or is on a different plane than) the orientation of torso axis 1210 in FIGS. 12C-12D. For example, torso axis 1210 in FIG. 12E is perpendicular to gravity because user 702 in FIG. 12E is fully reclining. In some embodiments, in response to determining the orientation of torso axis 1210, device X700 determines torso zone position 1216c of torso zone 1206. In some embodiments, torso zone 1206 of FIG. 12E is the same size and/or shape of torso zone 1206 of FIGS. 12C-12D. For example, even though the position of torso zone 1206 of FIG. 12E is different from the position of torso zone 1206 in FIGS. 12C-12D, torso zone 1206 of FIG. 12E still has a conical shape. As depicted, device X700 determines torso zone 1206 based on angle lambda (a) relative to torso axis 1210.

At FIG. 12E, device X700 displays keyboard 718 at keyboard position 1213c, which does not overlap with an area occupied by user 702 (and/or torso zone 1206). In some embodiments, in response to detecting torso zone 1206 has torso zone position 1216c, device X700 displays keyboard 718 at keyboard position 1213c. As depicted in side view 1201, device X700 displays keyboard 718 along keyboard line 1214. Keyboard line 1214 of FIG. 12E has angle of rho (p) relative to vector 1204, where angle rho (p) is different from angle sigma (a) of FIG. 12C and angle chi (X) of FIG. 12D. For example, angle rho (p) is smaller than angle sigma (a) of FIG. 12C and angle chi (X) of FIG. 12D (e.g., keyboard line 1214 in FIG. 12E is closer to vector 1204 as compared to keyboard line 1214 of FIGS. 12C-12D). At FIG. 12E, as depicted on display X702, device X700 displays keyboard 718 at an area above torso zone 1206. In some embodiments, device X700 displays keyboard 718 at a position that is non-overlapping with and/or is within a threshold distance from torso zone 1206. In some embodiments, device X700 displays keyboard 718 immediately adjacent to torso zone 1206 (e.g., no intervening gap between keyboard 718 and torso zone 1206). Hatching region 1220 depicts where keyboard 718 would have been displayed had device X700 not adjusted the position of keyboard 718 to account for user position 1218b and/or torso zone position 1216c. For example, hatching region 1220 depicts a position of keyboard 718 along a keyboard line having an angle of sigma (a) (e.g., as depicted in FIG. 12C). Hatching region 1220 depicts a position of keyboard 718 that is closer to the body of user 702 as compared to keyboard position 1213c. As depicted in FIG. 12E, device X700 displays keyboard 718 closer to text field 712 as compared to keyboard 718 of FIGS. 12C-12D. In some embodiments, device X700 displays keyboard 718 as overlapping with text field 712. In some embodiments, device X700 displays keyboard 718 at a position that does not overlap with text field 712 (e.g., to the right and/or left of text field 712) when device X700 determines torso zone 1206 causes keyboard 718 to be displayed at a keyboard position (e.g., keyboard position 1213c) that overlaps with text field 712 (e.g., keyboard 718 is displayed adjacent to text field 712 as depicted in FIG. 7F).

At FIG. 12F, in response to detecting pinch 1205d1, movement 1205d2, and end of pinch 1205d1 of FIG. 12D, device X700 displays keyboard 718 at keyboard position 1213d. Keyboard position 1213d is a position that is closer to the body of user 702 as compared to keyboard position 1213b of FIG. 12D. At FIG. 12F, keyboard 718 is displayed along keyboard line 1214 that has angle tau (τ) relative to vector 1204, where angle tau (τ) is greater than angle chi (χ) of FIG. 12D. As depicted in FIG. 12F, while at keyboard position 1213d, a portion (e.g., some but not all) of keyboard 718 is within and/or overlaps with torso zone 1206. For example, bottom edge 1222 is between an edge of torso zone 1206 and the body of user 702. As illustrated in side view 1201, an edge of torso zone 1206 intersects a portion of keyboard 718.

At FIG. 12G, device X700 updates torso zone 1206 in response to detecting keyboard 718 has been moved to keyboard position 1213d. In some embodiments, device X700 updates torso zone 1206 such that keyboard 718 does not overlap with an area occupied and/or defined by torso zone 1206. As illustrated in display X702, device X700 has moved an edge of torso zone 1206 down toward bottom edge 1222 of keyboard 718. In some embodiments, the edge of torso zone 1206 is immediately adjacent to bottom edge 1222 of keyboard 718. As illustrated in side view 1201, an edge of torso zone 1206 does not intersect a portion of keyboard 718.

At FIG. 12G, torso zone 1206 has a different size than torso zone 1206 of FIG. 12F. In some embodiments, torso zone 1206 of FIG. 12G occupies a volume that is less than a volume occupied by torso zone 1206 of FIG. 12F. In some embodiments, the orientation of torso zone 1206 has changed relative to the body of user 702. At FIG. 12G, the edge of torso zone 1206 is closer to the body of user 702 relative to the edge of torso zone 1206 of FIG. 12F. At FIG. 12G, device X700 determines torso zone 1206 based on angle mu (μ) relative to torso axis 1210. Angle mu (μ) of FIG. 12G is an angle that is less than angle lambda (λ) of FIG. 12F (e.g., causing the conical shape of torso zone 1206 of FIG. 12G to be smaller in size as compared to the size of the conical shape of torso zone 1206 of FIG. 12F). In some embodiments, device X700 decreases a radius of an arch of torso zone 1206 (e.g., the arch moves closer to the body of user 702) in response to detecting movement of keyboard 718 to keyboard position 1213d (and/or into a position that overlaps with an area included in torso zone 1206). As depicted, torso zone 1206 of FIG. 12G maintains a conical shape.

At FIG. 12G, device X700 detects pinch 1205g while gaze 1203g of user 702 is directed to close option 1217. In response to detecting pinch 1205g and gaze 1203g, device X700 closes keyboard 718, as depicted in FIG. 12H.

At FIG. 12H, after keyboard 718 has been closed and/or while device X700 does not display keyboard 718, device X700 detects pinch 1205h while gaze 1203h of user 702 is directed toward text field 712. In response to detecting pinch 1205h while gaze 1203h of user 702 is directed toward text field 712, device X700 displays (e.g., re-displays) keyboard 718 at keyboard position 1213d, as depicted in FIG. 12I. In some embodiments, device X700 detects pinch 1205h while gaze 1203h of user 702 is directed to text field 712 while user 702 maintains user position 1218b (e.g., user has not moved after closing keyboard 718). In some embodiments, device X700 detects pinch 1205h while gaze 1203h of user 702 is directed to text field 712 after user has moved to a different position and then returned to user position 1218b (e.g., user has moved after closing keyboard 718 but has returned to the same position at the time pinch 1205h and gaze 1203h are detected).

At FIG. 12I, device X700 displays keyboard 718 and maintains the size and/or shape of torso zone 1206 that device X700 determined in FIG. 12G. Moreover, device X700 displays keyboard 718 at keyboard position 1213d (the previously displayed position). Device X700 displays keyboard 718 at keyboard position 1213d instead of keyboard position 1213b of FIG. 12D in response to detecting user input repositioning keyboard 718 (e.g., gaze 1203d, pinch, 1205d1, and/or movement 1205d2). Keyboard position 1213d of keyboard 718 is closer to the body of user 702 than keyboard position 1213b of keyboard 718 in FIG. 12D. Hatching region 1220 depicts where keyboard 718 would have been displayed had device X700 not adjusted the position of keyboard 718 to account for torso zone 1206. For example, hatching region 1220 depicts a position of keyboard 718 along keyboard line 1214 having an angle of sigma (σ) (e.g., as depicted in FIG. 12C). At FIG. 12I, device X700 detects pinch 1205i1 while gaze 1203i is directed toward reposition indicator 732. While detecting pinch 1205i1 is maintained (e.g., pinch 1205i1 hasn't ended), device X700 detects movement 1205i2 of pinch 1205i1 to move keyboard 718 up (e.g., relative to the body of user 702 and/or relative to email application interface 710). In response to detecting movement 1205i2 of pinch 1205i1, device X700 displays keyboard 718 at keyboard position 1213e of FIG. 12J. While device X700 displays keyboard 718 at keyboard position 1213e, device X700 detects an end of pinch 1205i1 (e.g., pinch 1205i1 is released).

At FIG. 12J, in response to detecting the end of pinch 1205i1, device X700 displays keyboard 718 at keyboard position 1213e. Keyboard position 1213e is farther from the body of user 702 than keyboard position 1213d of FIG. 12I. Additionally, keyboard position 1213e is closer to text field 712 than keyboard position 1213d of FIG. 12I. At FIG. 12J, device X700 determines keyboard 718 is displayed along keyboard line 1214 that has angle epsilon (ε) relative to vector 1212. In some embodiments, angle epsilon (ε) is a smaller angle than angle tau (τ) of FIGS. 12G-12I. In some embodiments, angle epsilon (ε) is smaller than angle sigma (σ) of FIG. 12B.

At FIG. 12K, device X700 updates torso zone 1206 in response to detecting keyboard 718 has been moved to keyboard position 1213e. As illustrated in display X702, the edge of torso zone 1206 has moved up toward bottom edge 1222 of keyboard 718. In some embodiments, the edge of torso zone 1206 is immediately adjacent to bottom edge 1222 of keyboard 718. As illustrated in side view 1201, torso zone 1206 of FIG. 12K has a different size than torso zone 1206 of FIG. 12J. In some embodiments, torso zone 1206 of FIG. 12K occupies a volume that is greater than a volume occupied by torso zone 1206 of FIG. 12J. In some embodiments, the orientation of torso zone 1206 has changed relative to the body of user 702. At FIG. 12K, an edge of torso zone 1206 is farther from the body of user 702 relative the edge of torso zone 1206 of FIG. 12J. At FIG. 12K, device X700 determines torso zone 1206 based on angle nu (ν) relative to torso axis 1210. Angle nu (ν) of FIG. 12K is an angle that is greater than angle mu (μ) of FIG. 12J (e.g., causing the conical shape of torso zone 1206 of FIG. 12K to be larger in size as compared to the size of the conical shape of torso zone 1206 of FIG. 12J). In some embodiments, device X700 increases a radius of an arch of torso zone 1206 (e.g., the arch moves farther from the body of user 702) in response to detecting movement of keyboard 718 into keyboard position 1213e. As depicted, torso zone 1206 of FIG. 12K maintains a conical shape. At FIG. 12K, device X700 detects pinch 1205k while gaze 1203k of user 702 is directed to close option 1217. In response to detecting pinch 1205g and gaze 1203g, device X700 closes keyboard 718, as depicted in FIG. 12L.

At FIG. 12L, after keyboard 718 has been closed and/or while device X700 does not display keyboard 718, device X700 detects pinch 12051 while gaze 12031 of user 702 is directed to text field 712. In response to detecting pinch 12051 while gaze 12031 of user 702 is directed to text field 712, device X700 displays (e.g., re-displays) keyboard 718 at keyboard position 1213e, as depicted in FIG. 12M. In some embodiments, device X700 detects pinch 12051 while gaze 12031 of user 702 is directed to text field 712 while user 702 maintains user position 1218b (e.g., user has not moved after closing keyboard 718). In some embodiments, device X700 detects pinch 12051 while gaze 12031 of user 702 is directed to text field 712 after user has moved to a different position and then returned to user position 1218b (e.g., user has moved after closing keyboard 718 but has returned to the same position at the time pinch 12051 and gaze 12031 are detected).

At FIG. 12M, device X700 displays keyboard 718 and maintains the size and/or shape of torso zone 1206 that device X700 determined in FIG. 12K. Moreover, device X700 displays keyboard 718 at a previously displayed position (e.g., keyboard position 1213e). Keyboard position 1213e is farther from the body of user 702 than keyboard position 1213d of keyboard 718 in FIG. 12I. Hatching region 1220 depicts where keyboard 718 would have been displayed had device X700 not adjusted the position of keyboard 718 to account for torso zone 1206. For example, hatching region 1220 depicts a position of keyboard 718 along keyboard line 1214 having an angle of sigma (σ) (e.g., as depicted in FIG. 12C).

At FIG. 12M, device X700 detects a request to move email application interface 710. In some embodiments, moving a user interface that includes a text field is a triggering event for updating a position of keyboard 718. Device X700 detects pinch 1205m1 while gaze 1203m of user 702 is directed to a window banner of email application interface 710 (and/or an icon that, when selected, causes email application interface 710 to be in a state moves in response to device X700 detecting a movement of an input). While pinch 1205m1 is maintained (e.g., pinch 1205m1 has not ended), device X700 detects movement 1205m2 of pinch 1205m1 in an upward direction (e.g., relative to user 702 and/or relative to gravity). In response to detecting pinch 1205m1 and movement 1205m2 of pinch 1205m1, device X700 displays email application interface 710 at a new position, as depicted in FIG. 12N. While device X700 displays email application interface 710 at the new position, as depicted in FIG. 12N, device X700 detects an end of pinch 1205m1 (e.g., pinch 1205m1 is released).

At FIG. 12N, in response to detecting the new position of email application interface 710, device X700 updates the position of keyboard 718. For example, email application interface 710 of FIG. 12N is at a position that is higher along the y-axis (e.g., an axis parallel to the direction of gravity) relative to the position of email application interface 710 of FIG. 12M. As depicted, email application interface 710 of FIG. 12N is at a position that is farther from user 702 and/or torso zone 1206 relative to the position of email application interface 710 of FIG. 12M. In response to detecting that email application interface 710 has been moved in a respective direction (e.g., up, down, left, and/or right), device X700 moves keyboard 718 in the same direction. For example, device X700 displays keyboard 718 at keyboard position 1213f. Keyboard position 1213f is a position that is higher along the y-axis relative to keyboard position 1213e of FIG. 12M. As depicted, keyboard 718 at keyboard position 1213f of FIG. 12N is at a position that is farther from user 702 and/or torso zone 1206 relative to keyboard 718 at keyboard position 1213e of FIG. 12M. In some embodiments, in response to determining that keyboard 718 no longer intersects and/or overlaps with torso zone 1206 when keyboard 718 is displayed at angle sigma (e.g., the angle that is typically used unless it intersects with torso zone 1206, as described with respect to FIG. 12C), device X700 displays keyboard 718 at keyboard position 1213f. As depicted, bottom edge 1222 of keyboard 718 is not immediately adjacent to torso zone 1206 (e.g., there is a gap between bottom edge 1222 and torso zone 1206) while keyboard 718 is displayed at keyboard position 1213f.

At FIG. 12N, device X700 detects a request to move email application interface 710 down. For example, device X700 detects pinch 1205n1 while gaze 1203n is directed to a window banner (and/or an icon that, when selected, puts email application interface 710 in a state that causes email application interface 710 to move in response to device X700 detecting a movement of an input) of email application interface 710. While pinch 1205n1 is maintained (e.g., pinch 1205n1 has not ended), device X700 detects movement 1205m2 of pinch 1205m1 in a downward direction (e.g., relative to user 702 and/or relative to gravity). In response to detecting pinch 1205n1 and movement 1205n2 of pinch 1205n1, device X700 displays email application interface 710 to a new position, as depicted in FIG. 12O. While device X700 displays email application interface 710 at the new position, as depicted in FIG. 12O, device X700 detects an end of pinch 1205n1 (e.g., pinch 1205n1 is released).

At FIG. 12O, in response to detecting that the position of email application interface 710 has been updated, device X700 updates the position of keyboard 718. As depicted, device X700 displays keyboard 718 at keyboard position 1213g, which does not overlap with an area occupied by user 702 (and/or torso zone 1206). In some embodiments, in response to detecting torso zone 1206 has torso zone position 1216c, device X700 displays keyboard 718 at keyboard position 1213g. As depicted in side view 1201, device X700 displays keyboard 718 along keyboard line 1214. Keyboard line 1214 of FIG. 12O has an angle of gamma (γ) relative to vector 1204, where angle gamma (γ) is a smaller angle than angle sigma (σ) (e.g., keyboard line 1214 in FIG. 12O is closer to vector 1204 as compared to keyboard line 1214 of FIG. 12N). At FIG. 12O, as depicted on display X702, device X700 displays keyboard 718 at an area above torso zone 1206. In some embodiments, device X700 displays keyboard 718 at a position that is non-overlapping with and/or is within a threshold distance from torso zone 1206. In some embodiments, device X700 displays keyboard 718 immediately adjacent to torso zone 1206 (e.g., no intervening gap between keyboard 718 and torso zone 1206). Hatching region 1220 depicts where keyboard 718 would have been displayed had device X700 not adjusted the position of keyboard 718 to account for user position 1218b and/or torso zone position 1216b. For example, hatching region 1220 depicts a position of keyboard 718 along a keyboard line having an angle of sigma (σ) (e.g., as depicted in FIG. 12C). Hatching region 1220 depicts a position of keyboard 718 that is closer to the body of user 702 as compared to keyboard position 1213g.

At FIG. 12P, in some embodiments, device X700 determines an area encompassed by torso zone 1206 based at least partially on one or more measurements of a portion of 702 detected via one or more sensors 1226 (e.g., one or more cameras and/or one or more depth sensors). For example, device X700 determines torso zone 1206 based on a depth map of a portion (e.g., some but not all or all) of the body (e.g., including the chest and/or stomach) of user 702. In some embodiments, device X700 determines different sizes for torso zone 1206 based on the depth map indicating that different users have different sizes. In some embodiments, device X700 adjusts a size, a position, and/or a shape of torso zone 1206 based on the one or more measurements detected via one or more sensors 1224. In some embodiments, using the one or more measurements detected via one or more sensors 1224, device X700 adjusts an outer edge of 1206 so that the outer edge of 1206 is within a threshold distance (e.g., 2 inches, 4 inches, or 6 inches) of an edge of a portion of a body of user 702. In some embodiments, torso zone 1206 has a shape that corresponds to (e.g., is dependent on and/or is based on) the contours of the body of user 702. As depicted in side view 1201 and in top-down schematic 709, torso zone 1206 does not form a conical shape.

At FIG. 12P, device X700 detects a triggering event to display keyboard 718. For example, device X700 detects pinch 1205p while gaze 1203p of user 702 is directed to email application icon 1225 that corresponds to the application of email application interface 710. In response to detecting pinch 1205p and gaze 1203p, device X700 displays email application interface 710 and keyboard 718, as depicted in FIG. 12Q or FIG. 12R.

At FIGS. 12Q-12R, text field 712 has a different position in email application interface 710. As described herein, device X700 displays keyboard 718 at different positions based on the different position of text field 712. At FIG. 12Q, device X700 displays keyboard 718 at keyboard position 1213i that is based on the position of text field 712. In some embodiments, prior to displaying keyboard 718 at keyboard position 1213i, device X700 determines whether displaying keyboard 718 at keyboard position 1213i includes displaying keyboard 718 within the threshold distance of email application interface 710. In some embodiments, to determine whether keyboard 718 will be displayed within a threshold range of email application interface 710, device X700 determines whether an edge (e.g., top, bottom, left, and/or right) of keyboard 718 is within a threshold distance of an edge (e.g., top, bottom, left, and/or right) of email application interface 710. At FIG. 12Q, keyboard 718 partially overlaps with email application interface 710 and, as such, the top edge of keyboard 718 is within a threshold range of the bottom edge of email application interface 710. In some embodiments, to determine whether keyboard 718 will be displayed within a threshold distance of email application interface 710, device X700 determines whether keyboard 718 will at least partially overlap with email application interface 710. In response to detecting that displaying keyboard 718 at keyboard position 1213i is within a threshold range of email application interface 710, device X700 displays keyboard 718 at keyboard position 1213i. As depicted, keyboard position 1213i is along keyboard line 1214 that has an angle of sigma (σ) relative to vector 1204, as described in greater detail with respect to FIG. 12C.

At FIG. 12R, device X700 displays keyboard 718 at keyboard position 1213h that is based on the position of text field 712. Text field 712 of email application interface 710 in FIG. 12R is lower in email application interface 710 (and/or closer to the bottom edge of email application interface 710) as compared to text field 712 in FIG. 12Q. Based on the location of text field 712 in FIG. 12R, device X700 determines whether keyboard 718 will be displayed within a threshold distance of email application interface 710. At FIG. 12R, prior to displaying keyboard 718 (and/or in response to detecting pinch 1205p and gaze 1203p), device X700 determines that displaying keyboard 718 at a position that is based on a keyboard line that has an angle of sigma (σ) relative to vector 1204 would result in displaying keyboard 718 beyond the threshold distance of email application interface 710. In some embodiments, device X700 determines that displaying keyboard 718 based on a keyboard line that has an angle of sigma (σ) will result in displaying keyboard 718 at a position that does not at least partially overlap with email application interface 710 and/or at a position where an edge (e.g., top, bottom, left, and/or right) of keyboard 718 is not with within a threshold distance of an edge (e.g., top, bottom, left, and/or right) of email application interface 710.

At FIG. 12R, in response to determining that that displaying keyboard 718 at a position that is based on a keyboard line that has an angle of sigma (σ) relative to vector 1204 results in displaying keyboard 718 beyond the threshold distance of email application interface 710, device X700 displays keyboard 718 at keyboard position 1213i. As depicted in FIG. 12R, displaying keyboard 718 at keyboard position 1213i includes displaying a top edge of keyboard 718 within a threshold distance of bottom edge 1227 of email application interface 710. In some embodiments, displaying keyboard 718 at keyboard position 1213i includes displaying a top edge of keyboard 718 immediately adjacent to (e.g., without an intervening gap) bottom edge 1227 of email application interface 710. In some embodiments, displaying keyboard 718 at keyboard position 1213i includes displaying keyboard 718 on keyboard line 1214 at an angle omega (o) relative to vector 1204, where angle omega (o) is a smaller angle than angle sigma (σ).

At FIG. 12S, in response to detecting a triggering event to display keyboard 718 (e.g., selecting text field 712, moving email application interface 710, and/or selecting an application icon), device X700 displays keyboard 718 based on user position 1218c of user 702 (and/or torso zone 1206). As depicted, user 702 is fully reclining and/or is horizontal. Torso zone 1206 in FIG. 12S is based on one or more measurements detected via one or more sensors 1226 (e.g., one or more cameras and/or one or more depth sensors), which described in greater detail with respect to FIG. 12P. Device X700 displays keyboard 718 at keyboard position 1213j, which does not overlap with an area occupied by user 702 (and/or torso zone 1206). Device X700 displays keyboard 718 along keyboard line 1214. In some embodiments, keyboard line 1214 in FIG. 12S has an angle relative to vector 1204 that is less than angle sigma (σ) in FIG. 12C. At FIG. 12S, hatching region 1220 depicts where keyboard 718 would have been displayed had device X700 not adjusted the position of keyboard 718 to account for user position 1218c and/or torso zone 1206 in FIG. 12S.

FIG. 12T illustrates examples 1230A-1230C that depict how a torso zone (or lack thereof) affects a position of keyboard 718. In example 1230A, device X700 displays keyboard 718 without using torso zone 1206. As such, device X700 displays keyboard 718 at keyboard position 1228a. As depicted in display X702, keyboard 718 is partially obstructed by the user's chest, as depicted by double-hatching 738.

At FIG. 12T, in example 1230B, device X700 displays keyboard 718 based on torso zone 1206 that is determined from one or more measurements detected via sensors 1226, as described with respect to FIGS. 12P-12S. As depicted in display X702, keyboard 718 is not obstructed. Because device X700 determines torso zone 1206 based on one or more measurements detected via sensors 1226, device X700 displays X702 in keyboard position 1228b that is visible by user 702.

At FIG. 12T, in example 1230C, device X700 displays keyboard 718 based on torso zone 1206 that has a conical shape, as described with respect to FIGS. 12B-12E. As depicted in display X702, keyboard 718 is not obstructed. Because device X700 determines torso zone 1206 based on a conical shape of torso zone 1206, device X700 displays X702 in keyboard position 1228c that is visible by user 702. Keyboard position 1228c of example 1203C is different from keyboard position 1228b of example 1203B. For example, keyboard position 1228c is farther from user 702 (and/or closer to text field 712) than keyboard position 1228b.

FIG. 13 is a flow diagram of an exemplary method 1300 for positioning a virtual keyboard based on a person's position, in some embodiments. In some embodiments, method 1300 is performed at a computer system (e.g., 700, X700, and/or computer system 101 in FIG. 1A) (e.g., a smartphone, a tablet computer, a laptop computer, a desktop computer, and/or a head mounted device (e.g., a head mounted augmented reality and/or extended reality device)) that is in communication with one or more display generation components (e.g., a display controller, a touch-sensitive display system, a monitor, and/or a head mounted display system) (e.g., 701, X702, and/or display generation component 120 in FIGS. 1A, 3, and 4) (e.g., a heads-up display, a display, a touchscreen, a projector, etc.) and one or more input devices (e.g., 701, 703, and/or 125) (e.g., a touch-sensitive surface, a keyboard, a controller, a microphone, a sensor (such as a motion sensor and/or a sensor for detecting body gestures), a camera (e.g., an infrared camera, a depth camera, a visible light camera, and/or one or more cameras (e.g., a camera (e.g., color sensors, infrared sensors, and other depth-sensing cameras) that point downward at a user's hand or a camera that points forward from the user's head)), and/or a mouse) (in some embodiments, the one or more input devices are capable of detecting movement of a portion of a user's body (e.g., detect air gestures)). In some embodiments, method 1300 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1300 are, optionally, combined and/or the order of some operations is, optionally, changed.

The computer system detects (1302), via the one or more input devices, an event (e.g., 1203b, 1205b, 1203h, 1205h, 1203i, 1205i1, 1205i2, 1203m, 1205m1, 1205m2, 1203n, 1205n1, 1205n2, 1203p, and/or 1205p) (e.g., a user input, a gesture, and/or a touch input) associated with an input field (e.g. 712) (e.g., a text entry field, an input region, and/or a region of a user interface that receives text and/or other content via user input, such as, a search field of a web-browser and/or a document of a word processing application). In some embodiments, the event associated with the input field includes a request to display a user interface (e.g., a request to launch an application or a request to display a window) that includes the input field, an input interacting with a user interface (e.g., a system user interface, an application region, or an application window) that includes the input field, moving an application window that includes the input field, and/or a request to add content to the input field. In response to detecting the event associated with the input field, the computer system displays (1304), via the one or more display generation components, a keyboard user interface (e.g., 718 and/or 918) (e.g., a software and/or virtual keyboard that includes a plurality of selectable key elements) for inputting content (e.g., content associated with a keystroke of keyboard 718 and/or text 906 in FIGS. 9E-9F) (e.g., alphanumeric text, symbols, characters, and/or punctuation marks) into the input field. In some embodiments, the keyboard user interface (and/or the input field) is displayed in a three-dimensional environment (or, optionally, a two-dimensional environment). In some embodiments, the keyboard user interface (and/or the input field) is displayed in an augmented reality environment. In some embodiments, the keyboard user interface (and/or the input field) is displayed in an extended reality environment or a virtual reality environment. In some embodiments, the keyboard user interface is displayed with a portion of an environment that is a virtual portion or a pass-through portion (e.g., video or optical pass-through) of the environment. Displaying the keyboard user interface for inputting content includes, in accordance with a determination that a portion (e.g., a physical portion, torso, shoulders, neck, chest, abdomen, back, and/or hips) of a person (e.g., a portion of the body of user 702) associated with the computer system (e.g., a user of the computer system and/or a person wearing, holding, touching, and/or operating the computer system) has (e.g., is physically positioned in) a first spatial arrangement (e.g., 1218a, 1218b, and/or 1218c) (e.g., position, orientation, shape, and/or size), the computer system displaying (1306) the keyboard user interface at a first distance from (or, optionally, a first position relative to and/or a first orientation relative to) the input field (e.g., the distance between 718 and 712 depicted in FIGS. 12C-12E, 12I, 12M, 12S, and 12T). In some embodiments, the distance of the keyboard user interface from the input field is a distance along one or more axes of a coordinate system, such as a three-dimensional coordinate system and/or a two-dimensional coordinate system. Displaying the keyboard user interface for inputting content includes, in accordance with a determination that the portion of the person associated with the computer system has a second spatial arrangement (e.g., 1218a, 1218b, and/or 1218c), different from the first spatial arrangement, the computer system displaying (1308) the keyboard user interface at a second distance from (e.g., the distance between 718 and 712 depicted in FIGS. 12C-12E, 12I, 12M, 12S, and 12T) (or, optionally, has a second position relative to and/or has a second orientation relative to) the input field that is different from the first distance (e.g., 718 is displayed closer to 712 when 702 is 1218c as compared to when 702 is in position 1218a) (e.g., the second distance is further from or closer to the input field). In some embodiments, a spatial arrangement is a spatial arrangement in a three-dimensional environment (e.g., a physical environment). In some embodiments, the portion of the person has the first spatial arrangement when the portion of the person occupies a region having a shape and/or a volume that is different from a shape and/or a volume of a region that is occupied when the portion of the person has the second spatial arrangement. In some embodiments, the portion of the person has the first spatial arrangement when the portion of the person has a first position (e.g., location and/or orientation) that is different from a position of the portion of the person in the second spatial arrangement. In some embodiments, the first spatial arrangement and/or the second arrangement are relative to a physical environment and/or an object in the physical environment. In some embodiments, the first spatial arrangement and/or the second arrangement are relative to a direction of gravity. In some embodiments, the first spatial arrangement and/or the second arrangement are relative to the computer system. In some embodiments, the first spatial arrangement and/or the second arrangement are relative to a physical portion of the person (e.g., head, torso, shoulders, neck, chest, abdomen, back, and/or hips). In some embodiments, the first spatial arrangement and/or the second arrangement are a spatial arrangement of a first physical portion of the person (e.g., head, torso, shoulders, neck, chest, abdomen, back, and/or hips) relative to a spatial arrangement of a second physical portion of the person that is different from the first physical portion of the person (e.g., the first and second spatial arrangements are based on a spatial arrangement of the person's head relative to the spatial arrangement of the person's chest). In some embodiments, a spatial arrangement of the portion of the person is based on data detected via the one or more sensors, such as depth and/or image sensors, that capture data (e.g., image and/or depth data) that represents a physical environment (e.g., the spatial arrangement is an estimated position of the portion of the person that is determined based on measurements of the physical environment captured by one or more sensors of the computer system). In some embodiments, the first spatial arrangement is a position of a representation (e.g., an avatar) of the person in a virtual environment. In some embodiments, the position of the representation of the person in the virtual environment is determined based on an estimated position of the person in a physical environment (e.g., a non-virtual environment). Detecting an event associated with an input field and, in response, conditionally displaying a keyboard user interface at different distances from the input field depending on whether a person associated with the computer system has a first spatial arrangement or a second arrangement, different from the first spatial arrangement, performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body.

In some embodiments, detecting the event associated with the input field includes detecting an input (e.g., 1203b, 1205b, 1203h, 1205h, 12031, 12051, 1203p, and/or 1205p) (e.g., a press of a button, an air gesture, and/or a touch input) directed toward the input field (e.g., an input selecting the input field and/or an input that is directed at a location that corresponds to a location of the input field, such as an air gesture detected while attention is directed toward the input field). Detecting an input directed at the input field and, in response, conditionally display a keyboard user interface at different distances from the input field depending on whether a person associated with the computer system has a first spatial arrangement or a second arrangement, different from the first spatial arrangement, performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body when an input is directed at the input field.

In some embodiments, detecting the event associated with the input field includes detecting a change in position of a user interface (e.g., 1203m, 1205m1, 1205m2, 1203n, 1205n1, and/or 1205n2) (e.g., a change in position of an application window and/or a system user interface element) that includes the input field (e.g., 710 has moved between FIG. 12M and FIG. 12N) (e.g., that the user interface that includes the input field has moved from a first user interface position to a second user interface position that is different from the first user interface position). In some embodiments, detecting the event associated with the input field includes detecting an input corresponding to a request to move the user interface that includes the input field (e.g., in response to detecting the input corresponding to the request to move the user interface that includes the input field, the computer system moves the user interface that includes the input field and displays the keyboard user interface). Detecting the event associated with the input field includes detecting a change in position of a user interface that includes the input field and, in response, conditionally displaying a keyboard user interface at different distances from the input field depending on whether a person associated with the computer system has a first spatial arrangement or a second arrangement, different from the first spatial arrangement, performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body when the user interface is moved.

In some embodiments, detecting the event associated with the input field includes detecting a request (e.g., 1203p and 1205p) to initiate display of (e.g., a request to start displaying and/or a request to begin display of) a user interface (e.g., 710) that includes the input field (e.g., 710 is displayed in FIG. 12Q in response to 1203p and 1205p) (e.g., the computer system displays the keyboard user interface in response to detecting a request to display the user interface that includes the input field). In some embodiments, detecting a request to initiate display of the user interface that includes the input field includes an input (e.g., a mouse click, an air gesture, and/or a touch input) directed at a graphical object (e.g., icon, banner, application icon, and/or application window) associated with the user interface that includes the input field. Detecting a request to initiate display of the user interface that includes the input field and, in response, conditionally display a keyboard user interface at different distances from the input field depending on whether a person associated with the computer system has a first spatial arrangement or a second arrangement, different from the first spatial arrangement, performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body when the user interface is initially displayed.

In some embodiments, displaying the keyboard user interface at the first distance from the input field includes displaying the keyboard user interface at a respective keyboard position (e.g., 1213h and/or 1213i) (e.g., location and/or orientation). In some embodiments, displaying the keyboard user interface at the respective keyboard position includes, in accordance with a determination that a respective portion (e.g., 712) (e.g., visual element, graphical object, a reference point, and/or a particular portion) of a user interface (e.g., 710) that includes the input field is at a first location (e.g., the position of 712 in FIG. 12Q) (e.g., position and/or orientation), the computer system displaying the keyboard user interface at a first keyboard position (e.g., 1213h). In some embodiments, the portion of the user interface is an edge (e.g., top, bottom, left, and/or right edge) of the user interface. In some embodiments, the portion of the user interface is an input field of the user interface (e.g., the selected input field). In some embodiments, displaying the keyboard user interface at the respective keyboard position includes, in accordance with a determination that the respective portion of the user interface that includes the input field is at a second location (e.g., the position of 712 in FIG. 12R), different from the first location (e.g., the position of 712 in FIG. 12R is lower than the position of 712 in FIG. 12Q), the computer system displaying the keyboard user interface at a second keyboard position (e.g., 1213i) that is different from the first keyboard position (e.g., 1213i is lower than 1213h along the vertical axis) (e.g., the keyboard has the same distance relative to the input field but the location of the keyboard user interface is based on a location of a portion and/or reference point in the user interface). Conditionally displaying a keyboard user interface at different keyboard positions based on a location of a respective portion of the user interface performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body when a portion of the user interface has different locations.

In some embodiments, the respective portion of the user interface is the input field (e.g., as described in FIGS. 12B-12C, X700 displays 718 based on a top edge of 712) (e.g., the keyboard has the same distance relative to the input field but the location of the keyboard user interface is based on a location of the input field). Conditionally displaying a keyboard user interface at different locations based on a location of the input field performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body when the input field has different locations.

In some embodiments, displaying the keyboard user interface at the first distance includes displaying the keyboard user interface at an offset amount (e.g., as described in FIG. 12C, X700 displays 718 based on offsetting 718 from a top edge of 712) (e.g., a non-zero predetermined offset amount, an offset distance, and/or an offset angle) from the input field. In some embodiments, the keyboard user interface is offset from the input field in one or more dimensions (e.g., angle, distance, height, width, and/or length). In some embodiments, the one or more dimensions are with respect to a location of the input field. Displaying the keyboard user interface at an offset amount from the input region reduces the number of inputs needed to perform an operation, improves the placement of the keyboard user interface with respect to the input field, and increases the accuracy of predicting where the keyboard user interface should be displayed so as to avoid displaying the keyboard user interface at a position that intersects a portion of the person's body.

In some embodiments, the offset amount is relative to a vector (e.g., 1204) (e.g., a line) from a portion (e.g., the head and/or eyes of 702) (e.g., body part, head, eyes, and/or hands) of the person to the input field (e.g., as described with respect to FIG. 12B, vector 1204 intersects a portion of 702 and 712). In some embodiments, offsetting the keyboard user interface from the input field includes offsetting the keyboard user interface based on an angle (e.g., 15 degrees, 25 degrees, 38 degrees, 45 degrees, and/or 60 degrees) relative to the vector from the portion of the person to the input field. In some embodiments, the one or more dimensions include an angle selected from a range of angles (e.g., 35 degrees to 43 degrees, 32 degrees to 46 degrees, 28 degrees to 48 degrees, and/or 18 degrees to 58 degrees). In some embodiments, the vector from the portion of the person to the input field is perpendicular to (e.g., normal to and/or 90 degrees relative to) a plane (e.g., viewing pane) of the input field and/or a user interface associated with the input field. In some embodiments, in accordance with a determination that the vector from the portion of the person to the input field is a first vector (e.g., at a first vector location), the computer system displays the keyboard user interface at a respective keyboard location. In some embodiments, in accordance with a determination that the vector from the portion of the person to the input field is a second vector (e.g., at a second vector location that is different from first vector location) that is different from the first vector, the computer system displays the keyboard user interface at a keyboard location that is different from the respective keyboard location. Offsetting the keyboard user interface based on a vector from the portion of the person to the input field reduces the number of inputs needed to perform an operation and increases the accuracy of predicting where the keyboard user interface should be displayed so as to avoid displaying the keyboard user interface at a position that intersects a portion of the person's body.

In some embodiments, displaying the keyboard user interface at the first distance (e.g., the distance between 718 and 712 in FIG. 12R) includes aligning (e.g., visually, spatially, vertically, and/or horizontally) the keyboard user interface with a boundary (e.g., a bottom boundary of 710) (e.g., top boundary, bottom boundary, left boundary, and/or right boundary) of the user interface that includes the input field (e.g., 718 is immediately adjacent to the bottom boundary of 710 in FIG. 12R) (e.g., the boundary of the keyboard user interface appears next to (e.g., immediately adjacent to) and/or in line with a boundary of the user interface). In some embodiments, aligning the keyboard user interface with a boundary of the user interface that includes the input field includes: displaying the keyboard user interface such that a portion (e.g., a top edge and/or a bottom edge) of the keyboard user interface is parallel with the boundary of the user interface that includes the input field; and/or displaying the keyboard user interface such that a center of the keyboard user interface and a center of the user interface that includes the input field are on a common line (e.g., a line that is vertical relative to a physical, virtual, and/or XR environment). In some embodiments, aligning the boundary of the keyboard user interface with a boundary of the user interface includes aligning the boundary of the keyboard user interface with the boundary of the user interface (e.g., the boundary of the keyboard user interface appears to be aligned with the boundary of the user interface but is displayed at a different position, such as a different height, depth, and/or in a different plane). In some embodiments, aligning the boundary of the keyboard user interface with the boundary of the user interface includes aligning the boundary of the keyboard user interface on a line that intersects (e.g., extends through and/or passes through) a body part (e.g., head, eyes, and/or hands) of the person and the boundary of the user interface. In some embodiments, in accordance with a determination that the boundary of the user interface that includes the input field is at a first boundary location, the computer system displays the keyboard user interface at a respective keyboard location. In some embodiments, in accordance with a determination that the boundary of the user interface that includes the input field is at a second boundary location different from the first boundary location, the, the computer system displays the keyboard user interface at a keyboard location that is different from the respective keyboard location. Displaying the keyboard user interface at different locations based on aligning the keyboard user interface with a location of a boundary of the user interface performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body when a boundary of the keyboard user interface is at different locations.

In some embodiments, aligning the keyboard user interface with the boundary of the user interface that includes the input field includes aligning a portion of the keyboard user interface (e.g., a top boundary of 718) (e.g., a boundary of the keyboard user interface and/or a specific part of the keyboard user interface) with a bottom boundary (e.g., a bottom boundary of 710) (e.g., lower most edge) of the user interface that includes the input field (e.g., a top boundary of 718 is immediately adjacent to the bottom boundary of 710 in FIG. 12R). In some embodiments, a top portion of the keyboard user interface is aligned with the bottom boundary of the user interface that includes the text field. Aligning a portion of the keyboard user interface that includes the input field with a bottom boundary of the user interface reduces the number of inputs needed to perform an operation and increases the accuracy of predicting where the keyboard user interface should be displayed so as to avoid displaying the keyboard user interface at a position that intersects a portion of the person's body when a boundary of the keyboard user interface is at different locations.

In some embodiments, displaying the keyboard user interface at the first distance from the input field includes displaying the keyboard user interface at a respective position (e.g., 1213h and/or 1213i). In some embodiments, displaying the keyboard user interface at the respective position includes, in accordance with a determination that the input field of the user interface is at a first input field location (e.g., the location of 712 in FIG. 12Q) (e.g., position and/or orientation), the computer system displays the keyboard user interface at a first offset amount from the input field (e.g., 718 is displayed based on angle sigma (σ) relative to vector 1204 in FIG. 12Q) (e.g., without aligning the keyboard user interface with a boundary of the user interface). In some embodiments, the first input field location is within a threshold distance (e.g., an angular distance and/or a linear distance) of a top edge of the user interface that includes the input field. In some embodiments, the first input field location is in a top half of the user interface that includes the input field (e.g., and is not in a bottom half of the user interface). In some embodiments, displaying the keyboard user interface at the respective position includes, in accordance with a determination that the input field of the user interface is at a second input field location (e.g., the location of 712 in FIG. 12R), different from the first input field location, the computer system aligns (e.g., visually, spatially, vertically, and/or horizontally) the keyboard user interface with a boundary (e.g., the bottom boundary of 710) (e.g., top boundary, bottom boundary, left boundary, and/or right boundary) of the user interface (e.g., without offsetting the keyboard user interface from the input field by the respective amount) that includes the input field (e.g., the top boundary of 718 is immediately adjacent to the bottom boundary of 710 in FIG. 12R). In some embodiments, the second input field location is within a threshold distance (e.g., 0.5 inch, 1 inch, and/or 2 inches) of a bottom edge of the user interface that includes the input field. In some embodiments, the second input field location is in the bottom half of the user interface that includes the input field (e.g., and is not in the top half of the user interface). In some embodiments, the first input field location is closer to a top edge of the user interface that includes the input field as compared to the second input field location. In some embodiments, the second input field location is closer to the bottom edge of the user interface that includes the input field as compared to the first input field location. In some embodiments, the input field is a text entry field that is configured to receive alphanumerical text in response to the computer system detecting an input via the keyboard user interface (and/or via a hardware keyboard). In some embodiments, the input field is an input region that receives content (alphanumeric text and/or images). In some embodiments, the input field is a document of a word processing application. In some embodiments, the input field is a message compose region of a communication application. In some embodiments, the input field is a text box that is configured to receive text information. Conditionally offsetting the keyboard user interface from the input field by an offset amount or aligning the keyboard user interface with a boundary of the user interface when an input field is in different locations performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body when an input field has different locations in the user interface.

In some embodiments, displaying the keyboard user interface at the second distance from the input field (e.g., 1213i in FIG. 12R) includes the computer system displaying the keyboard user interface at a position that is closer to the input field than when the keyboard user interface is displayed at the first distance from the input field (e.g., 1213i in FIG. 12R is closer to 712 than 1213h in FIG. 12Q) (e.g., the second distance is less than the first distance). Conditionally displaying a keyboard user interface closer to the input field based on the person associated with the computer system having different spatial arrangements performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body.

In some embodiments, displaying the keyboard user interface at the second distance from the input field includes the computer system displaying the keyboard user interface at a keyboard position that does not overlap (e.g., as described throughout FIGS. 12A-12T, X700 does not display 718 at a position that overlaps with 1206) (e.g., does not intersect and/or fall within) a body region (e.g., 1206) (e.g., a torso region and/or a virtual region) associated with the portion of the person (e.g., 1206 is based on a position of 702) (e.g., a three-dimensional volume surrounding the portion of the person that is based on the position, size, shape, and/or orientation of the portion of the person), wherein the keyboard position is selected (e.g., X700 determines a position to display 718 so that 718 does not overlap with 1206) (e.g., determined by the computer system) to avoid overlapping with the body region (e.g., as described and depicted throughout FIGS. 12A-12T) (e.g., based on a position of the body portion). In some embodiments, the computer system displays the keyboard user interface so as to avoid a restricted region (e.g., the body region). In some embodiments, the body region is a three-dimensional region. Displaying the keyboard user interface at a keyboard position that does not overlap a body region associated with the portion of the person, the keyboard position is selected to avoid overlapping with the body region, reduces the number of inputs needed to perform an operation and increases the accuracy of predicting where the keyboard user interface should be displayed so as to avoid displaying the keyboard user interface at a position that intersects a portion of the person's body.

In some embodiments, displaying the keyboard user interface includes, in accordance with a determination that the portion of the person associated with the computer system has a first position (e.g., 1218a, 1218b, and/or 1218c) (e.g., a first location and/or first pose in a physical environment), the computer system displaying the keyboard user interface at a first location (e.g., 1213a, 1213b, and/or 1213c) that is determined based on the body region having a first body region position (e.g., 1216a, 1216b, and/or 1216c). In some embodiments, displaying the keyboard user interface includes, in accordance with a determination that the portion of the person associated with the computer system has a second position (e.g., 1218a, 1218b, and/or 1218c) (e.g., a second location and/or second pose in a physical environment), different from the first position, the computer system displaying the keyboard user interface at a second location (e.g., 1213a, 1213b, and/or 1213c) that is different from the first location and is determined based on the body region having a second body region position (e.g., 1216a, 1216b, and/or 1216c) that is different from the first body region position (e.g., as depicted in FIGS. 12B-12E, X700 displays 718 at different positions based on position of 1206) (e.g., when the portion of the person changes position, the keyboard user interface will be displayed at different locations that are based on different positions of the body region). Displaying the keyboard user interface at different locations based on a position of a portion of the person associated with the computer system, where the different locations are determined based on different body region positions, performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body.

In some embodiments, displaying the keyboard user interface includes, in accordance with a determination that the portion of the person (e.g., a portion of the body of 702) (e.g., a physical portion, torso, shoulders, neck, chest, abdomen, back, and/or hips) has a first body orientation (e.g., 1218a, 1218b, and/or 1218c) (e.g., location, pose, and/or position in physical space), the computer system displaying the keyboard user interface at a first keyboard location (e.g., 1213a, 1213b, and/or 1213c) that is determined based on the body region (e.g., 1206) having a first body region orientation (e.g., 1216a, 1216b, and/or 1216c) corresponding to the first body orientation (e.g., as depicted in FIGS. 12B-12E, the position of 1206 changes when the position of 702 changes). In some embodiments, displaying the keyboard user interface includes, in accordance with a determination that the portion of the person has a second body orientation (e.g., 1218a, 1218b, and/or 1218c), different from the first body orientation, the computer system displaying the keyboard user interface at a second keyboard location (e.g., 1213a, 1213b, and/or 1213c) that is different from the first keyboard location and is determined based on the body region (e.g., 1206) having a second body region orientation (e.g., 1216a, 1216b, and/or 1216c) corresponding to the second body orientation, wherein the second body region orientation is different from the first body region orientation (e.g., the position of 1206 is different throughout FIGS. 12B-12E; as depicted in FIGS. 12B-12E, 1206 rotates based on 702 having a non-reclining position, partially reclining position, or a fully reclining position) (e.g., the body region has different orientations when the portion of the person has different orientations, which results in displaying the keyboard user interface at different keyboard locations). Displaying the keyboard user interface at different locations that are determined based on different orientations of the body region that correspond to the body orientation, where the keyboard user interface is displayed at different locations based on an orientation of a portion of the person associated with the computer system performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body.

In some embodiments, displaying the keyboard user interface includes, in accordance with a determination that the keyboard position is a first distance from a first portion of the person (e.g., when 718 is displayed at a position near the neck and/or chest of 702) (e.g., a person's head, neck, and/or shoulder), displaying the keyboard user interface at a first keyboard location (e.g., a keyboard location that corresponds a neck and/or chest area of 702) that corresponds to a first radius around the person (e.g., X700 displays 718 based on a radius of 1206 near the neck and/or chest of 702). In some embodiments, the first radius is a radius of an arch of the body region that is positioned in an area corresponding to a shoulder area and/or a chest area of the person. In some embodiments, displaying the keyboard user interface includes, in accordance with a determination that the keyboard position is a second distance from the first portion of the person (e.g., when 718 is displayed at a position near the stomach and/or hips of 702), displaying the keyboard user interface at a second keyboard location (e.g., a keyboard location that corresponds a stomach and/or hip area of 702) (e.g., different from the first keyboard location) that corresponds to a second radius around the person (e.g., X700 displays 718 based on a radius of 1206 near the stomach and/or hips of 702), wherein the second radius is greater (e.g., farther from the person) than the first radius (e.g., as described in FIG. 12B, the radius of 1206 is greater near the stomach and/or hips of 702 as compared to the radius of 1206 near the neck and/or chest of 702) (e.g., the radius is greater at the second distance than the first distance). In some embodiments, the second radius is a radius of an arch of the body region that is positioned in an area corresponding to a chest area and/or a stomach area of the person. In some embodiments the first keyboard location is closer to a physical portion the person than the second keyboard location (e.g., the body region is smaller near the person's shoulders as compared to the body region near the person's chest, which results in displaying the keyboard user interface closer to the person's body when the keyboard user interface is displayed closer to the person's shoulder). In some embodiments, the first keyboard location is closer to a shoulder portion of the person than the second keyboard location. In some embodiments, the first portion of the body region is smaller (e.g., has a smaller diameter, occupies a smaller area, and/or occupies a smaller volume) than the second portion of the body region. In some embodiments, a cross-sectional area of the body region increases as the body region extends away from a neck area of the person and toward a hip area of the person. In some embodiments, an area (and/or volume) occupied by body region increases as the body region extends from first portion of the person (e.g., a head, neck, and/or shoulder) toward a second portion of the portion (e.g., chest, stomach, hips, and/or feet), where the first portion of the person is located closer to a shoulder portion of the person relative to a location of the second portion of the person. In some embodiments, one or more dimensions (e.g., radius, circumference, length, width, and/or depth) of the body region increases as the body region extends from a first portion of the person (e.g., a head, neck, and/or shoulder) toward a second portion of the portion (e.g., chest, stomach, hips, and/or feet). Conditionally displaying the keyboard user interface at different radii based on a distance from a first portion of the person performs an operation when a set of conditions has been met without requiring further user input and increases the accuracy of predicting where the keyboard user interface should be displayed so as to avoid displaying the keyboard user interface at a position that intersects a portion of the person's body.

In some embodiments, displaying the keyboard user interface includes, in accordance with a determination that the portion of the person (e.g., a physical portion, torso, shoulders, neck, chest, abdomen, back, and/or hips) has a first body orientation (e.g., 1218a, 1218b, and/or 1218c) (e.g., pose, location and/or position in physical space), the computer system displaying the keyboard user interface (e.g. 718) at a first keyboard location (e.g., 1213a, 1213b, and/or 1213c) that is determined based on a first angle (e.g., angle lambda (λ) of 1206 in FIGS. 12C-12E) that is measure relative to a respective portion of the person (e.g., 1210a and/or a torso of 702) (e.g., head, neck, and/or shoulders). In some embodiments, the first keyboard location is determined based on a first size of the body region. In some embodiments, displaying the keyboard user interface includes, in accordance with a determination that the portion of the person has a second body orientation (e.g., 1218a, 1218b, and/or 1218c), different from the first body orientation, the computer system displaying the keyboard user interface at a second keyboard location (e.g., 1213a, 1213b, and/or 1213c) that is different from the first keyboard location, wherein the second keyboard location is determined based on the first angle (e.g., angle lambda (λ) of 1206 in FIGS. 12C-12E) that is measure relative to the respective portion of the person (e.g., X700 determines 1206 based on angle lambda (λ) of 1206 FIGS. 12C-12E even though 1206 has different positions throughout FIGS. 12C-12E) (e.g., an angle that forms a body region remains the same and/or is independent of the orientation of the person's torso). In some embodiments, the second keyboard location is determined based on the first size of the body region. In some embodiments, displaying the keyboard user interface at the first keyboard location and the second keyboard location is based on at least one fixed dimension (e.g., angle, radius, circumference, length, width, and/or height) of the body region, where the fixed dimension is measured with respect to a respective portion of the person (e.g., head, neck, and/or shoulders). In some embodiments, the body region extends from a first portion of the person (e.g., head, neck, and/or shoulders) toward a second portion of the person (e.g., chest, stomach, and/or hips) based on at least one dimension that is measured with respect to a respective portion of the person, where the second portion is different from the first portion of the person. In some embodiments, the body region has a fixed size and/or shape. In some embodiments, the body region is a cone (e.g., a right circular cone) that has an apex (and/or vertex) that is positioned at a neck area of the person. In some embodiments, the first angle is an opening angle and/or a vertex angle of a cone and is within the range of 12 degrees to 15 degrees. Displaying the keyboard user interface based on the same angle that is measure relative to the respective portion of the person even though the orientation of the person changes performs an operation when a set of conditions has been met without requiring further user input and increases the accuracy of predicting where the keyboard user interface should be displayed so as to avoid displaying the keyboard user interface at a position that intersects a portion of the person's body.

In some embodiments, the computer system displays, via the one or more display generation components, the keyboard user interface at a first keyboard location (e.g., 1213b in FIG. 12D) that is determined based on a first size of the body region (e.g., the size of 1206 in FIG. 12D) (or, optionally, the keyboard user interface is displayed at a first keyboard location that is determined based on a first angle that is measure relative to a respective portion of the person (e.g., head, neck, and/or shoulders)). After displaying the keyboard user interface at the first keyboard location and in accordance with a determination that the body region has change from the first size to a respective size that is different from the first size (e.g., X700 determines the size of 1206 is smaller in FIGS. 12F-12I) (or, optionally, changed from the first angle to a respective angle that is different from the first angle), the computer system displays, via the one or more display generation components, the keyboard user interface at a respective keyboard location (e.g., 1213d) that is different from the first keyboard location and is determined based on the respective size of the body region (e.g., X700 displays 718 at 1213d based on the size of 1206 in FIGS. 12F-12I instead of based on the size of 1206 in FIG. 12D) (e.g., the body region size and/or angle is dynamic, causing the keyboard user interface to be displayed in different locations). In some embodiments, after displaying the keyboard user interface at the first keyboard location and in accordance with a determination that the body region has not changed to a respective size that is different from the first size, displaying, via the one or more display generation components, the keyboard user interface at the first keyboard location. In some embodiments, the body region is a cone. In some embodiments, the size (and/or shape) of cone is modified when an angle of the cone changes. In some embodiments, an angle (e.g., opening angle and/or vertex angle) of the conical shape is an angle that is within a range of 10 degrees to 20 degrees. In some embodiments, the dimension is an angle that is measured with respect to a coronal plane (e.g., a plane that divides the person into an anterior portion and a posterior portion) and/or a sagittal plane (e.g., a plane that divides the person into a left portion and a right portion). In some embodiments, the dimension is based on an angle of a line that intersects the coronal plane at a neck area of the person and is within the range of 10 degrees to 20 degrees of the coronal plane. In some embodiments, the body region is a cone (e.g., a right circular cone) that has an apex (and/or vertex) that is positioned at a neck area of the person. Displaying the keyboard user interface at the first keyboard location that is determined based on a first size of the body region and, after displaying the keyboard user interface at the first keyboard location, conditionally displaying the keyboard user interface at a different location that is determined based on the respective size when the size of the body region has changed to the respective size reduces the number of inputs needed to perform an operation and increases the accuracy of predicting where the keyboard user interface should be displayed so as to avoid displaying the keyboard user interface at a position that intersects a portion of the person's body.

In some embodiments, displaying the keyboard user interface at the respective keyboard location includes, in accordance with a determination that the portion of the person is a first size (e.g., X700 determines the chest and/or stomach area of user 702 in FIGS. 12A-12T occupies a first volume) (e.g., has a first dimension and/or occupies a first volume), the computer system displaying the keyboard user interface at a second keyboard location (e.g., 1213d, 1213e, and/or 1213i) that is determined based on the body region having a second size (e.g., the size of 1206 in FIGS. 12D, 12G, 12I, 12K, 12M, and/or 12S). In some embodiments, displaying the keyboard user interface at the respective keyboard location includes, in accordance with a determination that the portion of the person is a second size that is different from the first size (e.g., X700 determines the chest and/or stomach area of user 702 in FIGS. 12A-12T occupies a second volume that is different from the first volume) (e.g., has a second dimension and/or occupies a second volume that is larger and/or smaller than the first volume), the computer system displaying the keyboard user interface at a third keyboard location (e.g., 1213d, 1213e, and/or 1213i) that is different from the second keyboard location and is determined based on the body region having a third size (e.g., the size of 1206 in FIGS. 12D, 12G, 12I, 12K, 12M, and/or 12S) that is different from the second size (e.g., as depicted in FIGS. 12D, 12G, 12I, 12K, 12M, and/or 12S the size of 1206 changes size which results in displaying 718 at different keyboard locations) (e.g., the body region size is based on information about the size of the portion of the person, which causes the keyboard user interface to be displayed at different locations). Conditionally displaying the keyboard user interface at different positions using a different sizes of body regions and based on a size of the portion of the person performs an operation when a set of conditions has been met without requiring further user input, reduces the number of inputs needed to perform an operation and increases the accuracy of predicting where the keyboard user interface should be displayed so as to avoid displaying the keyboard user interface at a position that intersects a portion of the person's body.

In some embodiments, the computer system is in communication with one or more sensors (e.g., 1226) (e.g., one or more image sensors and/or one or more depth sensors). In some embodiments, displaying the keyboard user interface at the respective keyboard location includes, in accordance with a determination that a first set of one or more measurements (e.g., a length, width, and/or height of a chest and/or stomach of user 702 detected via 1226) (e.g., height, width, depth, radius, and/or angle) that are detected via the one or more sensors and indicates the portion of the person is a first size (e.g., based on the detected length, width, and/or height of the chest and/or stomach of user 702, device X700 determines the chest and/or stomach of user 702 occupies a first volume), the computer system displaying the keyboard user interface at a second keyboard location (e.g., 1213h and/or 1213i) that is based on a body region that is determined from the first set of one or more measurements (e.g., device X700 determines 1206 based on the detected length, width, and/or height of the chest and/or stomach of user 702). In some embodiments, displaying the keyboard user interface at the respective keyboard location includes, in accordance with a determination that a second set of one or more measurements that are detected via the one or more sensors (e.g., a length, width, and/or height of a chest and/or stomach of user 702 detected via 1226) (e.g., the second set of one or more measurements indicate the torso of the person is larger and/or smaller than the first set of one or more measurements) and indicates the portion of the person is a second size that is different from the first size (e.g., based on the detected length, width, and/or height of the chest and/or stomach of user 702, device X700 determines the chest and/or stomach of user 702 occupies a second volume that is different from the first volume), the computer system displaying the keyboard user interface at a third keyboard location (e.g., 1213h and/or 1213i) that is different from the second keyboard location and is determined based on a body region that is determined from the second set of one or more measurements (e.g., device X700 determines 1206 based on the detected length, width, and/or height of the chest and/or stomach of user 702) (e.g., the body region size changes based on measurements of the size of the portion of the person, which causes the keyboard user interface to be displayed in different locations). In some embodiments, a size of the body region is based on one or more measurements of a size of the portion of the person captured via one or more sensors (e.g., one or more image sensors and/or one or more depth sensors). In some embodiments, in accordance with a determination that the one or more measurements of the size of the portion of the person captured via one or more sensors correspond to a first size of the portion of the person, the size of the body region is a first body region size. In some embodiments, in accordance with a determination that the one or more measurements of the size of the portion of the person captured via one or more sensors correspond to a second size of the portion of the person, different from the first size of the portion of the person, the size of the body region is a second body region size that is different from the first body region size. In some embodiments, the computer system detects and/or estimates a position and/or size of the portion of the person, which is used to determine the size of the body region. Conditionally displaying the keyboard user interface at different locations based using measurements that indicate the portion of the person has different sizes, where the different locations of the keyboard user interface are based on a body region that is determined from the measurements, performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body.

In some embodiments, displaying the keyboard user interface at the respective keyboard location includes, in accordance with a determination that a first set of one or more user interactions (e.g., 1203d, 1205d1, 1205d2, 1203i, 1205i1, and/or 1205i2) (e.g., a set of one or more inputs previously detected via the one or more input devices) with the computer system indicates the portion of the person is a first size (e.g., X700 determines a size of user 702 based on moving 718 closer and/or farther from the body of user 702), displaying the keyboard user interface at a second keyboard location (e.g., 1213b, 1213d, and/or 1213e) and is based on a body region (e.g., 1206) that is determined from the first set of one or more user interactions (e.g., device X700 determines 1206 based user 702 moving keyboard 718 closer and/or farther from the body of user 702). In some embodiments, the first set of one or more user interactions includes an interaction with (e.g., moving) the keyboard user interface and/or one or more graphical elements displayed by the computer system. In some embodiments, displaying the keyboard user interface at the respective keyboard location includes, in accordance with a determination that a second set of one or more user interactions (e.g., 1203d, 1205d1, 1205d2, 1203i, 1205i1, and/or 1205i2) (e.g., a set of one or more inputs previously detected via the one or more input devices) with the computer system indicates the portion of the person is a second size (e.g., X700 determines a size of user 702 based on moving keyboard 718 closer and/or farther from the body of user 702), different from the first size, the computer system displaying the keyboard user interface at a third keyboard location (e.g., 1213b, 1213d, and/or 1213e) that is different from the second keyboard location and is based on a body region that is determined from the second set of one or more user interactions (e.g., device X700 determines 1206 based user 702 moving 718 closer and/or farther from the body of user 702) (e.g., the body region size is based on user interactions with the computer system that indicate the person's size, which causes the keyboard user interface to be displayed in different locations when the person has the same body orientation). In some embodiments, the second set of one or more user interactions includes an interaction with (e.g., moving) the keyboard user interface and/or one or more graphical elements displayed by the computer system. In some embodiments, the body region (e.g., a size and/or dimension of the body region) is based on one or more user interactions (e.g., a set of one or more inputs previously detected via the one or more input devices) with the computer system that indicate a size of the portion of the person (e.g., interactions with the keyboard user interface and/or one or more graphical elements displayed by the computer system). In some embodiments, computer system infers the size of a torso area of the person based on behavior of the person with the keyboard user interface and/or other graphical elements. In some embodiments, the computer system infers a torso area of the person based on different user interactions and/or based on user interactions across different applications. Conditionally displaying the keyboard user interface at different locations based on different user interactions that indicate a size of the portion of the person, where the different locations of the keyboard user interface are based on a body region that is determined from the user interactions that indicate a size of the portion of the person, performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body.

In some embodiments, the first set of one or more user interactions and/or the second set of one or more user interactions include a request to move the keyboard user interface (e.g., 1203d, 1205d1, 1205d2, 1203i, 1205i1, and/or 1205i2 move keyboard 718 closer and/or farther from the body of user 702) (e.g., relative to an estimated position of the portion of the person). In some embodiments, the computer system detects the request to move the keyboard user interface by detecting an input selecting a graphical object (e.g., an icon, a banner, and/or affordance) of the keyboard user interface while the keyboard user interface is at a first location (e.g., detecting a pinch gesture is made while user's attention (e.g., based on gaze) is directed toward the graphical object and/or detecting a touch input at location of the graphical object), detecting a subsequent movement of the input from a first position (e.g., a position at which the input was first detected (e.g., a position at which a pinch gesture was made and/or a position at which a touch-down event of a touch input occurred)) to a second position that is different from the first position while the input is maintained (e.g., a pinch gesture is maintained while the pinch gesture moves from the first position to the second position and/or physical contact is maintained while the touch input moves from the first position to the second position), and detecting that the input has ended (e.g., detecting the pinch gesture has ended and/or is no longer being maintained; and/or detecting that physical contact of the touch input has ended and/or is no longer being maintained) when the keyboard user interface is at the second position. In some embodiments, the computer system detects the request to move the keyboard user interface by detecting a movement of the position of the portion of the person while the keyboard user interface is selected (e.g., is selected for movement). In some embodiments, detecting the request to move the keyboard user interface includes detecting an input selecting a portion (e.g., an icon, a banner, and/or affordance) of the keyboard user interface while a portion of the person is in a first position, detecting a movement of the portion of the person from the first position to a second position, different from the first position, while the input is maintained (e.g., a pinch gesture is maintained while the person moves and/or physical contact is maintained while the person moves), and detecting the input has ended (e.g., detecting the pinch gesture has ended and/or is no longer being maintained; and/or detecting that physical contact of the touch input has ended and/or is no longer being maintained) when the portion of the person is in the second position. In some embodiments, the estimated position is not based one or more measurements of a size of the portion of the person captured via one or more sensors. In some embodiments, the estimated location is not based the computer system detecting, via one or more sensors, one or more locations of a torso area of the person. Including a request to move the keyboard user interface as a user interaction that indicates the portion of the person is a particular size performs an operation when a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body.

In some embodiments, the computer system detects, via one or more input devices, a second event (e.g., 1203b, 1205b, 1203h, 1205h, 1203i, 1205i1, 1205i2, 1203m, 1205m1, 1205m2, 1203n, 1205n1, 1205n2, 1203p, and/or 1205p) associated with the input field. In response to detecting the second event associated with the input field, the computer system displays, via the one or more display generation components, a respective keyboard user interface (e.g., 718 and/or 918) including, in accordance with a determination that a previously displayed keyboard user interface was moved (e.g., 718 was moved from 1213b to 1213d across FIGS. 12D and 12F), based on one or more inputs (e.g., 1203d, 1205d1, and/or 1205d2) (e.g., a touch input, an air gesture, a button press, a gaze, and/or a speech input), to a location (e.g., 1213d) that was closer than a threshold distance (e.g., 1213d is closer than a threshold distance of 3 inches, 6 inches, and/or 12 inches from the body of 702) from the portion of the person (e.g., 718 was moved to 1213d, which is closer to the body of user 702 than a threshold distance of 3 inches, 6 inches, and/or 12 inches from the body of 702), the computer system displays the respective keyboard user interface closer than the threshold distance from the portion of the person (e.g., device X700 displays keyboard 718 at keyboard position 1213d, which is closer to the body of user 702 than the threshold distance of 3 inches, 6 inches, and/or 12 inches). In some embodiments, in response to detecting the second event associated with the input field, the computer system displays, via the one or more display generation components, a respective keyboard user interface (e.g., 718 and/or 918) including, in accordance with a determination that the previously displayed keyboard user interface was last displayed further than the threshold distance from the portion of the person (e.g., device X700 determines keyboard 718 was previously displayed at a keyboard position that is farther from the body of user 702 than the threshold distance of 3 inches, 6 inches, and/or 12 inches), displaying the respective keyboard user interface further than the threshold distance from the portion of the person (e.g., device X700 displays keyboard 718 at a keyboard position that is farther from the body of user 702 than the threshold distance of 3 inches, 6 inches, and/or 12 inches). In some embodiments, in accordance with a determination that the previously displayed keyboard user interface was last displayed at a location that does not overlap with a location of the body region, the computer system displays the respective keyboard user interface at the last displayed location (e.g., the location that does not overlap with the location of the body region) and is displayed independent of the threshold distance from the portion of the person. In some embodiments, the threshold distance from the portion of the person is based on the position of the body region. In some embodiments, a size and/or shape of the body region is updated in response to a previously displayed keyboard user interface being moved, based on one or more inputs, to a location that was closer to the portion of the person. Detecting an event associated with the input field and, in response, conditionally displaying the respective keyboard user interface closer or further than a threshold distance based on whether a previously displayed keyboard user interface was moved to a location that was closer than the threshold distance from the portion of the person or whether the previously displayed keyboard user interface was last displayed further than the threshold distance from the portion of the person performs an operation a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body.

In some embodiments, the computer system detects, via one or more input devices, a third event (e.g., 1203b, 1205b, 1203h, 1205h, 1203i, 1205i1, 1205i2, 1203m, 1205 m1, 1205m2, 1203n, 1205n1, 1205n2, 1203p, and/or 1205p) associated with the input field. In response to detecting the third event associated with the input field, the computer system displays, via the one or more display generation components, a respective keyboard user interface (e.g., 718 and/or 918) including, in accordance with a determination that a previously displayed keyboard user interface was moved (e.g., 718 was moved from 1213d to 1213e across FIGS. 12I-12J), based on one or more inputs (e.g., 1203i, 1205i1, 1205i2) (e.g., a touch input, an air gesture, a button press, a gaze, and/or a speech input), to a location (e.g., 1213e) that was further from a threshold distance from the portion of the person (e.g., 1213e is further than a threshold distance of 3 inches, 6 inches, and/or 12 inches from the body of 702), the computer system displays the respective keyboard user interface further than the threshold distance from the portion of the person (e.g., device X700 displays keyboard 718 at keyboard position 1213e, which is further from the body of user 702 than the threshold distance of 3 inches, 6 inches, and/or 12 inches). In response to detecting the third event associated with the input field, the computer system displays, via the one or more display generation components, a respective keyboard user interface (e.g., 718 and/or 918) including, in accordance with a determination that the previously displayed keyboard user interface was last displayed closer than the threshold distance from the portion of the person (e.g., device X700 determines keyboard 718 was previously displayed at a keyboard position that is closer to the body of user 702 than the threshold distance of 3 inches, 6 inches, and/or 12 inches), the computer system displays the respective keyboard user interface closer than the threshold distance from the portion of the person (e.g., device X700 displays keyboard 718 the keyboard position that is closer to the body of user 702 than the threshold distance of 3 inches, 6 inches, and/or 12 inches). In some embodiments, in accordance with a determination that the previously displayed keyboard user interface was last displayed at a location that does not overlap with a location of the body region, the computer system displays the respective keyboard user interface at the last displayed location (e.g., the location that does not overlap with the location of the body region) and is displayed independent of the threshold distance from the portion of the person. In some embodiments, the threshold distance from the portion of the person is based on the position of the body region. In some embodiments, a size and/or shape of the body region is updated in response to a previously displayed keyboard user interface being moved, based on one or more inputs, to a location that was further from the portion of the person. Detecting an event associated with the input field and, in response, conditionally displaying the respective keyboard user interface further or closer than a threshold distance based on whether a previously displayed keyboard user interface was moved to a location that was further than a threshold distance from the portion of the person or whether the previously displayed keyboard user interface was last displayed closer than the threshold distance from the portion of the person performs an operation a set of conditions has been met without requiring further user input, reduces the number of inputs needed to perform an operation, and increases the accuracy of predicting where the keyboard user interface should be displayed so as to avoid displaying the keyboard user interface at a position that intersects a portion of the person's body.

In some embodiments, displaying the keyboard user interface at the first distance from the input field (e.g., and/or the second distance from the input field) includes the computer system displaying the keyboard user interface with a first set of one or more position parameters (e.g., one or more coordinates of an orientation of 718 in FIGS. 7A-7T; and/or the height, depth, and/or angle from 1204 of 1213b in FIG. 12D) (e.g., angle and/or coordinates on the virtual coordinate system, such as x-, y-, z-axis). In some embodiments, while displaying the keyboard user interface at the first distance from the input field (e.g., and/or the second distance from the input field), the computer system detects, via the one or more input devices, one or more inputs corresponding to a request to modify the first set of one or more position parameters (e.g., 750g, 950c2, 1203d, 1205d1, and/or 1205d2) (e.g., angle and/or coordinates on the virtual coordinate system, such as x-, y-, z-axis) of the keyboard user interface (e.g., 1203d, 1205d1, and/or 1205d2 adjust a height, depth, and/or angle from 1204 of 718 in FIG. 12D to the height, depth, and/or angle from 1204 of 718 depicted in FIG. 12F). In some embodiments, the one or more inputs corresponding to the request to modify the first set of one or more position parameters includes moving the keyboard user interface in a respective direction (e.g., up, down, left, and/or right) relative to the portion of the person. In some embodiments, the one or more inputs corresponding to the request to modify the first set of one or more position parameters includes moving the keyboard user interface in a respective direction (e.g., up, down, left, and/or right) relative to one or more graphical objects that are concurrently displayed with the keyboard user interface (e.g., an input field and/or a user interface). In some embodiments, the one or more inputs corresponding to the request to modify the first set of one or more position parameters of the keyboard user interface includes detecting an input selecting a graphical object (e.g., an icon, a banner, and/or affordance) of the keyboard user interface (e.g., detecting a pinch gesture is made while user's attention (e.g., based on gaze) is directed toward the graphical object and/or detecting a touch input at location of the graphical object) while the keyboard user interface is at a first position (e.g., relative to the portion of the person and/or relative to one or more object concurrently displayed with the keyboard user interface), detecting subsequent movement of the input in a respective direction (e.g., up, down, left, and/or right) while the input is maintained (e.g., a pinch gesture is maintained while the pinch gesture moves in the respective direction and/or physical contact is maintained while the touch input moves in the respective direction), and detecting that the input has ended (e.g., detecting the pinch gesture has ended and/or is no longer being maintained; and/or detecting that physical contact of the touch input has ended and/or is no longer being maintained) when the keyboard user interface is at a second position that is different from the first position. In response to detecting the one or more inputs corresponding to the request to modify the first set of one or more position parameters of the keyboard user interface, the computer system displays, via the one or more display generation components, the keyboard user interface with a second set of one or more position parameters (e.g., 718 has updated coordinates in FIGS. 7H and 71; and/or 718 has the height, depth, and/or angle from 1204 depicted in FIG. 12F) (e.g., angle and/or coordinates on the virtual coordinate system, such as x-, y-, z-axis) (in some embodiments, displaying the keyboard user interface with the second set of one or more position parameters includes displaying the keyboard user interface at a modified position different from the first position). After displaying the keyboard user interface with the second set of one or more position parameters (in some embodiments, at the modified keyboard position), the computer system detects, via the one or more input devices, a set of one or more inputs corresponding to the request to cease display of the keyboard user interface (e.g., 750i, 1203g, and/or 1205g) (e.g., corresponding to a request to stop displaying the keyboard user interface, corresponding to a user closing the respective application, one or more movements of a user, and/or a request to terminate a text entry session) (e.g., an air gesture, a user's gaze, a speech input, a touch input, and/or mouse click); In some embodiments, the set of one or more inputs corresponding to the request to cease display of the keyboard user interface includes an input to close the keyboard user interface, an input to close a user interface including an input field, and/or an input to terminate a text entry session. In some embodiments, detecting the set of one or more inputs corresponding to the request to cease display of the keyboard user interface includes the computer system detecting an input directed toward a close graphical object (e.g., a touch input at location of the close graphical object and/or a pinch gesture while user's attention (e.g., based on gaze) is directed toward the close graphical object) (e.g., an icon, a banner, and/or affordance) that, when selected, causes the computer system to close the keyboard user interface. In response to detecting the set of one or more inputs, the computer system ceases display of the keyboard user interface corresponding to a request to cease display of the keyboard user interface (e.g., as illustrated in FIG. 7J and/or FIG. 12H). While the keyboard user interface is not displayed, the computer system detects, via the one or more input devices, one or more inputs corresponding to a request (e.g., 750j, 1203h, and/or 1205h) (e.g., a set of one or more inputs and/or an event associated with the input field) to display the keyboard user interface (e.g., in a representation of a portion of the three-dimensional environment and/or in a virtual environment). In some embodiments, the one or more inputs corresponding to the request to display the keyboard user interface includes an input to display a user interface (e.g., a request to launch an application or a request to display a window) that includes an input field, an input interacting with a user interface (e.g., a system user interface, an application region, or an application window) that includes the input field, an input moving a user interface that includes the input field, and/or a request to add content to the input field. In some embodiments, detecting the one or more inputs corresponding to the request to display the keyboard user interface includes detecting an input directed toward an application icon (e.g., an widget and/or affordance) corresponding to an application that includes an input field (e.g., detecting a pinch gesture is made while user's attention (e.g., based on gaze) is directed toward the application icon and/or detecting a touch input at location of the application icon) and/or detecting an input directed toward an input field (e.g., detecting a pinch gesture is made while user's attention (e.g., based on gaze) is directed toward the input field and/or detecting a touch input at location of the input field). In response to detecting the one or more inputs corresponding to the request to display the keyboard user interface, the computer system displays, via the one or more display generation components, the keyboard user interface with a third set of one or more position parameters (e.g., coordinates of 718 in FIGS. 7K and 7L; and/or coordinates of 718 in FIG. 12I) (e.g., angle and/or coordinates on the virtual coordinate system, such as x-, y-, z-axis), wherein the third set of one or more position parameters includes at least one position parameter included in (e.g., based on and/or selected based on) the second set of one or more position parameters (e.g., 718 has the same depth and/or angle in FIGS. 7K and 7L; and/or 718 has the same height, depth, and/or angle relative to 1204 in FIGS. 12G and 121) (e.g., at least a portion, if not all, of the modified parameters are used when the keyboard user interface is redisplayed). In some embodiments, the third set of one or more position parameters is the same as the second (and/or the first) set of one or more position parameters. In some embodiments, the third set of one or more position is different from the second (and/or the first) set of one or more position parameters. Displaying the keyboard user interface with the third set of one or more position parameters that includes at least one position parameter included in the second set of one or more position parameters improves how the keyboard user interface is displayed in three-dimensional environment after one or more position parameters have been modified.

In some embodiments, aspects/operations of methods 800, 1000, 1100, and 1300 may be interchanged, substituted, and/or added between these methods. For example, methods 800, 1000, and 1100 include features of method 1300 for positioning a virtual keyboard based on a user's spatial arrangement. As a further example, methods 800, 1000, and 1100 include features related to displaying a virtual keyboard based on a torso zone. As a further example, methods 800, 1000, and 1100 include features related to determining a position of a virtual keyboard based on a size and/or position of a user's torso. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve how virtual keyboards are displayed and/or positioned. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to display or position virtual keyboards. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of displaying virtual keyboards, the present technology can be configured to allow users to select to “opt in” or “opt out” of participation in the collection of personal information data during registration for services or anytime thereafter. In another example, users can select not to provide data for customization of a position of a virtual keyboard. In yet another example, users can select to limit the length of time data is maintained or entirely prohibit the development of a customized position of a virtual keyboard. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, virtual keyboards can be displayed by inferring preferences based on non-personal information data or a bare minimum amount of personal information, such as the content being requested by the device associated with a user, other non-personal information available to the service, or publicly available information.

1.-124. (canceled)

125. A computer system configured to communicate with a display generation component and one or more input devices, comprising:
one or more processors; and
memory storing one or more programs configured to be executed by the one or more processors, the one or more programs including instructions for:
displaying, via the display generation component, a user interface that includes:
a representation of a portion of a three-dimensional environment; and
a representation of a respective application;
receiving, via the one or more input devices, a request to display a keyboard user interface in the representation of the portion of the three-dimensional environment; and
in response to receiving the request to display the keyboard user interface,
displaying, via the display generation component, the keyboard user interface at a respective keyboard position in the representation of the portion of the three-dimensional environment, wherein:
in accordance with a determination that a first set of keyboard placement criteria is satisfied, wherein the first set of keyboard placement criteria includes a first application criterion that is satisfied when the representation of the respective application has a first pose in the representation of the portion of the three-dimensional environment, the respective keyboard position is at a first keyboard position in the representation of the portion of the three-dimensional environment; and
in accordance with a determination that a second set of keyboard placement criteria is satisfied, wherein the second set of keyboard placement criteria includes a second application criterion that is satisfied when the representation of the respective application has a second pose in the representation of the portion of the three-dimensional environment, wherein the second pose is different from the first pose, the respective keyboard position is at a second keyboard position in the representation of the portion of the three-dimensional environment that is different from the first keyboard position in the representation of the portion of the three-dimensional environment.

126. The computer system of claim 125, wherein:
the first set of keyboard placement criteria is satisfied when the representation of the respective application that has the first pose is at a first angle, relative to a first reference line, that is greater than a first angle threshold; and
the first keyboard position is a position based on a line that intersects a body part of a user of the computer system and the representation of the respective application.

127. The computer system of claim 126, wherein:
the second set of keyboard placement criteria is satisfied when the representation of the respective application that has the second pose is at a second angle, relative to the first reference line, that is less than the first angle threshold; and
the second keyboard position is based on a horizon line of the three-dimensional environment.

128. The computer system of claim 125, wherein the first keyboard position is based on a position of a respective body part of a user of the computer system within the three-dimensional environment, including:
in accordance with a determination that the respective body part of the user of the computer system has a first position of the respective body part within the three-dimensional environment, the first keyboard position is a third keyboard position; and
in accordance with a determination that the respective body part of the user of the computer system has a second position of the respective body part within the three-dimensional environment that is different from the first position of the respective body part, the first keyboard position is a fourth keyboard position that is different from the third keyboard position.

129. The computer system of claim 128, wherein the position of the respective body part of the user of the computer system within the three-dimensional environment is a position relative to a floor of the three-dimensional environment and wherein a position of the floor is determined by the computer system.

130. The computer system of claim 128, wherein:
the third keyboard position is based on a first angle relative to a respective line; and
the fourth keyboard position is based on a second angle, different from the first angle, relative to the respective line.

131. The computer system of claim 130, wherein:
the first position of the respective body part of the user of the computer system is in a first range of positions within the three-dimensional environment; and
the second position of the respective body part of the user of the computer system is a second range of positions within the three-dimensional environment, different from the first range of positions.

132. The computer system of claim 130, wherein the first keyboard position is based on the position of the respective body part of the user of the computer system within the three-dimensional environment, including:
in accordance with a determination that the respective body part of the user of the computer system has a third position of the respective body part that is in a third range of positions within the three-dimensional environment that is different from the first position of the respective body part the second position of the respective body part, the first keyboard position is a fifth keyboard position that is different from the third keyboard position and the fourth keyboard position.

133. The computer system of claim 125, wherein the first keyboard position is based on a respective device position of the computer system within the three-dimensional environment, including:
in accordance with a determination that the computer system has a first position within the three-dimensional environment, the first keyboard position is a sixth keyboard position; and
in accordance with a determination that the computer system has a second position within the three-dimensional environment, the first keyboard position is a seventh keyboard position that is different from the sixth keyboard position.

134. The computer system of claim 133, wherein:
the first position of the computer system within the three-dimensional environment is a position relative to a first body part of a user of the computer system; and
the second position of the computer system within the three-dimensional environment is a position relative to the first body part of the user of the computer system.

135. The computer system of claim 133, wherein:
the first position of the computer system within the three-dimensional environment is a position relative to a physical object; and
the second position of the computer system within the three-dimensional environment is a position relative to a physical object.

136. The computer system of claim 125, wherein displaying the keyboard user interface at the first keyboard position is in accordance with a determination that a set of intersection criteria is satisfied, wherein the set of intersection criteria includes a criterion that is satisfied when the first keyboard position does not cause the keyboard user interface to intersect with at least a portion of a physical object in the representation of the portion of the three-dimensional environment; and
wherein displaying the keyboard user interface at the respective keyboard position in the representation of the portion of the three-dimensional environment further includes:
in accordance with a determination that the first set of keyboard placement criteria is satisfied and in accordance with a determination that the set of intersection criteria is not satisfied, the respective keyboard position is at an eighth keyboard position, different from the first keyboard position, in the representation of the portion of the three-dimensional environment.

137. The computer system of claim 125, wherein the keyboard user interface includes:
a first character key that, when selected, causes input of a first alphanumeric character; and
a second character key that, when selected, causes input of a second alphanumeric character, different from the first alphanumeric character.

138. The computer system of claim 125, wherein the keyboard user interface includes a respective interface object for suggested content, the one or more programs further including instructions for:
while displaying the keyboard user interface at the respective keyboard position, detecting, via a hardware keyboard, an input to add respective content; and
in response to detecting the input to add respective content:
in accordance with a determination that the respective content is first content, the respective interface object for first content includes first suggested content; and
in accordance with a determination that the respective content is second content, different from the first content, the respective interface object for suggested content includes second suggested content, different from the first suggested content.

139. The computer system of claim 125, the one or more programs further including instructions for:
detecting, via the one or more input devices, a key selection input wherein the key selection input is an input detected on the keyboard user interface or an input detected via a hardware keyboard; and
in response to detecting the key selection input, displaying, via the display generation component, content corresponding to the key selection input in a text entry field.

140. The computer system of claim 125, wherein displaying the keyboard user interface at the first keyboard position includes displaying the keyboard user interface with a first set of one or more position parameters, the one or more programs further including instructions for:
while displaying the keyboard user interface at the first keyboard position, detecting, via the one or more input devices, a request to modify the first set of one or more position parameters of the keyboard user interface;
in response to detecting the request to modify the first set of one or more position parameters of the keyboard user interface, displaying, via the display generation component, the keyboard user interface with a second set of one or more position parameters;
after displaying the keyboard user interface with the second set of one or more position parameters, detecting, via the one or more input devices, a set of one or more inputs;
in response to detecting the set of one or more inputs, ceasing display of the keyboard user interface;
while the keyboard user interface is not displayed, receiving, via the one or more input devices, a second request to display the keyboard user interface in the representation of the portion of the three-dimensional environment; and
in response to receiving the second request to display the keyboard user interface, displaying, via the display generation component, the keyboard user interface with a third set of one or more position parameters, wherein the third set of one or more position parameters includes at least one position parameter included in the second set of one or more position parameters.

141. The computer system of claim 140, wherein:
displaying the keyboard user interface with the second set of one or more position parameters includes displaying the keyboard user interface at a respective position relative to the computer system; and
displaying the keyboard user interface with the third set of one or more position parameters includes:
in accordance with a determination that a set of one or more positioning criteria are met, wherein the set of one or more positioning criteria includes a criterion that is met when at least a portion of a body of a user of the computer system has moved less than a threshold amount after ceasing display of the keyboard user interface, displaying the keyboard user interface at the respective position relative to the computer system.

142. The computer system of claim 141, wherein the request to modify the first set of one or more position parameters of the keyboard user interface is a request to modify a position of the keyboard user interface for a first application, the one or more programs further including instructions for:
while the keyboard user interface is not displayed, receiving, via the one or more input devices, a third request to display the keyboard user interface in the representation of the portion of the three-dimensional environment; and
in response to receiving the third request to display the keyboard user interface:
in accordance with a determination that the third request to display the keyboard user interface corresponds to a request to display the keyboard user interface for the first application, displaying, via the display generation component, the keyboard user interface with the third set of one or more position parameters; and
in accordance with a determination that the third request to display the keyboard user interface corresponds to a request to display the keyboard user interface for a second application, different from the first application, displaying, via the display generation component, the keyboard user interface with a fourth set of one or more position parameters that is different from the third set of one or more position parameters.

143. The computer system of claim 140, wherein:
displaying the keyboard user interface with the third set of one or more position parameters includes:
in accordance with a determination that a second body part has moved more than a threshold amount after ceasing display of the keyboard user interface, displaying, via the display generation component, the keyboard user interface at a respective position that is offset from a default position by a first offset value, wherein the first offset value is based on the second set of one or more position parameters.

144. A non-transitory computer-readable storage medium storing one or more programs configured to be executed by one or more processors of a computer system that is in communication with a display generation component and one or more input devices, the one or more programs including instructions for:
displaying, via the display generation component, a user interface that includes:
a representation of a portion of a three-dimensional environment; and
a representation of a respective application;
receiving, via the one or more input devices, a request to display a keyboard user interface in the representation of the portion of the three-dimensional environment; and
in response to receiving the request to display the keyboard user interface, displaying, via the display generation component, the keyboard user interface at a respective keyboard position in the representation of the portion of the three-dimensional environment, wherein:
in accordance with a determination that a first set of keyboard placement criteria is satisfied, wherein the first set of keyboard placement criteria includes a first application criterion that is satisfied when the representation of the respective application has a first pose in the representation of the portion of the three-dimensional environment, the respective keyboard position is at a first keyboard position in the representation of the portion of the three-dimensional environment; and
in accordance with a determination that a second set of keyboard placement criteria is satisfied, wherein the second set of keyboard placement criteria includes a second application criterion that is satisfied when the representation of the respective application has a second pose in the representation of the portion of the three-dimensional environment, wherein the second pose is different from the first pose, the respective keyboard position is at a second keyboard position in the representation of the portion of the three-dimensional environment that is different from the first keyboard position in the representation of the portion of the three-dimensional environment.

145. A method, comprising:
at a computer system that is in communication with a display generation component and one or more input devices:
displaying, via the display generation component, a user interface that includes:
a representation of a portion of a three-dimensional environment; and
a representation of a respective application;
receiving, via the one or more input devices, a request to display a keyboard user interface in the representation of the portion of the three-dimensional environment; and
in response to receiving the request to display the keyboard user interface, displaying, via the display generation component, the keyboard user interface at a respective keyboard position in the representation of the portion of the three-dimensional environment, wherein:
in accordance with a determination that a first set of keyboard placement criteria is satisfied, wherein the first set of keyboard placement criteria includes a first application criterion that is satisfied when the representation of the respective application has a first pose in the representation of the portion of the three-dimensional environment, the respective keyboard position is at a first keyboard position in the representation of the portion of the three-dimensional environment; and
in accordance with a determination that a second set of keyboard placement criteria is satisfied, wherein the second set of keyboard placement criteria includes a second application criterion that is satisfied when the representation of the respective application has a second pose in the representation of the portion of the three-dimensional environment, wherein the second pose is different from the first pose, the respective keyboard position is at a second keyboard position in the representation of the portion of the three-dimensional environment that is different from the first keyboard position in the representation of the portion of the three-dimensional environment.
